(19) United States
(12) Patent Application Publication
(10) Pub. No.: US 2013/0312638 A1
(43) Pub. Date: Nov. 28, 2013

(54) SYSTEMS, DEVICES AND METHODS FOR THE FABRICATION OF POLYMERIC FIBERS

(71) Applicants: Kevin Kit Parker, Waltham, MA (US); Mohammad Reza Badrossamay, Arlington, MA (US); Josue Adrian Goss, Somerville, MA (US); Holly M. Golecki, Acton, MA (US)

(72) Inventors: Kevin Kit Parker, Waltham, MA (US); Mohammad Reza Badrossamay, Arlington, MA (US); Josue Adrian Goss, Somerville, MA (US); Holly M. Golecki, Acton, MA (US)

(73) Assignee: PRESIDENT AND FELLOWS OF HARVARD COLLEGE, Cambridge, MA (US)

(21) Appl. No.: 13/988,088

(22) PCT Filed: Nov. 17, 2011
(86) PCT No.: PCT/US11/61241

§ 371 Date: Aug. 5, 2013

Related U.S. Application Data
(60) Provisional application No. 61/546,798, filed on Oct. 13, 2011.
(60) Provisional application No. 61/476,453, filed on Apr. 18, 2011.
(60) Provisional application No. 61/414,674, filed on Nov. 17, 2010.

(51) Int. Cl. B29C 47/00

(52) U.S. Cl. CPC B29C 47/0014
USPC 106/156.2; 264/211.1; 425/447; 523/400; 524/401; 524/599

(57) ABSTRACT

Exemplary embodiments provide systems, devices and methods for the fabrication of three-dimensional polymeric fibers having micron, submicron, and nanometer dimensions, as well as methods of use of the polymeric fibers.

### RELATED APPLICATIONS

This application claims priority to U.S. Provisional Application Serial Nos. 61/414,674, filed on Nov. 17, 2010, U.S. 61/476,453, filed on Apr. 18, 2011, and U.S. 61/546,798, filed on Oct. 13, 2011, the entire contents of all of which are incorporated herein in their entirety by reference.

This application is related to International (PCT) Patent Application Serial Number PCT/US2010/34662 filed May 13, 2010, entitled “Methods And Devices For The Fabrication of 3D Polymeric Fibers,” the entire contents of which are incorporated herein in their entity by reference.

### GOVERNMENT SUPPORT

This invention was made with government support under PHY-0646094 and DMR-00820484 awarded by National Science Foundation, and under R01HL079126 awarded by the National Institutes of Health. The government has certain rights in the invention.

### BACKGROUND

Polymeric fibers, such as polymeric fibers, have a broad array of uses including, but not limited to, use in catalytic substrates, photonics, filtration, protective clothing, cell scaffolding, drug delivery and wound healing. Structures prepared using the polymeric fibers of the invention are good candidates for tissue engineering due to their high surface to mass ratio, high porosity for, e.g., breathability, encapsulation of active substances and fiber alignment, and because the structures can be easily wound into different shapes. Tissue engineering applications for structures made using the polymeric fibers of the invention include, but are not limited to orthopedic, muscular, vascular and neural prostheses, and regenerative medicines. Madurantakam, et al. (2009) Nanomedicine 4:193-206; Madurantakam, P. A., et al. (2009) Biomaterials 30(29):5456-5464; Xie, et al. (2008) Macromolecular Rapid Communications 29:1775-1792.

Electrospinning is a common conventional process for fabricating polymeric fibers, such as polymeric fibers. Electrospinning is a process that uses high voltages to create an electric field between a droplet of polymer solution at the tip of a needle and a collection device. One electrode of the voltage source is placed in the solution and the other electrode is connected to the collection device. This exerts an electrostatic force on the droplet of polymer solution. As the voltage is increased, the electric field intensifies, thus increasing the magnitude of the force on the pendant droplet of polymer solution at the tip of the needle. The increasing electrostatic force acts in a direction opposing the surface tension of the droplet and causes the droplet to elongate, forming a conical shape known as a Taylor cone. When the electrostatic force overcomes the surface tension of the droplet, a charged continuous jet of polymer solution is ejected from the cone. The jet of polymer solution accelerates towards the collection device, whipping and bending wildly. As the solution moves away from the needle and toward the collection device, the jet rapidly thins and dries as the solvent evaporates. On the surface of the grounded collection device, a non-woven mat of randomly oriented solid polymeric fibers is deposited. Zufan (2005) Final RET Report; Xie, J. W. et al. (2008) Macromolecular Rapid Communications 29(22):1775-1792; Reneker, D. H., et al. (2007) Advances in Applied Mechanics 41:43-195; Dzenis, Y. (2004) Science 304(5679):1917-1919; Rutledge, G. C. and Yu, J. H. (2007) “Electrospinning” In Encyclopedia of Polymer Science and Technology, John Wiley & Sons: New Jersey; Krogman, K. C., et al. (2009) Nature Materials 8(6):512-518; Pham, Q. P., et al. (2006) Tissue Engineering 12(5):1197-1211; Boland, E. D., et al. (2001) Journal of Macromolecular Science-Pure and Applied Chemistry 38(12):1231-1243; Teo, W. E. and Ramakrishna, S. (2006) Nanotechnology 17(14):R89-R106; Li, D.; Xia, Y. N. (2004) Advanced Materials 16(14):1151-1170; Greiner, A. and Wendorff, J. H. (2007) Angewandte Chemie-International Edition 46(30):5670-5703.

There are multiple drawbacks associated with electrospinning, e.g., a low production rate, the requirement of a high voltage electrical field, the requirement of precise solution conductivity, and the need for additional devices for producing aligned fiber structures. Lia and Xia (2004) Advanced Materials 16:1151-1170; Weitz, et al. (2008) Nano Letters 8:1187-1191; Arumuganathar, S, and Jayasinghe, S. N. (2008) Biomacromolecules 9(3):759-766.

Accordingly, there is a need in the art for improved systems, devices and methods for the fabrication of polymeric fibers, such as nanofibers.

### SUMMARY

Described herein are improved systems, devices and methods for the fabrication of polymeric fibers having micron, submicron, and nanometer dimensions. Exemplary devices include one or more reservoirs for containing a material solution for forming the fibers, and one or more collection devices for collecting the formed fibers. The present invention also provides a fluid mechanics model describing the shear forces inside a reservoir which was used to predict the shear stress in a rotating fluid flow to predict unfolding of naturally occurring and/or synthetic proteins for generating insoluble protein nanofibers.

Accordingly, in one aspect, the present invention provides a device for the fabrication of a micron, submicron or nanometer dimension polymeric fiber. The device includes a reservoir for holding a polymer, the reservoir including one or more orifices for ejecting the polymer during fiber formation, thereby forming a micron, submicron or nanometer dimension polymeric fiber and a collection device for accepting the formed micron, submicron or nanometer dimension polymeric fiber, wherein at least one of the reservoir and the collection device employs linear and/or rotational motion during fiber formation. The device may include a rotary motion generator for imparting a rotational motion to the reservoir and, in some exemplary embodiments, to the collection device.

Rotational speeds of the reservoir in exemplary embodiments may range from about 50,000 rpm to about 400,000 rpm, e.g., about 50,000, 55,000, 60,000, 65,000, 70,000, 75,000, 80,000, 85,000, 90,000, 95,000, 100,000, 105,000, 110,000, 115,000, 120,000, 125,000, 130,000, 135,000, 140,000, 145,000, 150,000 rpm, about 200,000 rpm, 250,000 rpm, 300,000 rpm, 350,000 rpm, or 400,000 rpm. Ranges and values intermediate to the above recited ranges and values are also contemplated to be part of the invention.

In an alternative embodiment, the reservoir may not be rotated, but may be pressurized to eject the polymer material from the reservoir through one or more orifices. For example, a mechanical pressurizer may be applied to one or more surfaces of the reservoir to decrease the volume of the reservoir, and thereby eject the material from the reservoir. In another exemplary embodiment, a fluid pressure may be introduced into the reservoir to pressurize the internal volume of the reservoir, and thereby eject the material from the reservoir.

Exemplary orifice lengths that may be used in some exemplary embodiments range between about 0.001 m and about 0.1 m, e.g., 0.0015, 0.002, 0.0025, 0.003, 0.0035, 0.004, 0.0045, 0.005, 0.0055, 0.006, 0.0065, 0.007, 0.0075, 0.008, 0.0085, 0.009, 0.0095, 0.01, 0.015, 0.02, 0.025, 0.03, 0.035, 0.04, 0.045, 0.05, 0.055, 0.06, 0.065, 0.07, 0.075, 0.08, 0.085, 0.09, 0.095, or 0.1 m. Ranges and values intermediate to the above recited ranges and values are also contemplated to be part of the invention.

Exemplary orifice diameters that may be used in some exemplary embodiments range between about 0.1 μm and about 10 μm, e.g., 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1.0, 2, 3, 4, 5, 6, 7, 8, 9, or 10 μm. Ranges and values intermediate to the above recited ranges and values are also contemplated to be part of the invention.

The device may further include a linear motion generator for imparting the linear motion to the at least one of the reservoir and the collection device. The device may also further include a control mechanism for controlling the speed of the motion imparted by the motion generator. The speed of the linear motion may be varied to control at least one of a pitch, a fiber spacing or a pore spacing of the formed fiber. In one embodiment, both of the reservoir and the collection device oscillates in a linear manner during fiber formation.

In yet another aspect, the present invention provides a device for the formation of a micron, submicron or nanometer dimension polymeric fiber. The device includes a reservoir for holding a polymer, the reservoir including one or more orifices for ejecting the polymer during fiber formation, thereby forming micron, submicron or nanometer dimension polymeric fibers, and an air vessel for circulating a vortex of air around the formed fibers to wind the fibers into one or more threads.

The device may further include a collection device for accepting the formed micron, submicron or nanometer dimension polymeric fibers.

In one embodiment, the collection device is rotating.

In one embodiment, the air vessel includes an enclosed member extending substantially vertically for accommodating the descending formed fibers, one or more angle nozzles for introduced one or more angled air jets into the enclosed member, and one or more air introduction pipes couplable to the one or more nozzles for introducing the air jets into the enclosed member.

In one embodiment, the air jets travel vertically downward along the enclosed member substantially in helical rings.

In another aspect, the present invention provides a device for the formation of a micron, submicron or nanometer dimension polymeric fiber. The device includes a reservoir for holding a polymer, the reservoir including one or more orifices for ejecting the polymer during fiber formation, thereby forming a micron, submicron or nanometer dimension polymeric fiber, one or more mechanical members disposed or formed on or in the vicinity of the reservoir for increasing an air flow or an air turbulence experienced by the polymer ejected from the reservoir, and a collection device for accepting the formed micron, submicron or nanometer dimension polymeric fiber.

In one embodiment, the one or more mechanical members are disposed on the reservoir.

In one embodiment, the device further includes a motion generator for imparting a motion to the reservoir, wherein the one or more mechanical members are disposed on the motion generator.

The one or more mechanical members may be stationary or moving.

The one or more mechanical members may be disposed vertically above the one or more orifices of the reservoir or disposed vertically below the one or more orifices of the reservoir.

In one embodiment, the formed fibers are unaligned due to the increased air flow or increased air turbulence created by the one or more mechanical members. In another embodiment, the formed fibers are aligned substantially along an axis or a plane due to the increased air flow or increased air turbulence created by the one or more mechanical members.

In one aspect, the present invention provides a miniaturized device for the formation of a micron, submicron or nanometer dimension polymeric fiber within a body cavity. The device includes a miniaturized reservoir for holding a polymer, the reservoir including one or more orifices for ejecting the polymer during fiber formation, thereby forming a micron, submicron or nanometer dimension polymeric fiber, and a motion generator for imparting a motion to the reservoir for ejecting the polymer from the reservoir during fiber formation, wherein a body cavity accepts the formed micron, submicron or nanometer dimension polymeric fiber.

In one embodiment, the motion generator is miniaturized and is insertable into the body cavity. In one embodiment, the miniaturized motion generator is a microdrive motor. In another embodiment, the motion generator is non-miniaturized and is provided outside the body cavity. In one embodiment, the non-miniaturized motion generator remotely controls the motion of the reservoir.

The device may further include one or more tubes coupled to the reservoir for introducing the polymer into the reservoir from outside the body cavity. The device may also further include one or more conduits coupled to the motion generator for supplying electrical power to the motion generator from outside the body cavity.

In another aspect, the present invention provides a reservoir for the formation of a micron, submicron or nanometer dimension polymeric fiber within a body cavity. The reservoir includes a reservoir body having a hollow internal space for holding a polymer; and a plurality of orifices provided on the body for ejecting the polymer during fiber formation, thereby forming a micron, submicron or nanometer dimension polymeric fiber.

The plurality of orifices may be provided on the same surface of the reservoir body, or on different surfaces of the reservoir body.

The plurality of orifices may have the same cross-sectional configuration or different cross-sectional configurations.

The reservoir may further comprise a first nozzle provided on a first of the one or more orifices of the reservoir. In one embodiment, the first nozzle has a cross-sectional configuration different from a cross-sectional configuration of the first orifice. In one embodiment, the first nozzle increases the surface area of the formed fiber. In another embodiment, the first nozzle convolutes the surface topography of the formed fiber. In one embodiment, the first nozzle creates one or more structural features on the surface of the formed fiber. In one embodiment, the structural features range in size from about 1 nanometer to about 500 nanometers, e.g., about 1, 2, 3, 4, 5, 6, 7, 8, 9, 10, 15, 20, 25, 30, 35, 40, 45, 50, 55, 60, 65, 70, 75, 80, 90, 100, 125, 150, 175, 200, 250, 300, 350, 400, 450, or 500 nanometers.

In yet another aspect, the present invention provides a device for the fabrication of a micron, submicron or nanometer dimension polymeric fiber. The device includes a rotational motion system, the system comprising a rotating reservoir suitable for accepting a polymer and comprising an orifice for ejecting the polymer during rotation of the reservoir, thereby forming a micron, submicron or nanometer dimension polymeric fiber and a collection device for accepting the formed micron, submicron or nanometer dimension polymeric fiber; wherein the device is free of an electrical field, e.g., a high voltage electrical field.

In another aspect, the present invention provides a device for the fabrication of a micron, submicron or nanometer dimension polymeric fiber. The device includes an linear motion system, said system comprising a reservoir suitable for accepting a polymer and comprising an orifice for ejecting said polymer during oscillation, e.g., vertical, horizontal, or diagonal oscillation, of the reservoir along the track system, thereby forming a micron, submicron or nanometer dimension polymeric fiber, and a collection device for accepting said formed micron, submicron or nanometer dimension polymeric fiber, wherein the device is free of an electrical field, e.g., a high voltage electrical field.

In another aspect, the invention provides methods for fabricating a micron, submicron or nanometer dimension polymeric fiber. The methods include feeding a polymer into a rotating reservoir of a device of the invention and providing motion at a speed and for a time sufficient to form a micron, submicron or nanometer dimension polymeric fiber.

In yet another aspect, the present invention provides methods for fabricating a micron, submicron or nanometer dimension polymeric fiber. The methods include providing a polymer solution and imparting a sufficient amount of shear stress to the polymer solution for a time sufficient to form a micron, submicron or nanometer dimension polymeric fiber. In one embodiment, a sufficient amount of shear stress in about 3,000 pascals.

In another aspect, the present invention provides methods for fabricating a micron, submicron or nanometer dimension polymeric fiber which include feeding a polymer solution into a rotating reservoir of a device of the invention and providing an amount of shear stress to the rotating polymer solution for a time sufficient to form a micron, submicron or nanometer dimension polymeric fiber.

The methods may further comprise collecting the formed micron, submicron or nanometer dimension polymeric fiber by, e.g., covering the formed micron, submicron or nanometer dimension polymeric fiber with a suitable material and peeling off the formed micron, submicron or nanometer dimension polymeric fiber from the walls of a collector of the device.

In one embodiment, the formed micron, submicron or nanometer dimension polymeric fiber is imaged, e.g., using a scanning electron microscope.

Exemplary polymers for use in the devices and methods of the invention may be biocompatible or nonbiocompatible, synthetic or natural, such as, for example, synthetic or natural polymers having shear induced unfolding. Exemplary polymers include, for example, poly(urethanes), poly(siloxanes) or silicones, poly(ethylene), poly(vinyl pyrrolidone), poly(2-hydroxy ethyl methacrylate), poly(N-vinyl pyrrolidone), poly(methyl methacrylate), poly(vinyl alcohol), poly(acrylic acid), polyacrylamide, poly(ethylene-co-vinyl acetate), poly(ethylene glycol), poly(methacrylic acid), polylactides (PLA), polyglycolides (PGA), poly(lactide-co-glycolides) (PLGA), polyanhydrides, polyphosphazenes, polygermanes, polyorthoesters, polyesters, polyamides, polyolefins, polycarbonates, polyaramides, polyimides, and copolymers and derivatives thereof.

Exemplary polymers for use in the devices and methods of the invention may also be naturally occurring polymers e.g., biogenic polymers, e.g., proteins, polysaccharides, lipids, nucleic acids or combinations thereof.

Exemplary biogenic polymers, e.g., polymers made in a living organism, e.g., fibrous proteins, for use in the devices and methods of exemplary embodiments include, but are not limited to, silk (e.g., fibroin, sericin, etc.), keratins (e.g., alpha-keratin which is the main protein component of hair, horns and nails, beta-keratin which is the main protein component of scales and claws, etc.), elastins (e.g., tropoelastin, etc.), fibrillin (e.g., fibrillin-1 which is the main component of microfibrils, fibrillin-2 which is a component in elastogenesis, fibrillin-3 which is found in the brain, fibrillin-4 which is a component in elastogenesis, etc.), fibrinogen/fibrins/thrombin (e.g., fibrinogen which is converted to fibrin by thrombin during wound healing), fibronectin, laminin, collagens (e.g., collagen I which is found in skin, tendons and bones, collagen II which is found in cartilage, collagen III which is found in connective tissue, collagen IV which is found in extracellular matrix protein, collagen V which is found in hair, etc.), vimentin, neurofilaments (e.g., light chain neurofilaments NF-L, medium chain neurofilaments NF-M, heavy chain neurofilaments NF-H, etc.), amyloids (e.g., alpha-amyloid, beta-amyloid, etc.), actin, myosins (e.g., myosin I-XVII, etc.), titin which is the largest known protein (also known as connectin), etc.

Exemplary biogenic polymers, e.g., fibrous polysaccharides, for use in the devices and methods of exemplary embodiments include, but are not limited to, chitin which is a major component of arthropod exoskeletons, hyaluronic acid which is found in extracellular space and cartilage (e.g., D-glucuronic acid which is a component of hyaluronic acid, D-N-acetylglucosamine which is a component of hyaluronic acid, etc.), etc.

Exemplary biogenic polymers, e.g., glycosaminoglycans (GAGs) (carbohydrate polymers found in the body), for use in the devices and methods of exemplary embodiments include, but are not limited to, heparan sulfate founding extracelluar matrix, chondroitin sulfate which contributes to tendon and ligament strength, keratin sulfate which is found in extracellular matrix, etc.

In one embodiment the polymers for use in the devices and methods of the invention may be mixtures of two or more polymers and/or two or more copolymers. In one embodiment the polymers for use in the devices and methods of the invention may be a mixture of one or more polymers and or more copolymers. In another embodiment, the polymers for use in the devices and methods of the invention may be a mixture of one or more synthetic polymers and one or more naturally occurring polymers.

In one embodiment, the polymer is fed into the reservoir as a polymer solution, i.e., a polymer dissolved in an appropriate solution. In this embodiment, the methods may further comprise dissolving the polymer in a solvent prior to feeding the polymer into the reservoir. In other embodiments, the polymer is fed into the reservoir as a polymer melt. In such embodiment, the reservoir is heated at a temperature suitable for melting the polymer, e.g., is heated at a temperature of about 100° C. to about 300° C., 100-200° C., about 150-300° C., about 150-250° C., or about 150-200° C., or about 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, or about 300° C.

In one embodiment of the invention, a plurality of micron, submicron or nanometer dimension polymeric fibers are formed. The plurality of micron, submicron or nanometer dimension polymeric fibers may be of the same diameter or of different diameters.

In one embodiment, the methods of the invention result in the fabrication of micron, submicron or nanometer dimension polymeric fiber having a diameter of about 15, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 33, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1000 nanometers, 10, 20, 30, 40, or about 50 micrometers.

In one embodiment, the methods of the invention result in the fabrication of a plurality of aligned (e.g., uniaxially aligned) micron, submicron or nanometer dimension polymeric fibers.

In other embodiments of the invention, the plurality of micron, submicron or nanometer dimension polymeric fibers are contacted with additional agents, e.g., a plurality of living cells, e.g., muscle cells, neuron cells, endothelial cells, and epithelial cells; biologically active agents, e.g., lipophilic peptides, lipids, nucleotides; fluorescent molecules, metals, ceramics, nanoparticles, and pharmaceutically active agents.

In certain embodiments of the invention the polymeric fibers contacted with living cells are cultured in an appropriate medium for a time until, e.g., a living tissue is produced.

In still other embodiments, the polymer is contacted with living cells during the fabrication process such that fibers populated with cells or fibers surrounded (partially or totally) with cells are produced. The polymer may also be contacted with additional agents, such as proteins, nucleotides, lipids, drugs, pharmaceutically active agents, biocidal and antimicrobial agents during the fabrication process such that functional micron, submicron or nanometer dimension polymeric fibers are produced which contain these agents.

In other aspects, the present invention provides the polymeric fibers produced using the methods and devices of the invention, as well as tissues, membranes, filters, biological protective textiles, biosensor devices, food products, and drug delivery devices comprising the polymeric fibers of the invention.

In another aspect, the present invention provides methods for identifying a compound that modulates a tissue function. The methods include, providing a tissue produced according to the methods of the invention; contacting the tissue with a test compound; and determining the effect of the test compound on a tissue function in the presence and absence of the test compound, wherein a modulation of the tissue function in the presence of the test compound as compared to the tissue function in the absence of the test compound indicates that the test compound modulates a tissue function, thereby identifying a compound that modulates a tissue function.

In yet another aspect, the present invention provides methods for identifying a compound useful for treating or preventing a tissue disease. The methods include, providing a tissue produced according to the methods of the invention; contacting the tissue with a test compound; and determining the effect of the test compound on a tissue function in the presence and absence of the test compound, wherein a modulation of the tissue function in the presence of said test compound as compared to the tissue function in the absence of the test compound indicates that the test compound modulates a tissue function, thereby identifying a compound useful for treating or preventing a tissue disease.

The tissue function may be any suitable physiological activity associate with the particular tissue type, e.g., a biomechanical activity, e.g., contractility, cell stress, cell swelling, and rigidity, or an electrophysiological activity.

In one embodiment, the methods include applying a stimulus to the tissue.

In another embodiment, a plurality of living tissues are contacted with a test compound simultaneously.

The present invention also provides method of forming fibers by providing a volume of a polymer solution and imparting a shear force to a surface of the polymer solution such that the polymer in the solution is unfolded, thereby forming a fiber.

In one embodiment, the polymer solution is a biogenic polymer solution. In one embodiment, the shear force is sufficient to expose molecule-molecule, e.g., protein-protein, binding sites in the polymer, thereby inducing fibrillogenesis.

### BRIEF DESCRIPTION OF THE DRAWINGS

The foregoing and other objects, aspects, features, and advantages of exemplary embodiments will become more apparent and may be better understood by referring to the following description taken in conjunction with the accompanying drawings, in which:

FIG. 1 illustrates an exemplary fiber formation device that employs linear motion.

FIG. 2 illustrates another exemplary fiber formation device that employs linear motion.

FIG. 3 illustrates another exemplary fiber formation device that employs linear motion.

FIG. 4A illustrates exemplary fibers formed by exemplary fiber formation devices that employ linear motion.

FIG. 4B illustrates exemplary fibers formed by a slower linear motion of an exemplary fiber formation device.

FIG. 4C illustrates exemplary fibers formed by a faster linear motion of an exemplary fiber formation device.

FIG. 5A illustrates exemplary fibers formed in a mesh configuration by exemplary fiber formation devices that employ linear motion.

FIG. 5B illustrates an exemplary polymeric fiber mesh structure formed by a slower linear motion of an exemplary fiber formation device.

FIG. 5C illustrates an exemplary polymeric fiber mesh structure formed by a faster linear motion of an exemplary fiber formation device.

FIG. 6 is a flowchart illustrating an exemplary method for forming or manufacturing an exemplary fiber formation device.

FIG. 7 is a flowchart illustrating an exemplary method for using an exemplary fiber formation device employing a linear motion to form fibers.

FIG. 8 illustrates an exemplary fiber formation device for forming fibers that are would into threads.

FIG. 9A illustrates a cross-sectional view taken through an exemplary reservoir.

FIG. 9B illustrates a material solution in the exemplary reservoir of FIG. 9A when the reservoir is rotated about a vertical axis.

FIG. 9C illustrates a material solution in another exemplary reservoir when the reservoir is rotated about a vertical axis.

FIGS. 10A-10C illustrate an exemplary air jet-spinning vessel that circulates a vortex of air around fibers for winding the fibers into threads.

FIG. 11 is a flowchart illustrating an exemplary method for forming or manufacturing an exemplary fiber formation device having an air-jet spinning vessel.

FIG. 12 is a flowchart illustrating an exemplary method for using an exemplary fiber formation device having an air-jet spinning vessel to form fibers wound into threads.

FIGS. 13A-13B illustrate a fiber formation device lacking an air foil.

FIG. 13C illustrates a microscope view of fibers produced by the fiber formation device of FIGS. 13A-13B.

FIGS. 14A-14B illustrate a fiber formation device having an air foil.

FIG. 14C illustrates a microscope view of fibers produced by the fiber formation device of FIGS. 14A-14B.

FIGS. 15A-15D illustrate different exemplary configurations of exemplary air foils.

FIGS. 16A and 16B illustrate microscope views of fibers formed by an exemplary fiber formation device having an air foil.

FIGS. 17A-17I illustrate different exemplary configurations of air foils associated with exemplary reservoirs in exemplary fiber formation devices.

FIG. 18 illustrates an exemplary miniaturized fiber formation device used as part of a laparoscopic tool for laparoscopic surgeries.

FIG. 19 illustrates an exemplary miniaturized reservoir containing a material solution that may be inserted into a body cavity in order to form polymeric fibers.

FIGS. 20A-20D illustrate exemplary orifices on reservoirs of fiber formation devices.

FIGS. 21A-21H illustrate exemplary cross-sectional configurations or shapes of nozzles that may be used to increase the surface area and/or topographical complexities of polymeric fibers.

FIG. 22 illustrates additional exemplary cross-sectional configurations or shapes of exemplary nozzles associated with orifices of an exemplary reservoir.

FIG. 23 depicts an aspect of the devices of the invention. (A) Photograph of a device. (B) Schematic representation of one embodiment of the devices of the invention. (C) Enlarged schematic representation of the device in 23(B) showing that the polymer solution is ejected from the two orifices of the rotating reservoir due to centrifugal action.

FIG. 24 depicts a schematic of one aspect of the invention, referred to as a rotary jet-spinning process (RJS). (a) In one embodiment, a rotary jet-spinning device includes a perforated reservoir (internal volume of 700 μL and external diameter of 12.5 mm) with two side wall orifices (orifice diameter of 340 μm and length to diameter ratio of 9) which rotates about its vertical axis in the center of a stationary collection device; the polymer solution continuously feeds into the reservoir and produces fibers that are deposited over the collection device (diameter of 300 mm). (b) Without wishing to be bound by theory, this figure depicts a magnified view of the formation mechanism of polymeric fibers using the RJS system depicted in (a), (i) jet-initiation, (ii) jet-extension and (iii) solvent evaporation. (c) Photographic image of 3D polymeric fiber produced by rotary jet-spinning, 8 wt % PLA in CHCl3 at 12,000 rpm rotation speed. (d) Scanning electron micrograph (SEM) of fibers in 24(c). (e) PLA fibers (10 wt % PLA in CHCl3 at 12,000 rpm rotation speed) produced with expedited solvent evaporation and high humidity (more than 55% R.H.). (f) SEM of 5 wt % PEO in water spun at 12,000 rpm. (g) SEM of 8 wt % PAA in water at 50% neutralization degree spun at 12,000 rpm, (h) SEM of 8 wt % PAA in water at 100% neutralization degree spun at 12,000 rpm. (i) SEM of 14 wt % gelatin in 20 v/v % acetic acid spun at 12,000 rpm. (j) The laser scanning confocal image of fiber encapsulated fluorescent polystyrene beads (0.2 μm diameter). (k) SEM of emulsion of gelatin in PLA spun at 12,000 rpm rotation speed.

FIG. 25 depicts the effect of polymer concentration on the fabrication of 3D polymeric fibers with different features. (A) Using a 4% weight solution of polylactic acid (PLA) in chloroform at 10,000 rpm rotation speed beads are formed due to insufficient polymer entanglement and Rayleigh instability driven by surface tension forces. (B) Using a 6% weight solution of polylactic acid (PLA) in chloroform at 10,000 rpm rotation speed beads-on-string are formed due to insufficient polymer entanglement and Rayleigh instability driven by surface tension forces. (B′) A graph depicting the size distribution of the average diameter of the polymeric fibers formed in (B). (C) Using an 8% weight solution of polylactic acid (PLA) in chloroform at 10,000 rpm rotation speed continuous fibers are formed. (C′) A graph depicting the size distribution of the average diameter of the polymeric fibers formed in (C). (D) Using a 10% weight solution of polylactic acid (PLA) in chloroform at 10,000 rpm rotation speed continuous fibers with a bimodal distribution of diameters are formed. (D′) A graph depicting the size distribution of the average diameter of the polymeric fibers formed in (D).

FIG. 26 depicts fiber morphology and the diameter distribution for 8% weight PLA solution spun at different rotation speeds. At the top, scanning electron micrographs show the morphology of fibers spun at 4,000 rpm, 8,000 rpm, and 12,000 rpm rotation speed. The graph plots the diameters of fibers formed. The horizontal lines inside the boxes in the graph represent the median values and the limits of the box denote the upper and lower quartiles. The maximum and minimum values are delimited by the bars. Scale bar is 10 micrometers for all scanning electron micrographs.

FIG. 27(A) depicts a scanning electron micrograph of fibers fabricated at 5,000 rpm rotation speed. FIG. 27(B) is a graph depicting the diameter distribution of at least 200 samples of produced fibers showing that the average diameter is 557 nm.

FIG. 28(A) depicts a scanning electron micrograph of fibers fabricated at 7,000 rpm rotation speed. FIG. 28(B) is a graph depicting the diameter distribution of at least 200 samples of produced fibers showing that the average diameter is 497 nm.

FIG. 29(A) depicts a scanning electron micrograph of fibers fabricated at 10,000 rpm rotation speed. FIG. 29(B) is a graph depicting the diameter distribution of at least 200 samples of produced fibers showing that the average diameter is 440 nm.

FIG. 30 depicts fiber morphology and the diameter distribution for 4%, 6%, 8%, and 10% weight PLA solutions spun at 12,000 rpm rotation speed. At the top, scanning electron micrographs show the morphology of fibers fabricated using 4% (a), 6% (b), 8% (c), and 10% (d) weight PLA solutions. The graph plots the diameters of fibers formed. The horizontal lines inside the boxes in the graph represent the median values and the limits of the box denote the upper and lower quartiles. The maximum and minimum values are delimited by the bars. Scale bar is 20 micrometers for all scanning electron micrographs.

FIG. 31a is a graph depicting the specific viscosity of polymer solutions versus polymer concentration for PLA solutions in chloroform. Changes in the slope mark the onset of the semi-dilute, unentangled, semi-dilute, entangled, and concentrated regimes. The concentrated regime (c*) was found to be 6% weight. FIG. 31b is a graph depicting the relationship between capillary number, polymer concentration and fiber morphology of fibers fabricated at various rotation speeds. The critical polymer concentration and critical capillary number indicated. The jet break-up may be estimated by the capillary number, defined as the ratio of Weber number (We) to Reynolds number (Re), which characterizes the ratio of the viscous force to the surface tension force. Scale bar is 20 μm.

FIG. 32 depicts the use of the polymeric fibers prepared using the devices and methods as described herein for fabrication of tissue engineered scaffolds. (a) Photographic image of PLA scaffold affixed to a 25 mm glass coverslip. (b) Stereo microscope image of PLA scaffold shows macroscale alignment of fibers. (c) SEM of PLA fibers with a cell attached to and encompassing the fiber bundle. Median fiber diameter is 1.43±0.55 μm. (d) Laser scanning confocal image of a cardiomyocyte attached to and extending along a gelatin nanofiber. Median diameter of gelatin fibers is 515±27 nm (white dashed line). (e) Laser scanning confocal image of engineered anisotropic cardiac muscle on a RJS-produced PLA scaffold (fibers are 1.43±0.55 μm diameter, white dashed lines). Nuclear DNA is stained in light gray, α-actinin at the sarcomeric Z-lines is medium gray. Scale bars are 20 μm.

FIG. 33 is a graph plotting viscosity as a function of shear rate for different concentrations of PLA.

FIGS. 34A and 34B illustrate exemplary fibers formed with 8 wt % polylactic acid dissolved in chloroform which is rotated in an exemplary reservoir at about 12,000 rpm.

FIGS. 35A-35D illustrate fibers produced from 12% polylactic acid solutions that may be manually wound into microthreads and implanted as a cell delivery device.

FIGS. 36A and 36B schematically illustrate the process of in vivo fibrillogenesis. FIG. 36A schematically illustrates a globular fibronectin (FN). FIG. 36B schematically illustrates extension of the FN of FIG. 36A during the process of fibrillogenesis.

FIG. 37A is a perspective view of an exemplary fiber formation device that employs rotational motion to eject a polymer material through an orifice. 37B-D show the fluid mechanics model describing the parabolic velocity field and resulting shear forces inside the orifice of a rotating reservoir and a fluid mechanics model describing the parabolic velocity profile and shear stress gradient inside the orifice. FIG. 37B is a cross-sectional side view of the orifice of FIG. 37A to show fluid flow in the orifice due to the rotational motion. FIG. 37C is a graph of exemplary orifice radii in m (along the y-axis) against exemplary velocities in m/s (along the x-axis). FIG. 37D is a graph of exemplary orifice radii in m (along the y-axis) against exemplary shear stresses in pascals (along the x-axis).

FIG. 38A illustrates an exemplary rotating reservoir containing a soluble biogenic polymer material in its globular state.

In FIG. 38B, a biogenic polymer, e.g., a protein comprising a beta sheet structure, such as fibronectin, is depicted before and after spinning in an exemplary fiber forming device of the invention employing rotational motion and comprising a reservoir and an orifice.

In FIG. 38C, a biogenic polymer comprising a random coil structure, such as silk fibroin, is depicted before and after spinning in an exemplary fiber forming device of the invention employing rotational motion and comprising a reservoir and an orifice.

FIG. 39A depicts the proposed mechanism of in vitro fibrillogenesis of fibronectin (FN) in an exemplary fiber forming device of the invention employing rotational motions and comprising a reservoir and an orifice (also referred to as a Rotary Jet Spinning device, or RJS).

FIG. 39B is a scanning electron microscopy image of FN nanofibers produced by an exemplary fiber forming device of the invention employing rotational motion and comprising a reservoir and an orifice showing the morphology of the fibers with diameter of 232.6±59 nm. Scale bar is 3 μm.

FIGS. 40A-40C are scanning electron microscopy images showing the morphological and chemical analysis of fabricated fibronectin (FN) nanofibers. FIG. 40D is a scanning electron microscopy image of fabricated bulk fibronectin nanofibers.

FIG. 41A is a schematic of the mechanism of FRET fluorescence. FIGS. 41B and 41C depict the FRET analysis of fabricated fibronectin nanofibers showing that a reduction in FRET intensity correlates to unfolded FN, unfolded by the exemplary fiber forming device of the invention employing rotational motions and comprising a reservoir and an orifice.

FIG. 42 is Raman spectroscopy graph of protein conformation in fabricated fibronectin nanofibers.

FIGS. 43A-43C are laser scanning confocal images of (a) cardiomyocytes (b) actin filaments of cardiac fibroblasts and (c) neurons attached to and orienting with FN nanofibers. Scale bars are 10 μm.

FIGS. 44A-44D depict the morphological and chemical analysis of silk fibroin nanofibers.

FIG. 45 is a graph of rotational speeds in rpm (along the y-axis) versus exemplary orifice lengths in m (along the x-axis) with an exemplary orifice radius of about 10 μm.

FIG. 46 is a graph of rotational speeds in rpm (along the y-axis) versus exemplary orifice lengths in m (along the x-axis) with an exemplary orifice radius of about 200 μm.

FIG. 47 is a graph of rotational speeds in rpm (along the y-axis) versus exemplary orifice lengths in m (along the x-axis) with an exemplary orifice radius of about 1 mm.

FIG. 48 is a graph of rotational speeds in rpm (along the y-axis) versus exemplary orifice radii in μm (along the x-axis) with an exemplary orifice length of about 1 mm.

FIG. 49 is a graph of rotational speeds in rpm (along the y-axis) versus exemplary orifice radii in μm (along the x-axis) with an exemplary orifice length of about 10 mm.

FIG. 50 is a graph of exemplary orifice radii in m (along the y-axis) versus exemplary orifice lengths in m (along the x-axis) at an exemplary rotational speed of about 50,000 rpm.

FIG. 51 is a graph of exemplary orifice radii in m (along the y-axis) versus exemplary orifice lengths in m (along the x-axis) at an exemplary rotational speed of about 75,000 rpm.

FIG. 52 are fibronectin nanofibers produced in a device comprising a rotating reservoir and an orifice rotated at 75,000 rpm and having a 200 um orifice radius and a 0.5 cm orifice length.

FIG. 53 are silk fibroin nanofibers produced in a device comprising a rotating reservoir and an orifice rotated at 75,000 rpm and having a 200 um orifice radius and a 0.5 cm orifice length.

FIG. 54 are poly(lactic acid) nanofibers produced in a device comprising a rotating reservoir and an orifice rotated at 75,000 rpm and having a 200 um orifice radius and a 0.5 cm orifice length.

FIGS. 55A and 55B illustrate an exemplary fiber formation device that employs high speed rotational motion (e.g., at about 50,000 rpm to about 80,000 rpm).

FIGS. 56A, 56B and 56C illustrate an exemplary hand-held fiber formation device that employs high speed rotational motion (e.g., at about 50,000 rpm to about 108,000 rpm).

FIGS. 57A and 57B illustrate an exemplary prototype including an exemplary polymer nozzle for ejecting a polymer material and an air jet nozzle for providing one or more air jets. FIG. 57A is a perspective view of the exemplary prototype. FIG. 57B is a side close-up view of a polymer nozzle and an associated air jet nozzle.

FIGS. 58A and 58B illustrate perspective views of nanofibers that are sprayed onto a substrate using the exemplary device of FIGS. 57A and 57B.

FIGS. 59A and 59B illustrate before and after views, respectively, of a steel mesh that is sprayed with 8% poly-lactic acid nanofibers for about sixty seconds using the exemplary device of FIGS. 57A and 57B to demonstrate airbrush-type application of the fibers.

FIG. 60A is a graph of exemplary orifice radius in mm (along the y-axis) versus exemplary shear stresses in Pa (along the x-axis).

FIG. 60B is a graph of the fraction of the volume of fibronectin that is unfolded (along the y-axis) versus the rotational speed in rpm (along the x-axis).

FIG. 61A illustrates a schematic view of a rotating reservoir containing soluble fibronectin in its globular conformation and fibronectin unfolding during fibrillogenesis as it exits through an orifice.

FIG. 61B illustrates treatment of the Weissenberg number that can be used to predict when fibronectin-fibronectin binding occurs in the rotating fluid flow.

FIG. 62A is a graph of exemplary orifice diameters in m (along the y-axis) versus exemplary shear stresses in Pa (along the x-axis) plotted at exemplary rotational speeds of about 15,000 rpm and about 40,000 rpm.

FIG. 62B is a graph of exemplary fiber tensile stresses in kPa withstood by exemplary fibers (along the y-axis) versus exemplary % strains (along the x-axis) plotted at exemplary rotational speeds of about 15,000 rpm and about 40,000 rpm.

### DETAILED DESCRIPTION

The present invention provides improved systems, devices, and methods which allow for tunable polymeric fiber orientation, alignment, and diameter by applying centrifugal or rotational motion and/or linear motion and without use of an electrical field, e.g., a high voltage electrical field.

Exemplary devices of the invention include one or more reservoirs for containing a material solution for forming the polymeric fibers having micron, submicron, and nanometer dimensions, and one or more collection devices for collecting the formed fibers employing linear and/or rotational motion. Exemplary embodiments may be free of an electrical field, e.g., a high voltage electrical field, and do not require an electrical field for fiber formation.

The terms “fiber” and “polymeric fiber” are used herein interchangeably, and both terms refer to fibers having micron, submicron, and nanometer dimensions.

The reservoir and collection device may be constructed of any material, e.g., a material that can withstand heat and/or that is not sensitive to chemical organic solvents. In one embodiment, the reservoir and the collection device are made up of a plastic material, e.g., polypropylene, polyethylene, or polytetrafluoroethylene. In another embodiment, the reservoir and the collection device are made up of a metal, e.g., aluminum, steel, stainless steel, tungsten carbide, tungsten alloys, titanium or nickel.

Any suitable size or geometrically shaped reservoir or collector may be used in the devices of the invention. For example, the reservoir may be round, rectangular, or oval. The collector may be round, oval, rectangular, or a half-heart shape. The collector may also be shaped in the form of any living organ, such as a heart, kidney, liver lobe(s), bladder, uterus, intestine, skeletal muscle, or lung shape, or portion thereof. The collector may further be shaped as any hollow cavity, organ or tissue, such as a circular muscle structure, e.g., a sphincter or iris.

In one embodiment, the devices of the invention further comprise a component suitable for continuously feeding the polymer into the rotating reservoir, such as a spout or syringe pump

These shapes allow the polymeric fibers to be deposited in the form of a living organ for the production of engineered tissue and organs, described in more detail below.

In certain embodiments, the collection device is maintained at about room temperature, e.g., about 20, 21, 22, 23, 24, 25, 26, 27, 28, 29, or about 30° C. and ambient humidity, e.g., about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or about 90% humidity. The devices may be maintained at and the methods may be formed at any suitable temperature and humidity depending on the desired surface topography of the polymeric fibers to be fabricated. For example, increasing humidity from about 30% to about 50% results in the fabrication of porous fibers, while decreasing humidity to about 25% results in the fabrication of smooth fibers. As smooth fibers have more tensile strength than porous fibers, in one embodiment, the devices of the invention are maintained and the methods of the invention are performed in controlled humidity conditions, e.g., humidity varying by about less than about 10%.

The reservoir may also include a heating element for heating and/or melting the polymer.

The device may further comprise a component suitable for continuously feeding the polymer into the reservoir.

The collection device of the device may be of any shape, e.g., round, oval, rectangular, or of a heart, kidney, lung, liver lobe(s), bladder, uterus, intestine, skeletal muscle or any other living organ shape, or portion thereof.

The reservoir and the collection device of the device may be made up of a material that can withstand heat, or of a material that is not sensitive to chemical organic solvents. For example, the reservoir and the collection device of the device may be made up of a plastic material, e.g., polypropylene, polyethylene, and polytetrafluoroethylene; or a metal, e.g., aluminum, steel, stainless steel, tungsten carbide, a tungsten alloy, titanium, and nickel.

In one embodiment of the invention, the device is free of a needle.

In one embodiment, the formed micron, submicron or nanometer dimension polymeric fiber is imaged, e.g., using a scanning electron microscope.

The devices and methods of the invention may be used to form a single, continuous polymeric fiber or a plurality of polymeric fibers of the same or different diameters, e.g., diameters about 25 nanometers to about 50 micrometers, about 100 nanometers to about 1 micrometer, about 500 nanometers to about 100 micrometers, 25 micrometers to about 100 micrometers, or about 5, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 33, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1000 nanometers, 10, 20, 30, 40, or about 50 micrometers. Sizes and ranges intermediate to the recited diameters are also part of the invention.

The polymeric fibers formed using the methods and devices of the invention may be of any length. In one embodiment, the length of the polymeric fibers is dependent on the length of time the device is in motion and/or the amount of polymer fed into the system. For example, the polymeric fibers may be about 1 nanometer, about 10 feet, or about 500 yards. Additionally, the polymeric fibers may be cut to a desired length using any suitable instrument.

In one embodiment, the methods and device of the invention produce about 0.5, 1, 2, 3, 4, 5, 6, 7, 8, 9, 10, 11, 12, 13, 14, or about 15 grams of polymeric fiber per hour.

In one embodiment of the invention, a plurality of micron, submicron or nanometer dimension polymeric fibers are formed. The plurality of micron, submicron or nanometer dimension polymeric fibers may be of the same diameter or of different diameters.

In one embodiment, the methods of the invention result in the fabrication of a plurality of aligned (e.g., uniaxially aligned) micron, submicron or nanometer dimension polymeric fibers.

The fibers produced according to the methods disclosed herein can be, for example, used as extracellular matrix and, together with cells, may also be used in forming engineered tissue. Such tissue is useful not only for the production of prosthetic devices and regenerative medicine, but also for investigating tissue developmental biology and disease pathology, as well as in drug discovery and toxicity testing. The polymeric fibers of the invention may also be combined with other substances, such as, therapeutic agents, in order to deliver such substances to the site of application or implantation of the polymeric fibers. The polymeric fibers produced according to the methods disclosed herein may also be used to generate food products, membranes and filters.

A. Exemplary Embodiments Employing Linear and/or Rotational Motion

Exemplary embodiments provide systems, devices and methods for forming fibers by employing linear and/or rotational motion.

In one aspect, the present invention provides devices, e.g., devices for the fabrication of a polymeric fiber, such as a polymeric fiber having a micron, submicron, or nanometer dimension. In one embodiment, the devices are substantially void of an electric field, or do not require, an electrical field, e.g., a high voltage electrical field, in order to generate the polymeric fiber. In another embodiment, the devices are free of a needle.

In one embodiment, the present invention provides systems, devices and methods for forming fibers by employing linear motion.

In some exemplary embodiments, a linear motion may be imparted one or more reservoirs containing a material solution which is used to form the fibers. In some exemplary embodiments, a linear motion may be imparted on one or more collection devices used to collect fibers that are formed from a material solution. In some exemplary embodiments, linear motion may be imparted on both one or more reservoirs containing a material solution which is used to form the fibers and on one or more collection devices used to collect fibers that are formed from the material solution. An exemplary range for typical linear velocities used in exemplary embodiments is, but is not limited to, between about 0.0001 m/s to about 4.2 m/s. Exemplary embodiments may be used to form polymeric fibers having exemplary diameters on the order of nanometers or microns.

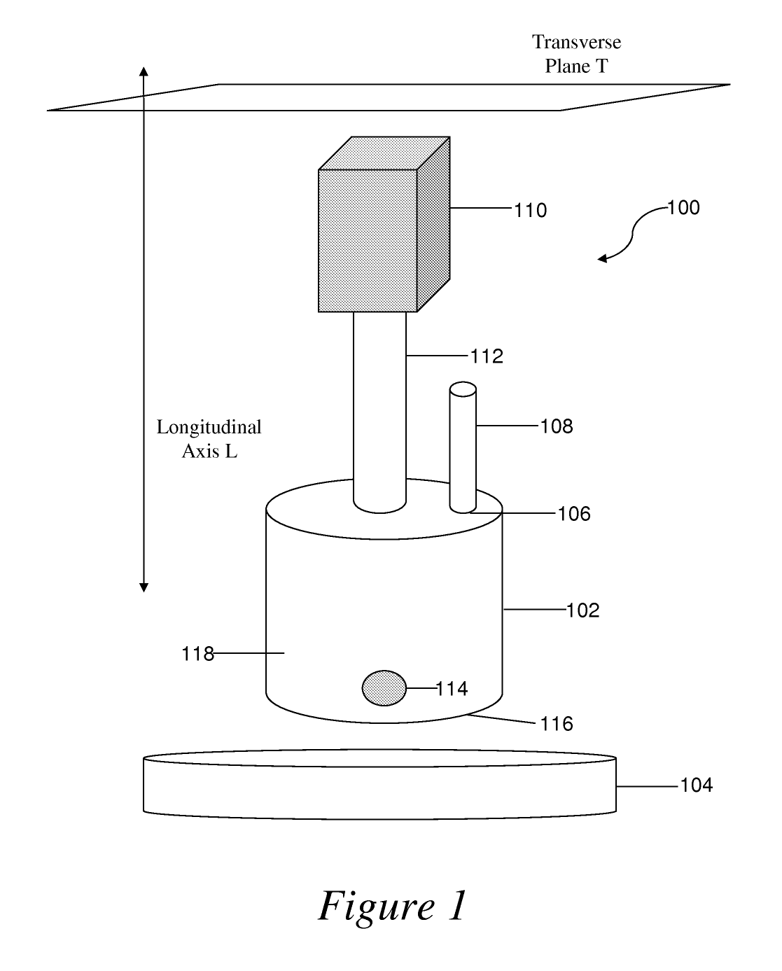

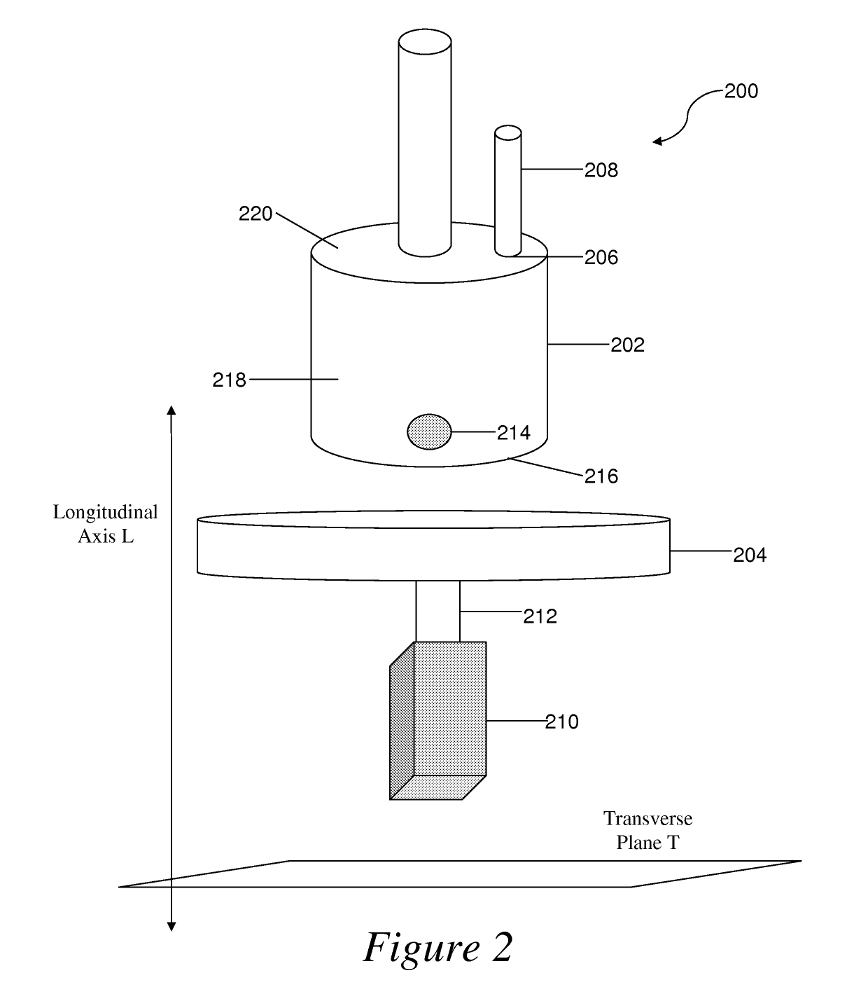

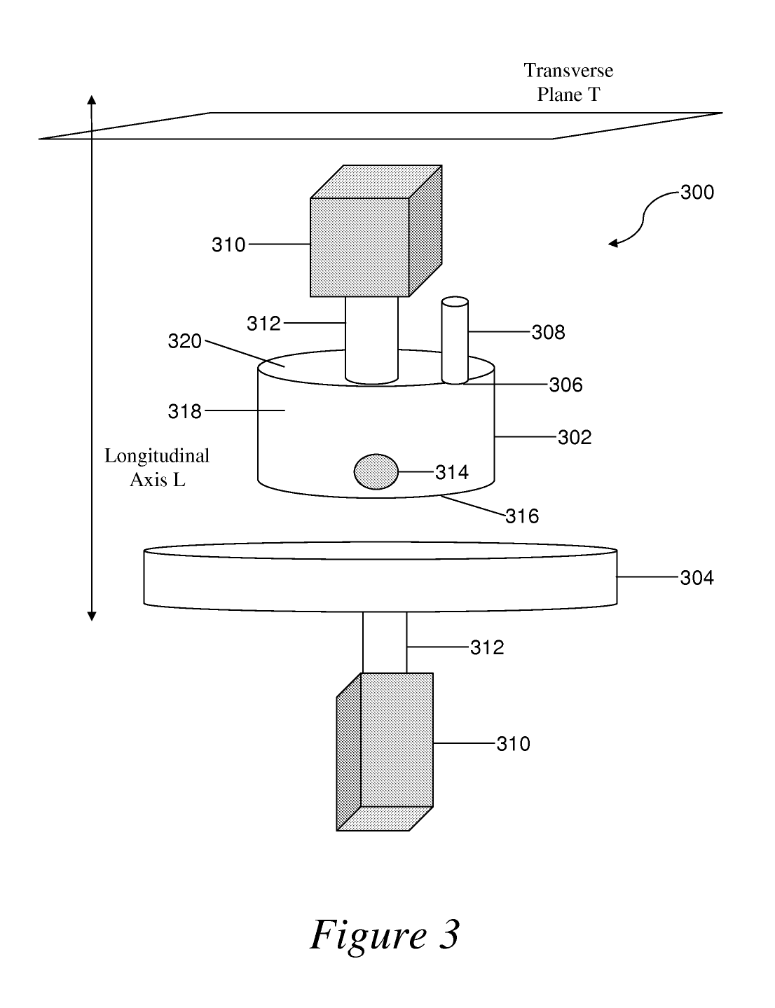

In an exemplary fiber formation device 100 illustrated in FIG. 1, a linear motion is imparted on one or more reservoirs containing a material solution to cause the reservoirs to move substantially in a linear back and forth motion. The exemplary fiber formation device 100 includes one or more reservoirs 102 for holding one or more material solutions. During fiber formation, the reservoir 102 is moved linearly in a back and forth motion in an exemplary embodiment, which causes one or more jets of the material solution to be ejected from the reservoir 102. Air drag extends and elongates the jets into fibers as the solvent in the material solution evaporates. The device 100 includes one or more collection devices 104, e.g., a plate, bobbin, etc., for collecting the fibers formed during the fiber formation process. In an exemplary embodiment, the collection device 104 is disposed vertically below the reservoir 102. Although the exemplary collection device 104 illustrated in FIG. 1 is stationary, other exemplary collection devices may be moving, e.g., rotating and/or oscillating, as illustrated in the exemplary embodiments of FIGS. 2 and 3.

The reservoir 102 includes one or more inlet ports 106, each coupled to one or more inlet pipes 108 for introducing one or more material solutions and/or one or more other fluids (e.g., air pressure) into the reservoir 102. An exemplary inlet pipe 108 may be coupled to one or more storage devices that store a material solution or to one or more devices that produce a material solution. One or more material solutions may be fed into the reservoir 102 through the inlet port 106 at a constant flow rate or at variable flow rates.

In an exemplary embodiment, the inlet port 106 may be closed temporarily or permanently after the reservoir 102 is filled before fiber formation. In another exemplary embodiment, the inlet port 106 may remain open for continuous or intermittent filling of the reservoir 102 during fiber formation. In an exemplary embodiment, the reservoir 102 may be pre-filled and the filled reservoir 102 may not include the inlet pipe 108 and may have one or more temporarily or permanently sealed inlet ports 106. In another exemplary embodiment, the inlet port 106 may remain coupled to the inlet pipe 108 and the reservoir 102 may be filled continuously or in one or more sessions during fiber formation.

The reservoir 102 is coupled directly or indirectly to one or more motion generators 110, e.g., a linear motor, an oscillating track system, a rotating motor, etc., that impart a motion to the reservoir 102.

In an exemplary embodiment, the motion generator 110 imparts a substantially linear back and forth motion to the reservoir 102 along substantially any axis in space suitable for fiber formation. In this case, the motion generator 110 may include one or more linear motion generators, e.g., oscillating track systems, linear motors, etc. In an exemplary embodiment, the reservoir 102 is moved in a linear back and forth motion substantially along a longitudinal axis L that extends between the reservoir 102 and the collection device 104. In another exemplary embodiment, the reservoir 102 is moved in a linear back and forth motion substantially along any transverse axis along the transverse plane T substantially orthogonal to the longitudinal axis L. In some exemplary embodiments, a linear motion generator moving back and forth along one axis may be coupled with one or more other linear motion generators moving back and forth along other axes to provide a resultant motion along a different axis.

In another exemplary embodiment, the linear back and forth motion of the reservoir 102 along any axis may be combined with rotational motion, e.g., a rotational motion substantially about the longitudinal axis L. In this case, the motion generator 110 may include one or more linear motion generators, e.g., linear motors, oscillating track systems, etc., coupled with one or more rotational motion generators, e.g., rotary motors, etc.

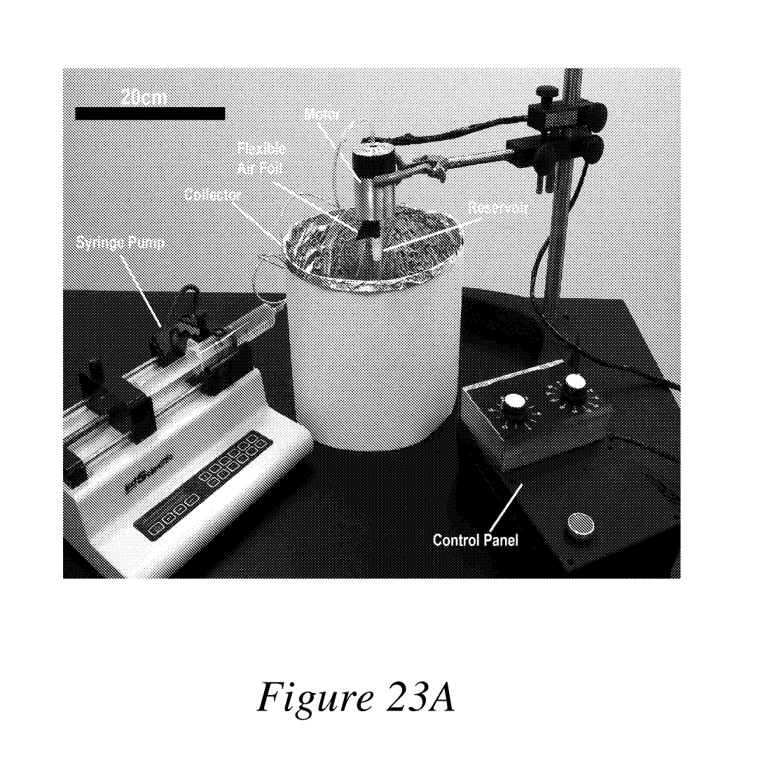

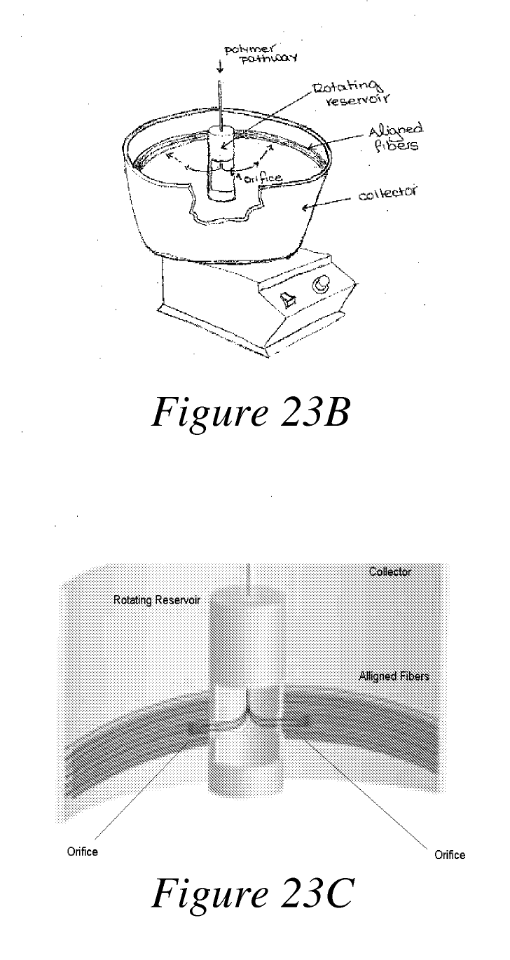

In another exemplary embodiment, the motion generator 110 imparts a substantially rotational motion to the reservoir 102, e.g., a rotational motion about the longitudinal axis L. In this exemplary embodiment, the motion generator 110 may include one or more rotational motion generators, e.g., rotational motors, etc. An exemplary rotational motion generator is depicted in FIG. 23A and may be provided in accordance with the disclosure of a rotational motion generator in International (PCT) Patent Application Serial Number PCT/US10/34662 filed May 13, 2010, entitled “Methods And Devices For The Fabrication of 3D Polymeric Fibers, the entire contents of which are incorporated herein by reference.

In another exemplary embodiment, the motion generator 110 imparts other types of motions to the reservoir 102, e.g., irregular motions, complex motion patterns, linear motion along different axes, rotational motion about different axes, motion that changes between linear and rotational, etc.

Exemplary embodiments may use different combinations of the exemplary motion generators to create and control desired weaves and/or alignments of the fibers formed by the motion of the reservoir 102.

In exemplary embodiments, the velocity of the reservoir 102, linear or rotational, may be kept substantially constant during a fiber formation session or may be increased or decreased during a fiber formation session. Exemplary linear velocities of the reservoir 102 may range from about 5 m/s to about 40 m/s in some exemplary embodiments, but are not limited to this exemplary range. Comparing some exemplary devices that employ purely linear motion to some exemplary devices that employ purely rotational motion for fiber formation, a linear velocity of about 10.8 m/s corresponds to about 8,000 rpm of rotational velocity, a linear velocity of about 16.2 m/s corresponds to about 12,000 rpm of rotational velocity, and a linear velocity of about 27.1 m/s corresponds to about 20,000 rpm of rotational velocity. Badrossamay et al. (2010), Nanofiber Assembly By Rotary Jet-Spinning, Nanoletters 10, 2257-2261.

The reservoir 102 may be coupled to the linear motion generator 110 using one or more mechanical coupling members 112, e.g., a rod, piston, etc., that reliably and efficiently transfer the motion generated by the generator 110 to the reservoir 102. The motion generator 110 may be coupled to an electrical power source (not shown), e.g., electrical mains or one or more batteries, that supplies electrical power to power the generator 110.

An exemplary reservoir may have a volume ranging from about one nanoliter to about 1 milliliter, about one nanoliter to about 5 milliliters, about 1 nanoliter to about 100 milliliters, or about one microliter to about 100 milliliters, for holding the liquid material. Some exemplary volumes include, but are not limited to, about one nanoliter o about 1 milliliter, about one nanoliter to about 5 milliliters, about 1 nanoliter to about 100 milliliters, one microliter to about 100 microliters, about 1 milliliter to about 20 milliliters, about 20 milliliters to about 40 milliliters, about 40 milliliters to about 60 milliliters, about 60 milliliters to about 80 milliliters, about 80 milliliters to about 100 milliliters, but are not limited to these exemplary ranges. Exemplary volumes intermediate to the recited volumes are also part of the invention. In certain embodiment, the volume of the reservoir is less than about 5, less than about 4, less than about 3, less than about 2, or less than about 1 milliliter. In other embodiments, the physical size of an unfolded polymer and the desired number of polymers that will form a fiber dictate the smallest volume of the reservoir.

The reservoir 102 includes one or more orifices 114 through which one or more jets of the material solution are forced to exit the reservoir 102 by the motion of the reservoir 102 during fiber formation. One or more exemplary orifices 114 may be provided on any suitable side or surface of the reservoir 102 including, but not limited to, a bottom surface 116 of the reservoir 102 that faces the collection device 104, a side surface 118 of the reservoir 102, a top surface 120 of the reservoir 102 that faces in the opposite direction to the collection device 104, etc. Exemplary orifices 114 may have any suitable cross-sectional geometry including, but not limited to, circular (as illustrated in the exemplary embodiment of FIG. 1), oval, square, rectangular, etc. In an exemplary embodiment, one or more nozzles may be provided associated with an exemplary orifice 114 to provide control over one or more characteristics of the material solution exiting the reservoir 102 through the orifice including, but not limited to, the flow rate, speed, direction, mass, shape and/or pressure of the material solution. The locations, cross-sectional geometries and arrangements of the orifices 114 on the reservoir 102, and/or the locations, cross-sectional geometries and arrangements of the nozzles on the orifices 114, may be configured based on the desired characteristics of the resulting fibers and/or based on one or more other factors including, but not limited to, viscosity of the material solution, the rate of solvent evaporation during fiber formation, etc.

Exemplary orifice lengths that may be used in some exemplary embodiments range between about 0.001 m and about 0.1 m, e.g., 0.0015, 0.002, 0.0025, 0.003, 0.0035, 0.004, 0.0045, 0.005, 0.0055, 0.006, 0.0065, 0.007, 0.0075, 0.008, 0.0085, 0.009, 0.0095, 0.01, 0.015, 0.02, 0.025, 0.03, 0.035, 0.04, 0.045, 0.05, 0.055, 0.06, 0.065, 0.07, 0.075, 0.08, 0.085, 0.09, 0.095, or 0.1 m. Ranges and values intermediate to the above recited ranges and values are also contemplated to be part of the invention.

Exemplary orifice diameters that may be used in some exemplary embodiments range between about 0.05 μm and about 10 μm, e.g., 0.05, 0.06, 0.07, 0.08, 0.09, 0.1, 0.15, 0.2, 0.225, 0.25, 0.275, 0.3, 0.325, 0.35, 0.375, 0.4, 0.425, 0.45, 0.475, 0.5, 0.525, 0.55, 0.575, 0.6, 0.625, 0.65, 0.675, 0.7, 0.725, 0.75, 0.075, 0.8, 0.825, 0.85, 0.825, 0.9, 0.925, 0.95, 0.975, 1.0, 1.5, 2, 2.5, 3, 3.5, 4, 4.5, 5, 5.5, 6, 6.5, 7, 7.5, 8, 8.5, 9, 9.5, or 10 μm. Ranges and values intermediate to the above recited ranges and values are also contemplated to be part of the invention.

In operation, as the motion generator 110 moves the reservoir 102 back and forth in a linear manner, the inertia of a material solution in the reservoir 102 resists the linear motion of the motion generator 110 and the reservoir 102. This causes the material solution to be pulled against one or more walls of the reservoir 102 and through one or more orifices 114 that are present on the walls. The material solution forms one or more jets as it is pulled through one or more orifices 114. The jets exit the reservoir 102 through the orifices 114. The material jets extend through the air as they descend by the action of gravity from the reservoir 102 to the collection device 104, and the solvent in the material solution evaporates. The polymeric fibers subsequently descend onto and are collected by the collection device 104.

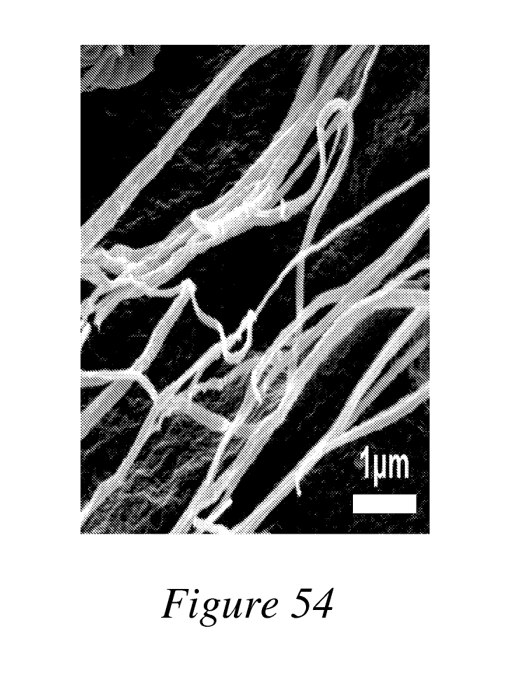

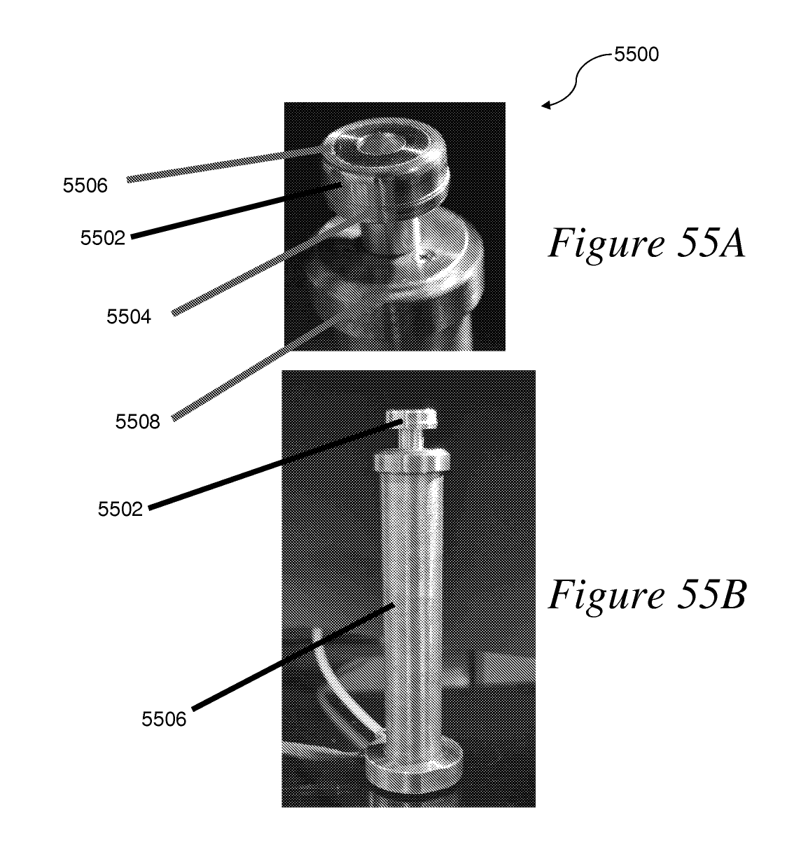

FIGS. 55A and 55B illustrates an exemplary fiber formation device 5500 that employs a rotational reservoir to form micron, submicron and nanometer dimension polymeric fibers. The device 5500 may include a reservoir 5502 including one or more orifices 5504 provided in a side-wall of the reservoir 5502. In an exemplary embodiment, an orifice may have an exemplary diameter of about 350 microns, but exemplary orifices are not limited to this exemplary diameter. In an exemplary embodiment, the reservoir may have a diameter of about two to six inches, but exemplary reservoirs are not limited to this exemplary diameter. In an exemplary embodiment, a lid 5506 may be provided at the top portion the reservoir, integrally with the reservoir or separately from the reservoir, to prevent the polymer material from spilling over the reservoir. An exemplary lid may be formed of laser-welded stainless steel.

The reservoir 5502 may be coupled to a motion generator 5508, e.g., a motor, that imparts a rotational motion to the reservoir 5502. In exemplary embodiments, the motion generator 5508 may rotate the reservoir 5502 at rotational speeds of about 50,000 to about 80,000 rpm, although exemplary rotational speeds are not limited to this exemplary range. In an exemplary embodiment, the motor may be provided in a pressurized case or container, e.g., a pressurized copper motor case, that may allow the motor to be cooled and to be protected from a solvent.

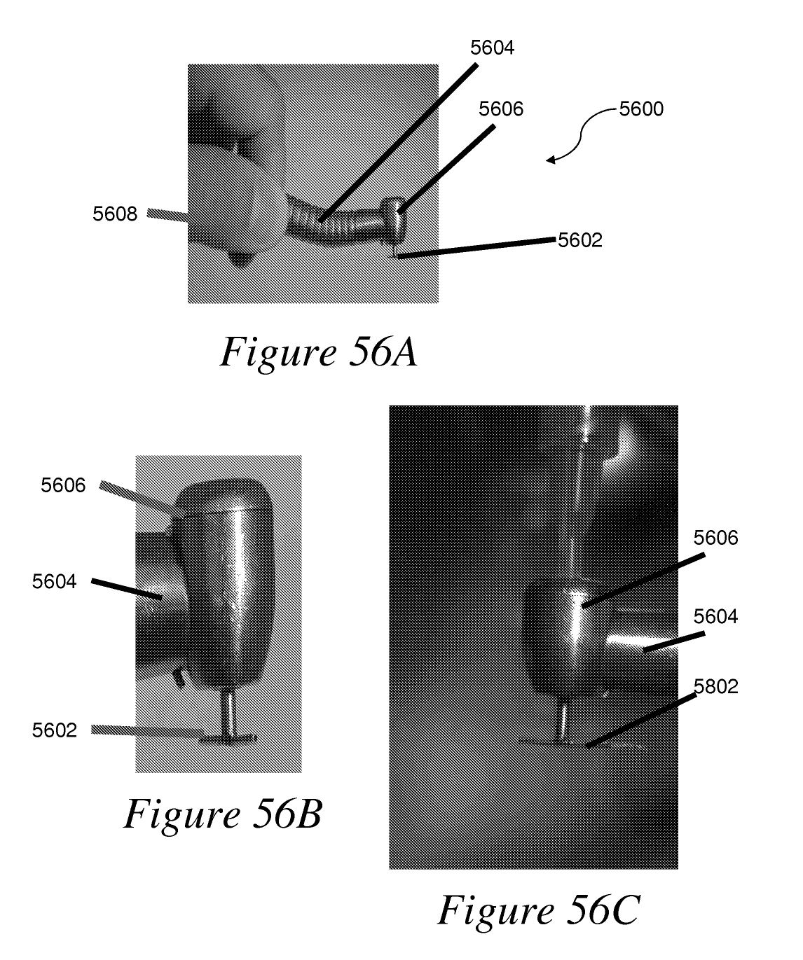

FIGS. 56A, 56B and 56C illustrate an exemplary hand-held fiber formation device 5600 that employs high speed rotational motion. FIG. 56A illustrates the device 5600 as held by a hand 5608. FIG. 56B illustrates a close-up view of the device 5600. FIG. 56C illustrates a snapshot in time of a high speed video of the device 5600 in operation. The device 5600 may include a custom miniature reservoir 5602 that may, in an exemplary embodiment, be formed using a laser micro-welder. The reservoir 5602 may be provided with one or more orifices through which the polymer material may be ejected. In an exemplary embodiment, the reservoir 5602 may be periodically or continually be supplied with a polymer material through, for example, a supply channel provided in a body portion 5604 of the device 5600. The body portion 5604 may be configured to be held by a hand 5608 and used to change the orientation of the reservoir 5602.

The reservoir 5602 may be coupled to a motion generator 5606, for example, a motor that is driven by an air-turbine. In exemplary embodiments, the motion generator 5606 may rotate the reservoir 5602 at rotational speeds of about 50,000 to about 110,000 rpm, although exemplary rotational speeds are not limited to this exemplary range. In an exemplary embodiment, the rotational speed may be about 108,000 rpm.

In an alternative embodiment, the reservoir may not be rotated, but may be pressurized to eject the polymer material from the reservoir through one or more orifices. For example, a mechanical pressurizer may be applied to one or more surfaces of the reservoir to decrease the volume of the reservoir, and thereby eject the material from the reservoir. In another exemplary embodiment, a fluid pressure may be introduced into the reservoir to pressurize the internal volume of the reservoir, and thereby eject the material from the reservoir.

In an exemplary fiber formation device 200 illustrated in FIG. 2, a linear motion is imparted on one or more collection devices 204 used to collect fibers to cause the collection device 204 to move in a linear back and forth motion. Although the exemplary collection device 204 illustrated in FIG. 2 is capable of movement, e.g., rotational motion and/or linear motion, other exemplary collection devices may be stationary as illustrated in the exemplary embodiment of FIG. 1.

Features of the fiber formation device 200 that are similar to features in the fiber formation device 100 are described in connection with FIG. 1. Such features include one or more reservoirs 202, a bottom reservoir surface 216, a side reservoir surface 218, a top reservoir surface 220, one or more reservoir orifices 214, one or more reservoir inlet ports 206, and one or more reservoir inlet pipes 208.

The collection device 204 is coupled directly or indirectly to one or more motion generators 210, e.g., a linear motor, an oscillating track system, a rotating motor, etc., that impart a motion to the collection device 204.

In an exemplary embodiment, the motion generator 110 imparts a substantially linear back and forth motion to the collection device 204 along substantially any axis in space suitable for fiber formation. In this case, the motion generator 110 may include one or more linear motion generators, e.g., oscillating track systems, linear motors, etc. In an exemplary embodiment, the collection device 204 is moved in a linear back and forth motion substantially along a longitudinal axis L that extends between the reservoir 202 and the collection device 204. In another exemplary embodiment, the collection device 204 is moved in a linear back and forth motion substantially along any transverse axis along the transverse plane T substantially orthogonal to the longitudinal axis L. In some exemplary embodiments, a linear motion generator moving back and forth along one axis may be coupled with one or more other linear motion generators moving back and forth along other axes to provide a resultant motion along a different axis.

In another exemplary embodiment, the linear back and forth motion of the collection device 204 along any axis may be combined with rotational motion, e.g., a rotational motion substantially about the longitudinal axis L. In this case, the motion generator 210 may include one or more linear motion generators, e.g., linear motors, oscillating track systems, etc., coupled with one or more rotational motion generators, e.g., rotary motors, etc.

In another exemplary embodiment, the motion generator 210 imparts a substantially rotational motion to the collection device 204, e.g., a rotational motion about the longitudinal axis L. In this exemplary embodiment, the motion generator 210 may include one or more rotational motion generators, e.g., rotational motors, etc.

In another exemplary embodiment, the motion generator 210 imparts other types of motions to the collection device 204, e.g., irregular motions, complex motion patterns, linear motion along different axes, rotational motion about different axes, motion that changes between linear and rotational, etc.

Exemplary embodiments may use different combinations of the exemplary motion generators to create and control desired weaves and/or alignments of the fibers formed by the motion of the collection device 204.

In exemplary embodiments, the velocity of the collection device 204, linear or rotational, may be kept substantially constant during a fiber formation session or may be increased or decreased during a fiber formation session. Exemplary linear velocities of the collection device 204 may range from about 5 m/s to about 40 m/s in some exemplary embodiments, but are not limited to this exemplary range.

The collection device 204 may be coupled to the linear motion generator 210 using one or more mechanical coupling members 212, e.g., a rod, piston, etc., that reliably and efficiently transfer the motion generated by the motion generator 210 to the collection device 204. The motion generator 210 may be coupled to an electrical power source (not shown), e.g., electrical mains or one or more batteries, that supplies electrical power to power the generator 210.

In operation, a material solution in the reservoir 202 is ejected through one or orifices 214 present on the walls of the reservoir. In an exemplary embodiment, the material solution is caused to be ejected from the reservoir 202 by an increased pressure of the material solution or of another fluid (e.g., air) within the reservoir 202. In another exemplary embodiment, the material solution is caused to be ejected from the reservoir 202 by a motion of the reservoir 202. For example, the reservoir 202 may be moved in a rotational and/or linear manner by one or more motion generators to cause the material solution to be pulled against the walls of the reservoir 202 and through one or more orifices 214 that are present on the walls. The material solution forms one or more jets as it is pulled through one or more orifices 214 which exit the reservoir 202. As the material jets extend through the air in the space between the reservoir 202 and the collection device 204, air drag causes the jets to extend and lengthen into polymeric fibers as the solvent in the material solution evaporates. The fibers subsequently descend onto and are collected by the moving collection device 204.

In an exemplary fiber formation device 300 illustrated in FIG. 3, a linear velocity is imparted on one or more reservoirs 302 containing a material solution and on one or more collection devices 304 for collecting fibers formed from the material solution. Features shown in FIG. 3 similar to the features of FIGS. 1 and 2 are described in connection with FIGS. 1 and 2.

Features of the fiber formation device 300 that are similar to features in the fiber formation devices 100 and 200 are described in connection with FIGS. 1 and 2, respectively. Such features include one or more collection devices 304, one or more reservoirs 302, a bottom reservoir surface 316, a side reservoir surface 318, a top reservoir surface 320, one or more reservoir orifices 314, one or more reservoir inlet ports 306, one or more reservoir inlet pipes 308, one or more motion generators 310 for moving the reservoir 302 and the collection device 304, and one or more mechanical coupling members 312 for coupling the motion generators 310 to the reservoir 302 and the collection device 304. In an exemplary embodiment, the same motion generators 310 may move the reservoir 302 and the collection device 304. In another exemplary embodiment, separate motion generators 310 may be provided for moving the reservoir 302 and the collection device 304.

In operation, the motion generator 310 moves the reservoir 302 back and forth in a linear manner, the inertia of a material solution in the reservoir 302 resists the linear motion of the motion generator 310 and the reservoir 302. This causes the material solution to be pulled against one or more walls of the reservoir 302 and through one or more orifices 314 that are present on the walls. The material solution forms one or more jets as it is pulled through one or more orifices 314 which exit the reservoir 302. As the material jets extend through the air in the space between the reservoir 302 and the collection device 304, air drag causes the jets to extend and lengthen into polymeric fibers as the solvent in the material solution evaporates. The fibers subsequently descend onto and are collected by the moving collection device 304.

Exemplary fiber formation devices 100, 200 and 300 may employ one or more mechanisms to control the force and/or speed with which the material jet leaves the reservoir through one or more orifices. In an exemplary embodiment, the speed (linear and/or rotational) and/or magnitude of the motion (e.g., the distance traveled by the motion generator along a linear axis) of the motion generator may be increased to increase the pressure of the material solution in the reservoir which, in turn, increases the force and/or the speed with which the jets leave the reservoir, and vice versa. In an exemplary embodiment, the material solution may be fed into the reservoir through the inlet port during fiber formation to increase the pressure of the material solution in the reservoir which, in turn, increases the force and/or the speed with which the jets leave the reservoir, and vice versa. In an exemplary embodiment, the material solution may be fed into the reservoir through the inlet port at a faster or a slower rate to increase or decrease, respectively, the pressure of the material solution in the reservoir. This, in turn, raises or lowers, respectively, the force and/or the speed with which the jets leave the reservoir.

Exemplary fiber formation devices 100, 200 and 300 may employ the controllable linear motion of the reservoir to control alignment of the resulting fibers. Controlling one or more aspects of the linear motion of an exemplary reservoir enables control over the deposition and alignment of each layer of polymeric fibers onto the collection device. Exemplary aspects of the linear motion that may be controlled in exemplary devices 100, 200 and 300 include, but are not limited to, the speed of the linear motion of the reservoir, the force and/or speed with which the material jet leaves the reservoir, the dimensions of the reservoir, etc.

In some exemplary embodiments, the speed with which an exemplary motion generator oscillates the reservoir and/or the collection device affects the pitch of the helical fibers and the spacing between the fibers. An increasing vertical speed of the reservoir and/or the collection device typically results in an increased pitch of the helical fibers. Accordingly, in an exemplary embodiment, the pitch of the fibers formed is increased by increasing the linear speed of the oscillating reservoir and/or the oscillating collection device along the vertical direction, and vice versa. An increasing vertical speed of the reservoir and/or the collection device typically results in an increased spacing between the fibers. Accordingly, in an exemplary embodiment, the fiber spacing formed is increased by increasing the linear speed of the oscillating reservoir and/or the oscillating collection device along the vertical direction, and vice versa.

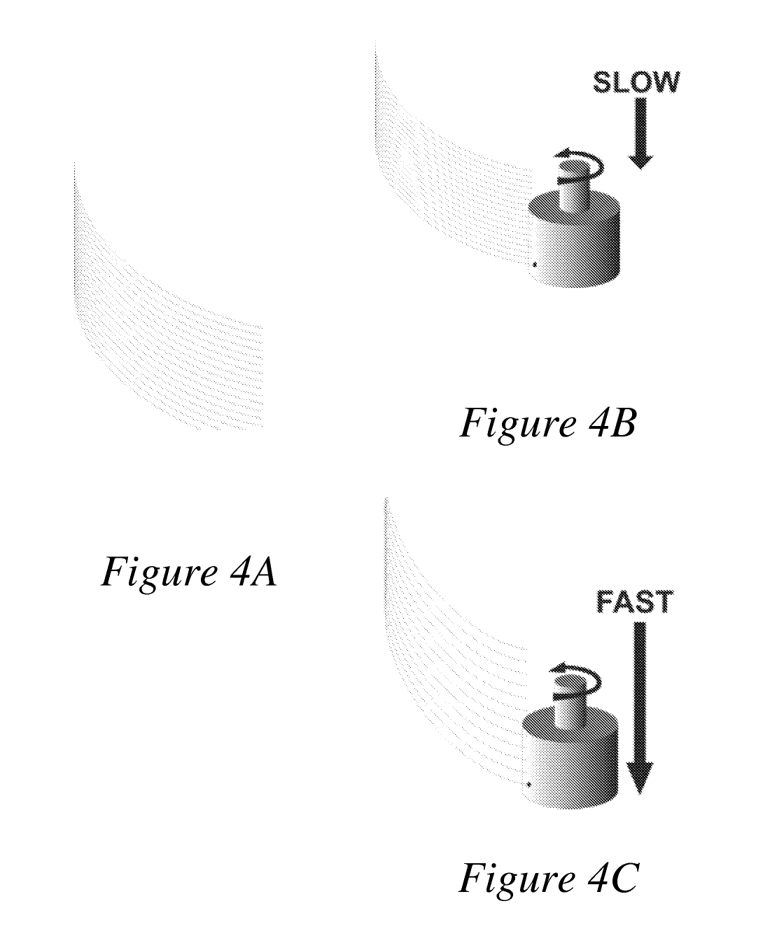

FIG. 4A illustrates exemplary fibers that may be formed by exemplary devices 100, 200 and 300. The fibers have a characteristic pitch angle and a characteristic spacing between the fibers. FIG. 4B illustrates exemplary fibers formed by a slower linear motion of an exemplary reservoir and/or collection device. FIG. 4C illustrates exemplary fibers formed by a faster linear motion of an exemplary reservoir and/or collection device than FIG. 4B. The exemplary fibers of FIG. 4B have a smaller pitch and smaller spacing between the fibers than the exemplary fibers of FIG. 4C, which shows that faster linear motions may be used to increase the pitch and/or fiber spacing, and vice versa.

In some exemplary embodiments, the polymeric fiber configuration formed on the collection device in exemplary devices of the invention, e.g., a mat configuration, a mesh configuration, etc., may be controlled by controlling aspects of the linear motion of the reservoir and/or the collection device. In some exemplary embodiments, the pore sizes formed between fibers of a mesh configuration, e.g., larger or smaller pore sizes, may be controlled by controlling aspects of the linear motion of the reservoir and/or the collection device in exemplary devices 100, 200 and 300. An increasing vertical speed of the reservoir and/or collection device typically results in larger pore sizes of the fibers, and vice versa. Accordingly, in an exemplary embodiment, the pore sizes of a polymeric fiber mesh structure formed is increased by increasing the linear speed of the oscillating reservoir and/or oscillating collection device along the vertical direction, and vice versa. Thus, exemplary devices 100, 200 and 300 may be used to form fibers of different porosities, e.g., for filters with varying pore sizes, for a cell-scaffold with a desired pore size which may be used to select a desired cell-scaffold infiltration, etc.

In an exemplary embodiment, as the reservoir and/or the collection device is oscillated in a linear manner while the reservoir is being rotated, the fibers are deposited in a controlled mesh structure, wherein the linear velocity of the reservoir and/or collection device determines the mesh pore size and the pitch of the polymeric fiber mesh structure. The pore size depends on the fiber diameter as well as the fiber pitch. A maximum pore size typically results from large fibers and an approximately 45 degree pitch in one direction. In this exemplary embodiment, fibers exiting the orifices of the reservoir at an approximately 45 degree angle in one direction are deposited in an approximately −45 degree angle in the other direction due to the linear motion. This results in the formation of layers of fibers that overlap each other at approximately 90 degrees.

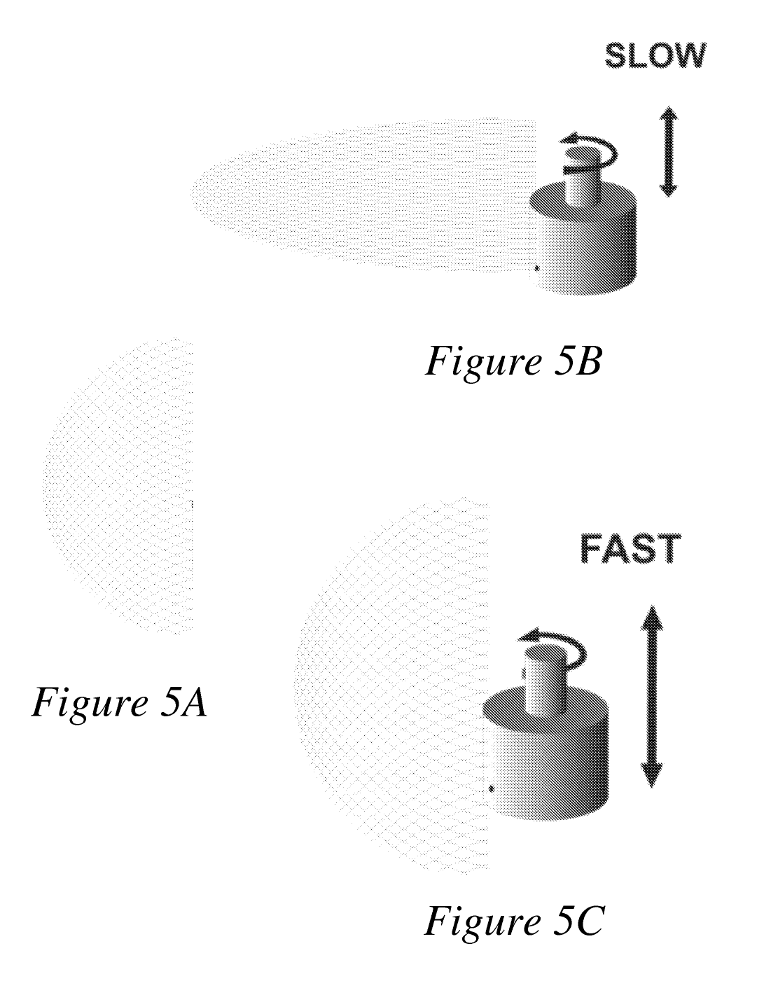

FIG. 5A illustrates exemplary fibers that may be formed in a mesh configuration by exemplary devices 100, 200 and 300. The fibers have a characteristic pitch angle and a characteristic pore size of pores formed between the fibers. FIG. 5B illustrates an exemplary polymeric fiber mesh structure formed by a slower linear motion of an exemplary reservoir and/or collection device. FIG. 5C illustrates an exemplary polymeric fiber mesh structure formed by a faster linear motion of an exemplary reservoir and/or collection device than FIG. 5B. The exemplary polymeric fiber mesh structure of FIG. 5B has a smaller pitch and smaller pore sizes than the exemplary polymeric fiber mesh structure of FIG. 5C, which shows that faster linear speeds may be used to increase the pitch and/or fiber spacing in a polymeric fiber mesh structure, and vice versa.

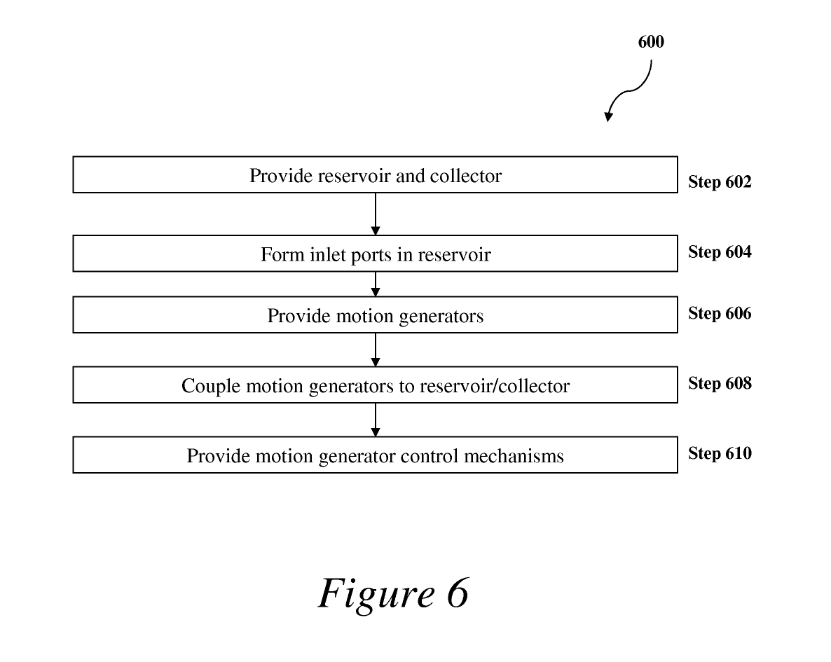

FIG. 6 is a flowchart illustrating an exemplary method 600 for forming or manufacturing an exemplary fiber formation device. In step 602, one or more reservoirs are provided for holding a material solution and one or more collection devices are provided for collecting polymeric fibers. In an exemplary embodiment, in step 604, one or more inlet ports are formed in the reservoir for introduction of the material solution into the reservoir, and one or more orifices are formed in the reservoir through which the material solution may be ejected during fiber formation. In another exemplary embodiment, the reservoir has one or more pre-formed inlet ports and one or more pre-formed orifices.

In step 606, one or more motion generators are provided for moving the reservoir, the collection device, or both the reservoir and the collection device during fiber formation. In step 608, the reservoir and/or the collection device are coupled to the motion generators. In an exemplary embodiment, the motion generators may be directly coupled to the reservoir and/or the collection device. For example, one or more motors may be provided on or integrally with the reservoir and/or the collection device. In other exemplary embodiments, the motion generators may be coupled to the reservoir and/or the collection device indirectly using one or more mechanical members, e.g., rods.

In step 610, one or more power sources and/or motion generator control mechanisms are provided integrally with the reservoir and/or the collection device, or separately from the reservoir and/or the collection device. The power sources, e.g., one or more batteries, provide electrical energy to the motion generators. The motion generator control mechanisms, e.g., one or more signal generators, control the movement of the motion generators, e.g., activation of the motion generators, the speed of the motion generators, the magnitude of the motion of the motion generators, etc. The motion generator control mechanisms may be used to pre-program the motion of the motion generators. The motion generator control mechanisms may be used to start, stop and alter the motion of the motion generators for a fiber formation session.

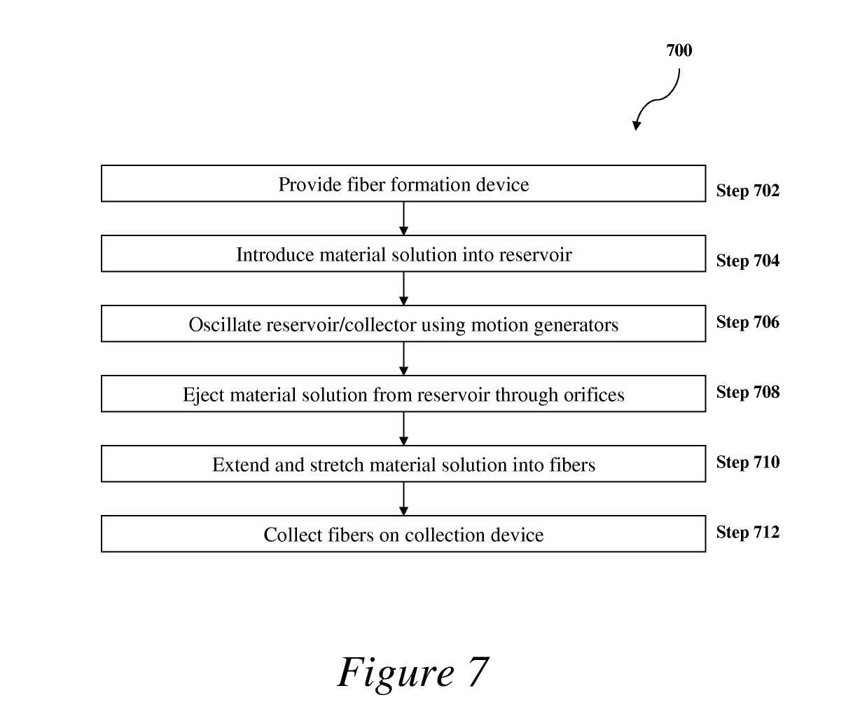

FIG. 7 is a flowchart illustrating an exemplary method 700 for using an exemplary fiber formation device to form fibers from a material solution. In step 702, an exemplary fiber formation device is provided, for example, in accordance with method 600 illustrated in FIG. 6. In step 704, the material solution is introduced into the reservoir, for example, through one or more inlet ports of the reservoir. The material solution may be introduced into the reservoir at one time, two or more times, continuously or periodically. The volume and flow rate of the material solution introduced into the reservoir may be kept constant or altered based on the requirements of fiber formation.

In step 706, the reservoir, the collection device, or both the reservoir and the collection device are moved using one or more motion generators linearly in a back-and-forth manner or in a combination of linear and rotational motions. In step 708, the material solution is ejected from the reservoir through one or more orifices in the reservoir. In step 710, the material is extended and stretched into fibers due to air drag and evaporation of the solvent in the material solution. In step 712, the resulting fibers are collected on one or more collection devices that may be stationary or moving.

Exemplary devices 100, 200, and 300 may be subjected to a linear motion at a velocity of about of, e.g., about 650 millimeters/second (mm/sec) to about 33,000 mm/sec, about 650 mm/sec to about 26,000 mm/sec, 650 mm/sec to about 19,000 mm/sec, about 650 mm/sec to about 13,000 mm/sec, about 3,200 mm/sec to about 13,000 mm/sec, about 3,200 mm/sec to about 9,800 mm/sec, or about 650, 700, 750, 800, 850, 900, 950, 1,000, 1,100, 1,200, 1,300, 1,400, 1,500, 1,600, 1,700, 1,800, 1,900, 2,000, 2,100, 2,200, 2,300, 2,400, 2,500, 2,600, 2,700, 2,800, 2,900, 3,000, 3,100, 3,200, 3,300, 3,400, 3,500, 3,600, 3,700, 3,800, 3,900, 4,000, 4,100, 4,200, 4,300, 4,400, 4,500, 4,600, 4,700, 4,800, 4,900, 5,000, 5,100, 5,200, 5,300, 5,400, 5,500, 5,600, 5,700, 5,800, 5,900, 6,000, 6,100, 6,200, 6,300, 6,400, 6,500, 6,600, 6,700, 6,800, 6,900, 7,000, 7,100, 7,200, 7,300, 7,400, 7,500, 7,600, 7,700, 7,800, 7,900, 8,000, 8,100, 8,200, 8,300, 8,400, 8,500, 8,600, 8,700, 8,800, 8,900, 9,000, 9,100, 9,200, 9,300, 9,400, 9,500, 9,600, 9,700, 9,800, 9,900, 10,000, 102,100, 10,200, 10,300, 10,400, 10,500, 10,600, 10,700, 10,800, 10,900, 11,000, 11,100, 11,200, 11,300, 11,400, 11,500, 11,600, 11,700, 11,800, 11,900, 12,000, 12,100, 12,200, 12,300, 12,400, 12,500, 12,600, 12,700, 12,800, 12,900, 13,000, 13,100, 13,200, 13,300, 13,400, 13,500, 13,600, 13,700, 13,800, 13,900, 14,000, 14,100, 14,200, 14,300, 14,400, 14,500, 14,600, 14,700, 14,800, 14,900, 15,000, 15,100, 15,200, 15,300, 15,400, 15,500, 15,600, 15,700, 15,800, 15,900, or about 16,000 mm/sec. Ranges and values intermediate to the above recited ranges and values are also contemplated to be part of the invention. For example, speeds of about 6,500 mm/sec-9,800 mm/sec, or 5,200 mm/sec-7,800 mm/sec are intended to be encompassed by the methods of the invention.

Exemplary devices 100, 200, and 300 may be subjected to a linear motion for a time sufficient to form a desired polymeric fiber, such as, for example, about 1 minute to about 100 minutes, about 1 minute to about 60 minutes, about 10 minutes to about 60 minutes, about 30 minutes to about 60 minutes, about 1 minute to about 30 minutes, about 20 minutes to about 50 minutes, about 5 minutes to about 20 minutes, about 5 minutes to about 30 minutes, or about 15 minutes to about 30 minutes, about 5-100 minutes, about 10-100 minutes, about 20-100 minutes, about 30-100 minutes, or about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100 minutes, or more. Times and ranges intermediate to the above-recited values are also intended to be part of this invention.

Rotational speeds of the reservoir in exemplary embodiments may range from about 1,000 rpm-50,000 rpm, about 1,000 rpm to about 40,000 rpm, about 1,000 rpm to about 20,000 rpm, about 5,000 rpm-20,000 rpm, about 5,000 rpm to about 15,000 rpm, or about 50,000 rpm to about 400,000 rpm, e.g., about 1,000, 1,500, 2,000, 2,500, 3,000, 3,500, 4,000, 4,500, 5,000, 5,500, 6,000, 6,500, 7,000, 7,500, 8,000, 8,500, 9,000, 9,500,10,000, 10,500, 11,000, 11,500, 12,000, 12,500, 13,000, 13,500, 14,000, 14,500, 15,000, 15,500, 16,000, 16,500, 17,000, 17,500, 18,000, 18,500, 19,000, 19,500, 20,000, 20,500, 21,000, 21,500, 22,000, 22,500, 23,000, 23,500, or about 24,000, 50,000, 55,000, 60,000, 65,000, 70,000, 75,000, 80,000, 85,000, 90,000, 95,000, 100,000, 105,000, 110,000, 115,000, 120,000, 125,000, 130,000, 135,000, 140,000, 145,000, 150,000 rpm, about 200,000 rpm, 250,000 rpm, 300,000 rpm, 350,000 rpm, or 400,000 rpm. Ranges and values intermediate to the above recited ranges and values are also contemplated to be part of the invention.

In certain embodiments, rotating speeds of about 50,000 rpm-400,000 rpm are intended to be encompassed by the methods of the invention. In one embodiment, devices employing rotational motion may be rotated at a speed greater than about 50, 000 rpm, greater than about 55,000 rpm, greater than about 60,000 rpm, greater than about 65,000 rpm, greater than about 70,000 rpm, greater than about 75,000 rpm, greater than about 80,000 rpm, greater than about 85,000 rpm, greater than about 90,000 rpm, greater than about 95,000 rpm, greater than about 100,000 rpm, greater than about 105,000 rpm, greater than about 110,000 rpm, greater than about 115,000 rpm, greater than about 120,000 rpm, greater than about 125,000 rpm, greater than about 130,000 rpm, greater than about 135,000 rpm, greater than about 140,000 rpm, greater than about 145,000 rpm, greater than about 150,000 rpm, greater than about 160,000 rpm, greater than about 165,000 rpm, greater than about 170,000 rpm, greater than about 175,000 rpm, greater than about 180,000 rpm, greater than about 185,000 rpm, greater than about 190,000 rpm, greater than about 195,000 rpm, greater than about 200,000 rpm, greater than about 250,000 rpm, greater than about 300,000 rpm, greater than about 350,000 rpm, or greater than about 400,000 rpm.

Exemplary devices employing rotational motion may be rotated for a time sufficient to form a desired polymeric fiber, such as, for example, about 1 minute to about 100 minutes, about 1 minute to about 60 minutes, about 10 minutes to about 60 minutes, about 30 minutes to about 60 minutes, about 1 minute to about 30 minutes, about 20 minutes to about 50 minutes, about 5 minutes to about 20 minutes, about 5 minutes to about 30 minutes, or about 15 minutes to about 30 minutes, about 5-100 minutes, about 10-100 minutes, about 20-100 minutes, about 30-100 minutes, or about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100 minutes, or more. Times and ranges intermediate to the above-recited values are also intended to be part of this invention.

The fiber formation devices of the invention may be used to make fibers from a range of materials. Exemplary materials are discussed below and include synthetic polymers, such as polyethylene, polypropylene, poly(lactic acid), etc. In some exemplary embodiments, the synthetic polymers may be specifically synthesized to possess domains along the backbone that may be activated for specific purposes including, but not limited to, specific binding, folding, unfolding, etc. Exemplary materials may also include biogenic polymers, e.g., natural polymers, such as chitosan, alginate, gelatin, etc. Exemplary biogenic polymers may also include protein materials, such as collagen, fibronectin, laminin, etc. Exemplary materials may also include other suitable materials, e.g., metallic or ceramic materials.

Exemplary fiber formation devices of the invention may have many applications including, but not limited to, mass production of polymer or biogenic polymer fibers, production of ultra-aligned fibrous scaffolds, bio-functional fibrous scaffolds for in vitro tissue engineering applications, bio-functional fibrous scaffolds for in vivo tissue engineering applications, bio-functional suture threads, ultra-strong fiber and fabric production, bio-functional protein or polymer filters, protective clothing or coverings, etc.

### B. Exemplary Embodiments Employing Air Jets

Exemplary embodiments provide systems, devices and methods for forming fibers that employ one or more gas jets.

In some exemplary embodiments, one or more gas jets may be employed in a fiber formation device to increase the shear forces that are imparted to a polymer material as it is ejected from a reservoir. Increased shear forces facilitate in unfolding of the structure of the polymer material and facilitate fiber formation, i.e., fibrillogenesis. In an exemplary embodiment, the gas jet may be applied coaxially with the polymer material as it is ejected from the reservoir in order to maximize the impact of the shear forces in facilitating fiber formation.

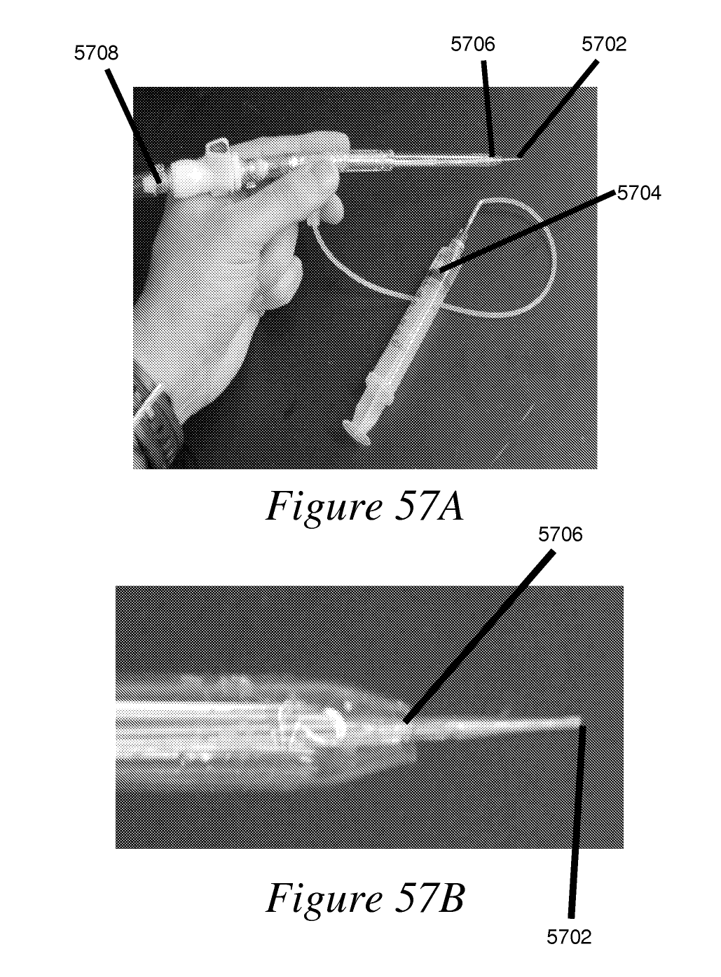

FIGS. 57A and 57B illustrate an exemplary prototype including an exemplary polymer nozzle 5702 for ejecting a polymer material and an air jet nozzle for providing one or more air jets. FIG. 57A is a perspective view of the exemplary prototype. FIG. 57B is a side close-up view of a polymer nozzle and an associated air jet nozzle. In an exemplary embodiment, the polymer nozzle 5702 may be coupled to a reservoir (not shown) or to any suitable supply mechanism for supplying the polymer material, e.g., a syringe 5704 containing the polymer material. An exemplary polymer nozzle may have an exemplary diameter ranging from about one micron to about five mm, but is not limited to this exemplary range. The prototype may also include a coaxial air jet nozzle 5706 for providing one or more air jets coaxially with the polymer material as it is ejected from the nozzle 5702. The prototype may also include a supply mechanism 5708 for providing one or more air jets coaxially with the ejected polymer material. The air jets may facilitate fiber formation by increasing the shear forces experienced by the polymer material. In some exemplary embodiments, the direction of the air jet may be changed to control the direction in which the fibers are formed. Exemplary air pressures at the air jet may range from about 10 psi to about 1,000 psi. An exemplary air jet nozzle 5706 may have an exemplary diameter ranging from about one mm to about twenty mm, but is not limited to this exemplary range. In an exemplary configuration, the air jet nozzle 5706 may be spaced from the polymer nozzle 5702 in a direction away from the directions of the polymer and air jet, by an exemplary distance ranging from about 0.5 cm to about 2 cm, although the distance is not limited to this exemplary range.

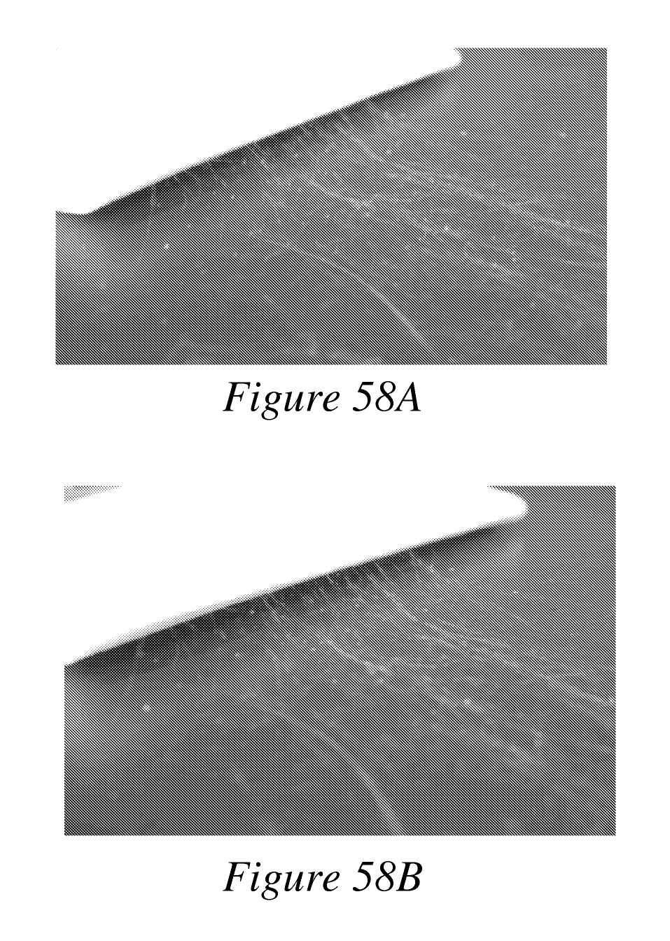

The exemplary fiber formation device of FIGS. 57A and 57B may be used to spray fibers onto a substrate, for example, as illustrated in FIGS. 58A and 58B.

FIGS. 58A and 58B illustrate perspective views of nanofibers that are sprayed onto a substrate using the exemplary device of FIGS. 57A and 57B.

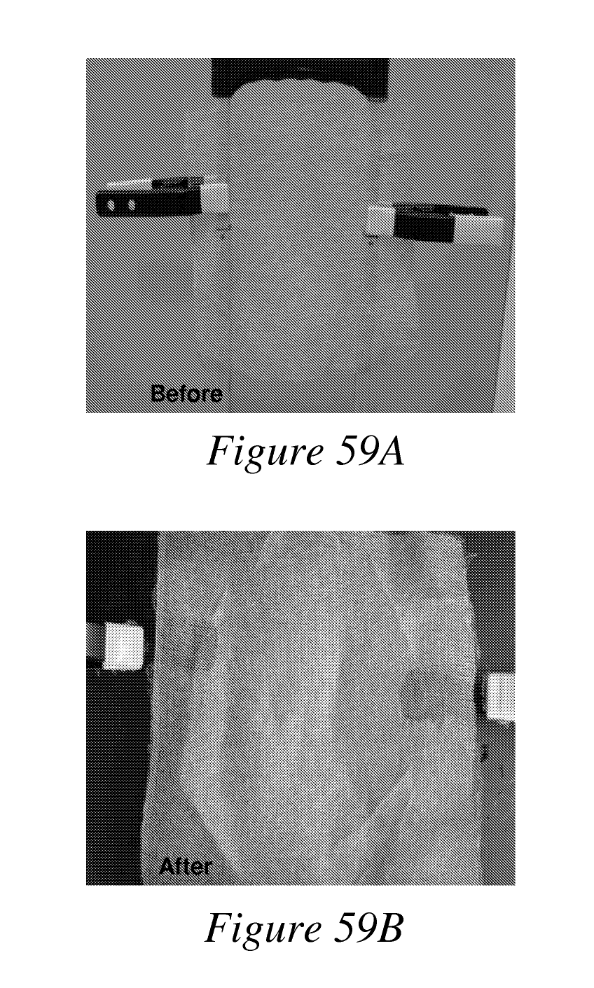

FIGS. 59A and 59B illustrate before and after views, respectively, of an exemplary 12″×12″ steel mesh that is sprayed with 8% poly-lactic acid nanofibers for about sixty seconds using the exemplary device of FIGS. 57A and 57B to demonstrate airbrush-type application of the fibers.

In some exemplary embodiments, one or more air jets may be employed in a fiber formation device to form fibers that are wound into threads. In exemplary embodiments, a material solution ejected from a reservoir is used to form fibers, and one or more spinning air jets are used to wind the fibers into threads.

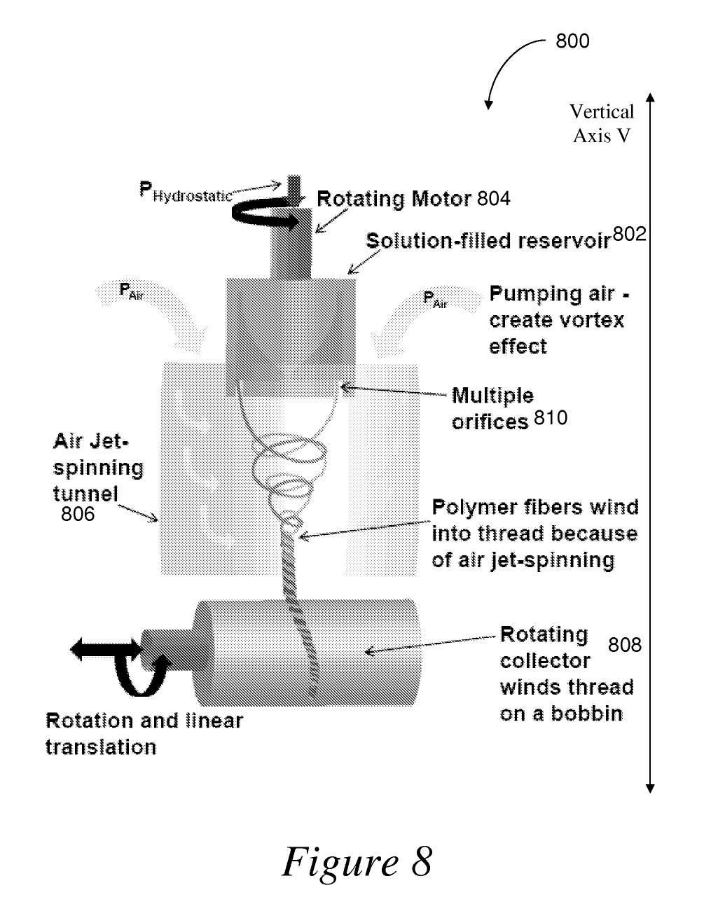

FIG. 8 illustrates an exemplary fiber formation device 800 that may be used in forming fibers that are wound into threads. The exemplary fiber formation device 800 includes one or more reservoirs 802 for holding a material solution. During fiber formation, the reservoir 802 is moved linearly in a back-and-forth manner, rotationally, or in a combination of linear and rotational motions using one or more motion generators 804, e.g., one or more motors. The motion of the reservoir 802 causes one or more jets of the material solution to be ejected from the reservoir. Air drag extends and elongates the jets into fibers. The device 800 includes an air jet-spinning vessel 806 disposed vertically below the reservoir 802 along the vertical axis V into which the fibers are introduced. The air jet-spinning vessel 806 circulates one or more vortices of air around the fibers as they fall through the air, thus winding the fibers into threads.

In an exemplary embodiment, the reservoir 802 is disposed vertically above the vessel 806 such that the jets of material solution descend through the air for a vertical distance before being influenced by the vortex of air in the vessel 806. In another exemplary embodiment, a lower portion of the reservoir 802 or the entire reservoir 802 is disposed within the vessel 806 such that the jets of material solution are influenced by the vortex of air in the vessel 806 as soon as the material solution is ejected from the reservoir 802. In an exemplary embodiment in which at least part of the reservoir 802 is lowered into the vessel 806, the orifices 810 of the reservoir 802 may be provided on a bottom side or bottom surface of the reservoir 802 so that the jets of material solution exiting the reservoir are directed into the vessel 806.

The exemplary device 800 includes one or more collection devices 808, e.g., a plate, bobbin, etc., disposed vertically below the air jet-spinning vessel 806 along the vertical axis V. The collection device 808 is used to collect the threaded fibers formed during the fiber formation process. Some exemplary collection devices 808 are stationary. Other exemplary collection devices 808 may move in a rotational manner, in a linear manner, or in a combination of rotational and linear manners. An exemplary rotating collection device 808 may have a grooved surface having one or more grooves or channels for directing the collection of fibers or threads. An exemplary rotating collection device 808 may be used to wind formed threads on a bobbin.

The reservoir 802 includes one or more orifices 810 through which one or more jets of the material solution are forced out of the reservoir 802 during fiber formation. Exemplary orifices 810 may have orifice channels having exemplary lengths that range between about one micron to about 10 millimeters. Exemplary orifices 810 may be located on any suitable side or surface of the reservoir 802.

The device 800 includes one or more motion generators 804. In an exemplary embodiment, the motion generator 804 imparts a linear motion to the reservoir 802. In another exemplary embodiment, the motion generator 804 imparts a rotation motion to the reservoir 802. An exemplary rotational motion generator is described in International (PCT) Patent Application Serial Number PCT/US10/34662. An exemplary rotational motion generator 804 may rotate at exemplary speeds that range from about 9 rpm to about 64,000 rpm. In another exemplary embodiment, the motion generator 804 imparts a combination of linear and rotational motions to the reservoir 802. In another exemplary embodiment, the motion generator 804 imparts another type of motion to the reservoir 802.

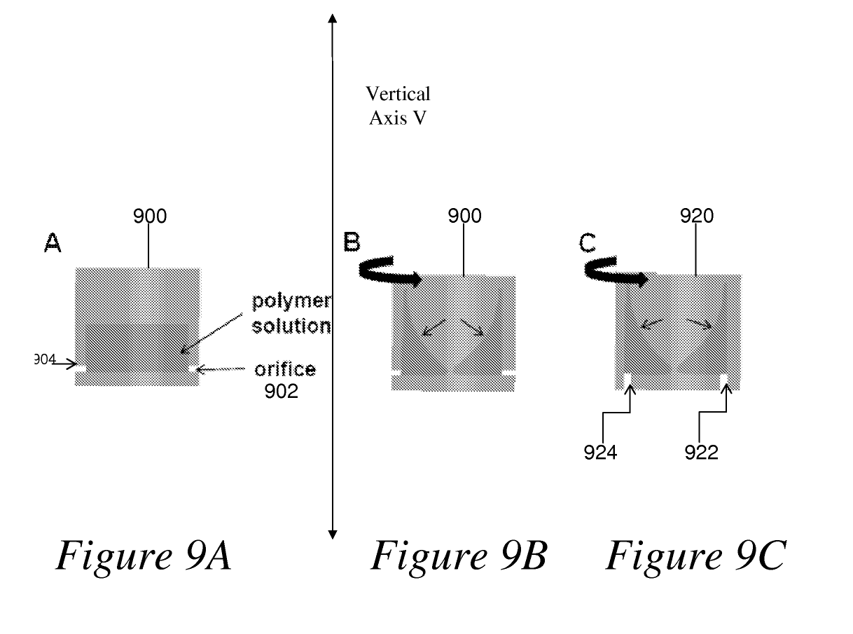

FIG. 9A illustrates a cross-sectional view taken along a vertical axis V through an exemplary reservoir 900 which contains a material solution and that includes orifices 902 and 904 provided in a side wall or side surface of the reservoir 900. FIG. 9B illustrates the material solution in the exemplary reservoir 900 when the reservoir is rotated about the vertical axis V extending centrally through the reservoir. FIG. 9C illustrates the material solution in an exemplary reservoir 920 when the reservoir is rotated about the vertical axis V. The reservoir 920 contains a material solution and includes orifices 922 and 924 provided in a bottom wall of the reservoir 900 that faces a collection device. In FIGS. 9B and 9C, the inertia of the material solution in the reservoir resists the rotational motion of the reservoir. This causes the material solution to be pulled against one or more internal surfaces or walls of the reservoir and through one or more orifices that are present on the walls. The material solution forms one or more jets as it is pulled through an orifice which exit the reservoir.

Exemplary orifices 810 may have any suitable cross-sectional geometry including, but not limited to, circular, oval, square, rectangular, etc. In an exemplary embodiment, one or more nozzles may be provided at an exemplary orifice 810 to provide control over the rate of flow, speed, direction, mass, shape and/or the pressure of the material solution that emerges from the reservoir 802. The location, cross-sectional geometry and arrangement of the orifices 810 and/or the nozzles may be configured based on the desired characteristics of the resulting fiber and/or one or more other factors including, but not limited to, viscosity of the material solution and the rate of solvent evaporation during fiber formation.

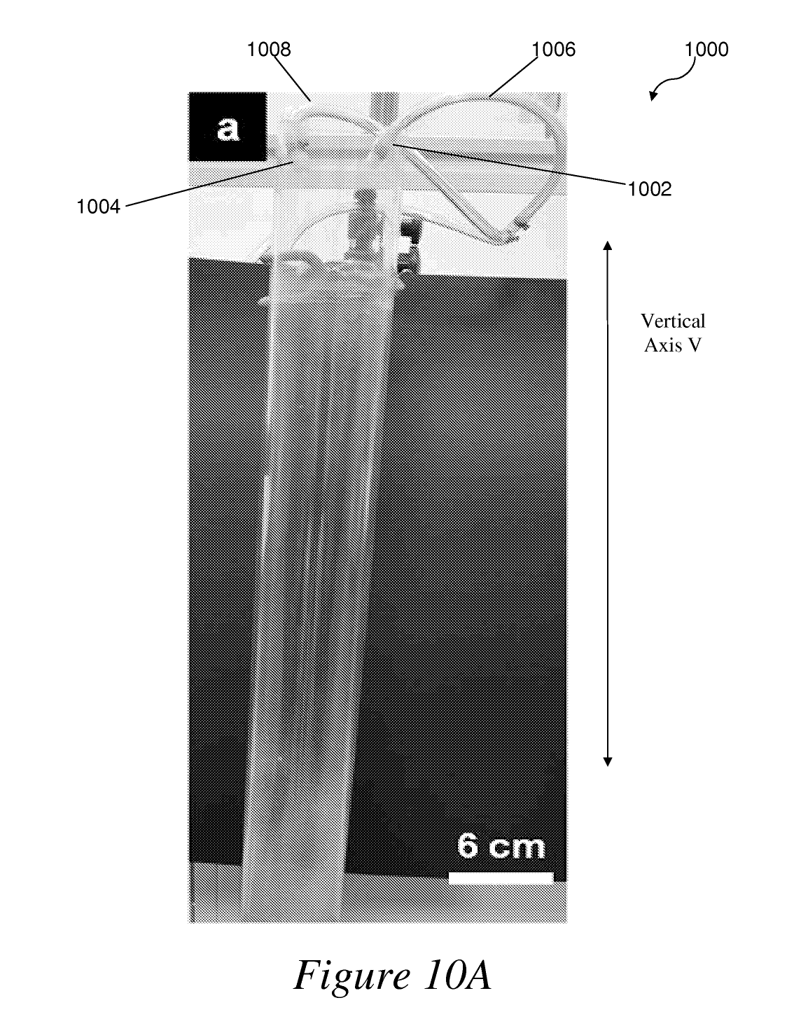

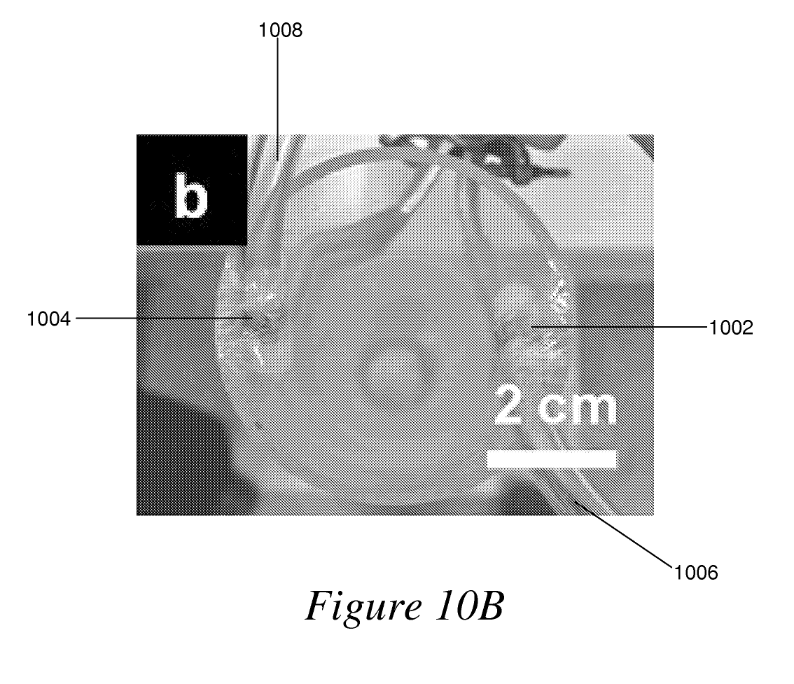

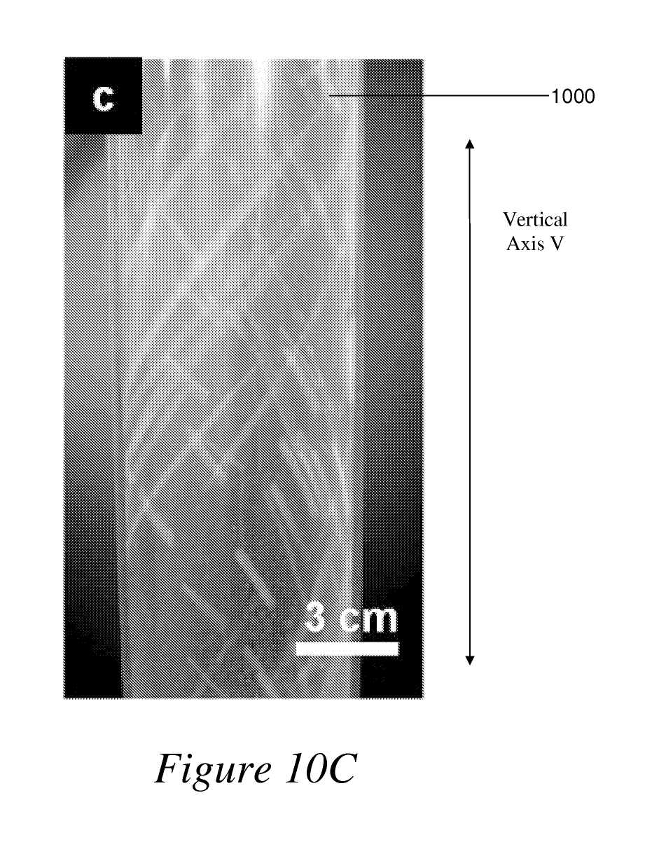

Exemplary air jet-spinning vessels include any suitable means for providing one or more twisting air flows for winding fibers into threads. FIG. 10A illustrates an exemplary air jet-spinning vessel 1000 that circulates one or more vortices of air around the fibers as they fall through the air, thus winding the fibers into threads. The exemplary vessel 1000 includes a vessel body that extends vertically between the reservoir and the collection device and that includes an internal space for accommodating fibers and the vortices of air. The vessel 1000 may have any suitable structure including, but not limited to, a cylindrical structure. The vessel 1000 may be formed of any suitable material including, but not limited to, acrylic, steel, etc. The vessel may have any suitable size. An exemplary height of the exemplary cylindrical vessel 1000 may range from about 0.5 m to about 2.5 m, but is not limited to this exemplary range. An exemplary radius of the exemplary cylindrical vessel 1000 may range from about 1 cm to about 10 cm, but is not limited to this exemplary range.

An exemplary air pressure inside a vessel 1000 may range from about 10 psi to about 30 psi, but is not limited to this exemplary range. An exemplary air speed inside a vessel 1000 may range from about 1 m/s to about 3 m/s, but is not limited to this exemplary range.

A top portion of the vessel 1000 includes one or more nozzles 1002 and 1004 coupled to one or more air supply tubes 1006 and 1008, respectively. In exemplary embodiments, a vessel 1000 may include one nozzle, two nozzles, three nozzles, four nozzles, five nozzles, or any higher number of nozzles. The nozzles 1002 and 1004 introduce air pressure in vortices or air jets from the air supply tubes 1006 and 1008 into the vessel 1000 to create an air vortex in the vessel 1000. The nozzles 1002 and 1004 are angled relative to the vertical axis V and introduces angled jets of air into the interior of the vessel 1000 from the air supply tubes 1006 and 1008, respectively. FIG. 10B illustrates a top view of the angled nozzles 1002 and 1004. The angled configuration of the nozzles 1002 and 1004 causes the air introduced by the nozzles to flow in substantially helical rings vertically downward along the vessel 1000. FIG. 10C illustrates a frame image of a movie of small particles traveling through the exemplary vessel 1000 in operation, which shows the paths of the air flow in helical rings down the length of the vessel 1000.

In operation, as an exemplary motion generator 804 moves the reservoir 802, the inertia of the material solution in the reservoir resists the motion of the motion generator and the reservoir. This causes the material solution to be pulled against one or more walls of the reservoir 802 and through one or more orifices 810 that are present on the walls. The material solution forms jets as it is pulled through the orifices 810 and exits the reservoir 802.

In an exemplary embodiment in which the material solution contains biogenic polymer, e.g., protein molecules, while traveling through the orifice channels, shear forces on the biogenic polymer, e.g., proteins, may cause chain unfolding which exposes binding domains. The biogenic polymer fibers that exit the reservoir may be in an extended state with cryptic binding domains exposed. Exemplary embodiments may configure the unfolded/folded state of the biogenic polymer fibers by controlling one or more factors including, but not limited to, the orifice diameter, orifice length, the rotation speed of the reservoir, etc.

The material jets extend through the air and solvent evaporation leads to the formation of polymeric fibers before reaching the air jet-spinning vessel 806. The angled air jets produced in the vessel 806 cause the fibers to be spun in helical rings as they descend through the vessel 806. This causes two or more fibers of solid, partially solidified or liquid jets, or of folded or unfolded biogenic polymer, e.g., protein, to be twisted or braided to form one or more fused threads before descending to the collection device 808.

In an exemplary embodiment in which the material solution includes biogenic polymer, e.g., protein molecules, because the biogenic polymeric fibers come into contact with each other in an extended state, the biogenic polymeric fibers relax after winding. In exemplary embodiments, polymers may be synthesized to have folded/unfolded domains. Exemplary embodiments may control the solvent evaporation rate of the material solution to create a covalently bound thread whose strength to diameter or cross-sectional area ratio far exceeds conventional threads or fibers.

The fused thread subsequently descends onto and is collected by the collection device 808 that is positioned below the vessel 806 and that moves in a rotational and/or linear manner. Exemplary device 800 may take advantage of solidification dependent polymeric fiber binding, shear unfolding, or chemically induced unfolding of biogenic polymer, e.g., protein molecules, to form ultra-strong polymeric fiber threads.

In some exemplary embodiments, the speed of the air in the vessel 806 is controlled to control the pitch of a desired thread. In an exemplary embodiment, the speed of the air in the vessel 806 is made substantially equal to the speed of the jet of material solution exiting the reservoir in order to form one or more continuous threads directly as the fibers exit the reservoir. In this exemplary embodiment, an exemplary speed of the jet exiting the reservoir, and similarly for the speed of the air in the vessel, ranges between about 100 cm/s to about 400 cm/s.

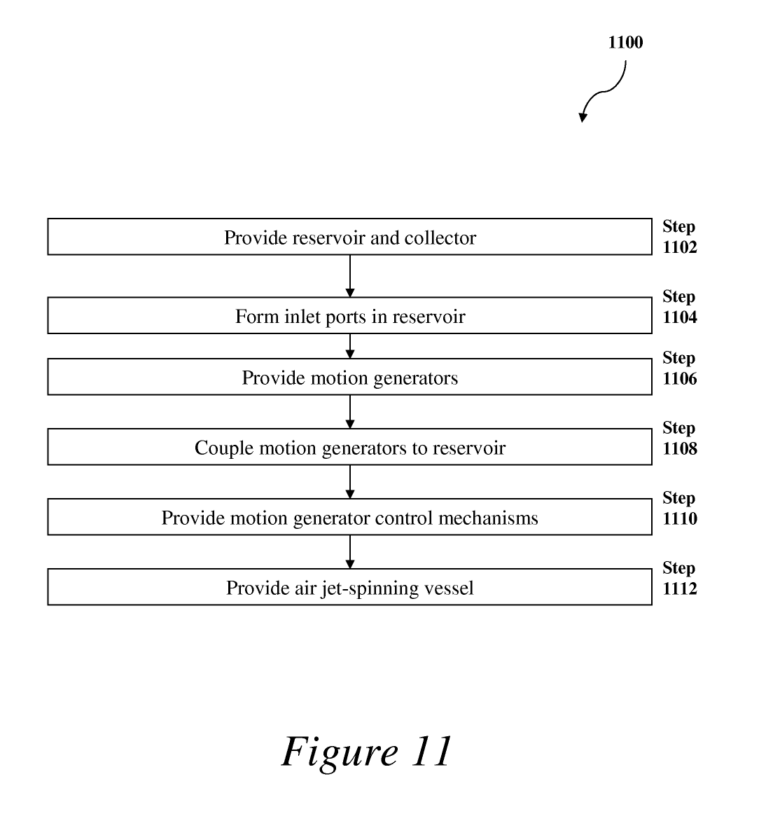

FIG. 11 is a flowchart illustrating an exemplary method 1100 for forming or manufacturing an exemplary fiber formation device. In step 1102, one or more reservoirs are provided for holding a material solution, and one or more collection devices are provided for collecting polymeric fibers. In an exemplary embodiment, in step 1104, one or more inlet ports are formed in the reservoir for introduction of the material solution into the reservoir, and one or more orifices are formed in the reservoir through which the material solution may be ejected during fiber formation. In another exemplary embodiment, the reservoir has one or more pre-formed inlet ports and one or more pre-formed orifices.

In step 1106, one or more motion generators are provided for moving the reservoir, the collection device, or both the reservoir and the collection device during fiber formation. In an exemplary embodiment, the motion generators provide a rotational motion to the reservoir. In other exemplary embodiments, the motion generators provide a linear motion or a combination of linear and rotational motions to the reservoir. For example, the reservoir may rotate about a central axis while linearly moving in a back-and-forth manner during fiber formation.

In step 1108, the reservoir is coupled to the motion generators. In an exemplary embodiment, the motion generators may be directly coupled to the reservoir. For example, one or more linear motors may be provided on or integrally with the reservoir. In other exemplary embodiments, the motion generators may be coupled to the reservoir using one or more mechanical members, e.g., rods.

In step 1110, one or more power sources and/or motion generator control mechanisms are provided either with the reservoir, or separately from the reservoir. The power sources, e.g., one or more batteries, provide electrical energy to the motion generators. The motion generator control mechanisms, e.g., one or more signal generators, control the movement of the motion generators, e.g., activation of the motion generators, the speed of the motion generators, etc.

In step 1112, an air jet-spinning vessel is provided. In step 1114, one or more angled air nozzles are formed in the air jet-spinning vessel and coupled to air supply means.

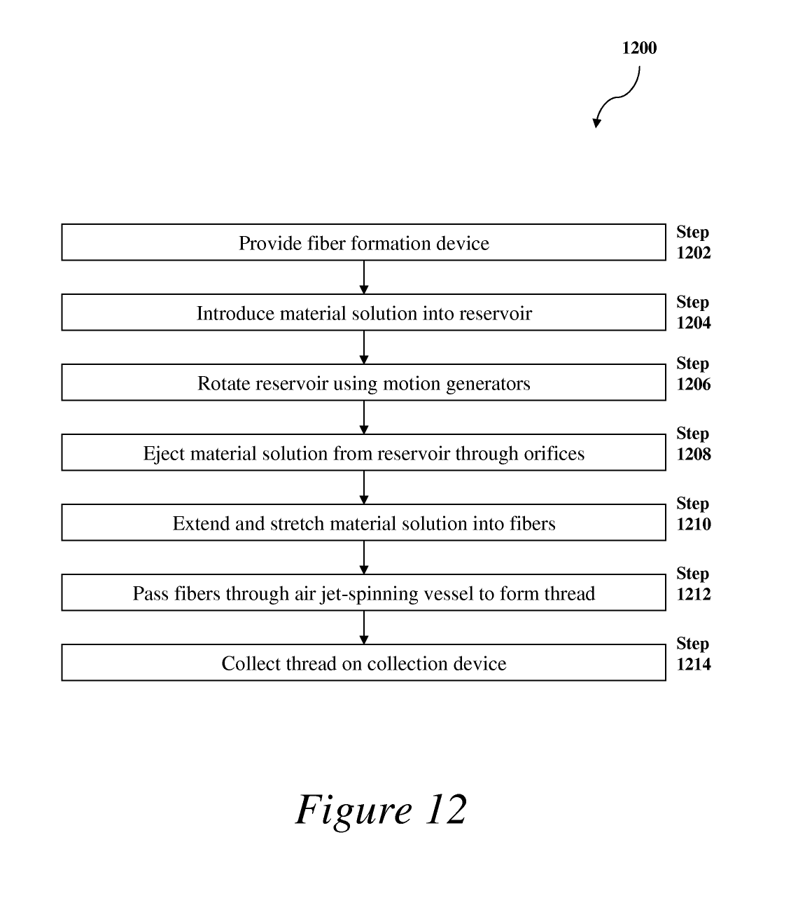

FIG. 12 is a flowchart illustrating an exemplary method 1200 for using an exemplary fiber formation device to form fibers wound into threads. In step 1202, an exemplary fiber formation device is provided, for example, in accordance with method 1100 illustrated in FIG. 11. In step 1204, the material solution is introduced into the reservoir, for example, through one or more inlet ports of the reservoir. The material solution may be introduced into the reservoir at one time, continuously or periodically. The volume and flow rate of the material solution into the reservoir may be controlled based on the requirements of the process of fiber formation.

In step 1206, the reservoir is moved using one or more motion generators. In step 1208, the motion of the reservoir causes the material solution to be ejected from the reservoir through one or orifices in the reservoir. In step 1210, the material is extended and stretched into fibers due to air drag. In step 1212, the resulting fibers are passed through an air jet-spinning vessel which winds the fibers into one or more threads. In step 1214, the thread is collected on one or more collection devices.

The exemplary fiber formation device 800 may be used to form fibers from a range of materials are described in more detail below and include, but not limited to, biogenic polymers, e.g., protein molecules, natural polymers, synthetic polymers, etc. Exemplary proteins used to form fibers using the exemplary device 800 include, but are not limited to, silk fibroin, fibronectin, vitronectin, collagen, laminin, etc. Natural polymers used to form fibers using the exemplary device 800 include, but are not limited to, chitosan, alginate, gelatin, etc. Exemplary synthetic polymers used to form fibers using the exemplary device 800 may or may not have been synthesized to contain domains on the backbone of the polymer that have the ability to be opened and closed by chemical or mechanical stimuli. The exemplary device 800 may be used to form polymeric fibers from synthetic polymers in which the resulting fused threads have enhanced mechanical, physical and/or chemical properties. One exemplary synthetic polymer is Kevlar threads for forward deployable manufacturing textiles.

Exemplary fiber formation device 800 may have many applications including, but not limited to, mass production of biogenic polymer, e.g., protein, fibers, mass production of ultra-strong biogenic polymer, e.g., protein, fibers, bio-functional fibrous scaffolds for in vitro tissue engineering applications, bio-functional fibrous scaffolds for in vivo tissue engineering applications, bio-functional suture threads, ultra-strong fiber and fabric production, bio-functional protein or polymer filters, protective clothing or coverings, etc.

One exemplary application of the exemplary fiber formation device 800 is in mimicking spider silk production. When spiders produce silk, proteins are extruded through small orifices. This process is thought to unfold the silk fibroin proteins. The fibers are subsequently wound into threads. At this time, when the proteins are returning to their relaxed state, they bind to form ultra-strong fibrous threads. The device 800 may be used to form such ultra-strong threads. In exemplary embodiments, the strength of the fiber threads may be controlled by tailoring the air speed in the air jet-spinning vessel 806 and/or by tailoring the protein unfolding to create bound threads at varying times throughout the unfolding/folding cycle of the molecules.

Biogenic polymers, e.g., proteins, may also be unfolded by a chemical method. In vivo the spider's duct contains a salt bridge. A salt bridge is a concentration gradient of ions through which the silk fibroin protein passes and is unfolded to expose cryptic binding domains. The properties of silk are a consequence of its repetitive primary amino acid sequence and mechanically robust secondary structure. Gupta, M. K., et al. A Facile Fabrication Strategy for Patterning Protein Chain Conformation in Silk Materials. Advanced Materials 22, 115-+(2010). Silk fibroin is composed of iterations of a highly repetitive hydrophobic core domain (rich in Alanine and Glycine) and its non-repetitive hydrophilic C-terminal domain. The conformation of silk II is mechanically stable as a tightly packed crystalline (β-sheet crystallites). These β-sheet crystallites act as physical crosslinks that greatly stabilize the protein structure, while enhancing the mechanical properties of the subsequent fiber formed, accounting for its high strength (1.1 GPa) and extensibility (27%). Heim, M., Romer, L. & Scheibel, T. Hierarchical structures made of proteins. The complex architecture of spider webs and their constituent silk proteins. Chemical Society Reviews 39, 156-164 (2010). Jiang, C. Y., et al. Mechanical properties of robust ultrathin silk fibroin films. Adv. Funct. Mater. 17, 2229-2237 (2007). The device 800 may include a salt bridge for unfolding proteins. The salt bridge may be located at one or more of the following components: in the reservoir 802, in a syringe feeding into the reservoir 802, or in the air jet-spinning vessel 806.

During silk spinning in vivo, the pH level is gradually decreased and NaCl is replaced by KPO₄, as water is resorbed by the epithelial cell lining of the duct. The change in salt gradients (along with elongation flow and shear force induced by the spinning process) induces a secondary structure transition because K⁺ and PO₄⁻ alter the hydration pattern of the protein surface. This causes the number of hydrophobic interactions within the protein to increase, promoting the formation of the highly stable β-sheet crystallites.

During its synthesis, fibroin monomers extend and their hydrophobic domains are unfolded in a step-wise manner. Dimers and oligomers interact via intermolecular interactions, initially forming α-helices when dimers from adjacent monomers interact via hydrophobic interactions (patches along monomer surfaces act as interaction domains for oligomerization). The dimer is further stabilized by an additional clamp like mechanism between two different helices, each coming from one of the two involved monomers. Conformational transitions can be induced by changing the local chemical conditions that reduce protein solubility and expose hydrophobic domains. This may induce tighter packing of the monomer. The driving force for the alignment of proteins is the elongational flow combined with shear stress.

### C. Exemplary Embodiments Employing Air Foils

Exemplary embodiments provide systems, devices and methods for controlling alignment of fibers formed from a material solution. Air flow and air turbulence in a fiber formation system are important parameters that affect the alignment of the fibers formed. In exemplary embodiments, one or more jets of a material solution are ejected from one or more reservoirs containing the material solution, and one or more air foils are used to modify the air flow and/or air turbulence in the surrounding air through which the jets of the material solution descend which, in turn, affects the alignment of the fibers that are formed from the jets. Exemplary polymeric fibers formed by exemplary fiber formation devices may range in size from about 50 nm to about 1 micron.

As used herein, an “air foil” refers to a single-part or multi-part mechanical member disposed or formed in the vicinity of one or more reservoirs to modify the air flow and/or the air turbulence in the surrounding air experienced by a material solution ejected from the reservoirs.

An exemplary air foil may be provided vertically above, vertically below, or both vertically above and below one or more orifices of a reservoir. Depending on the geometry and position of an exemplary air foil relative to the reservoir, the air flow created by the air foil may push fibers formed by the exemplary device upward or downward along the vertical direction.

In an exemplary embodiment, an exemplary air foil is provided or formed on or adjacent to the reservoir. In another exemplary embodiment, an exemplary air foil is provided or formed on or adjacent to one or more motion generators, e.g., one or more motors. In another exemplary embodiment, exemplary foils are provided or formed on or adjacent to both the reservoir and the motion generator. In some exemplary embodiments, one or more air foils may be provided separately from, but in the vicinity of, an exemplary fiber formation device.

In some exemplary fiber formation devices that include a plurality of reservoirs, one or more air foils may be provided separately for each reservoir, or one or more air foils may be provided commonly for all of the reservoirs.

An exemplary air foil may be stationary or moving. For example, an air foil provided on a rotating and/or oscillating reservoir may rotate and/or oscillate with the reservoir. Similarly, an air foil provided on a rotating and/or oscillating motion generator, e.g., motor, may rotate and/or oscillate with the motion generator.

Exemplary air foils may be formed of flexible materials (e.g., aluminum) and/or rigid materials (e.g., polymer sheets). Exemplary air foils may have two-dimensional or three-dimensional shapes. Exemplary two-dimensional shapes of air foils include, but are not limited to, triangular, circular, oval, square, propeller blade shape, etc. An exemplary air foil may have one or more pieces. In exemplary embodiments in which an air foil has multiple pieces, the multiple pieces may be provided separately or integrally together. The sizes of exemplary air foils may vary.

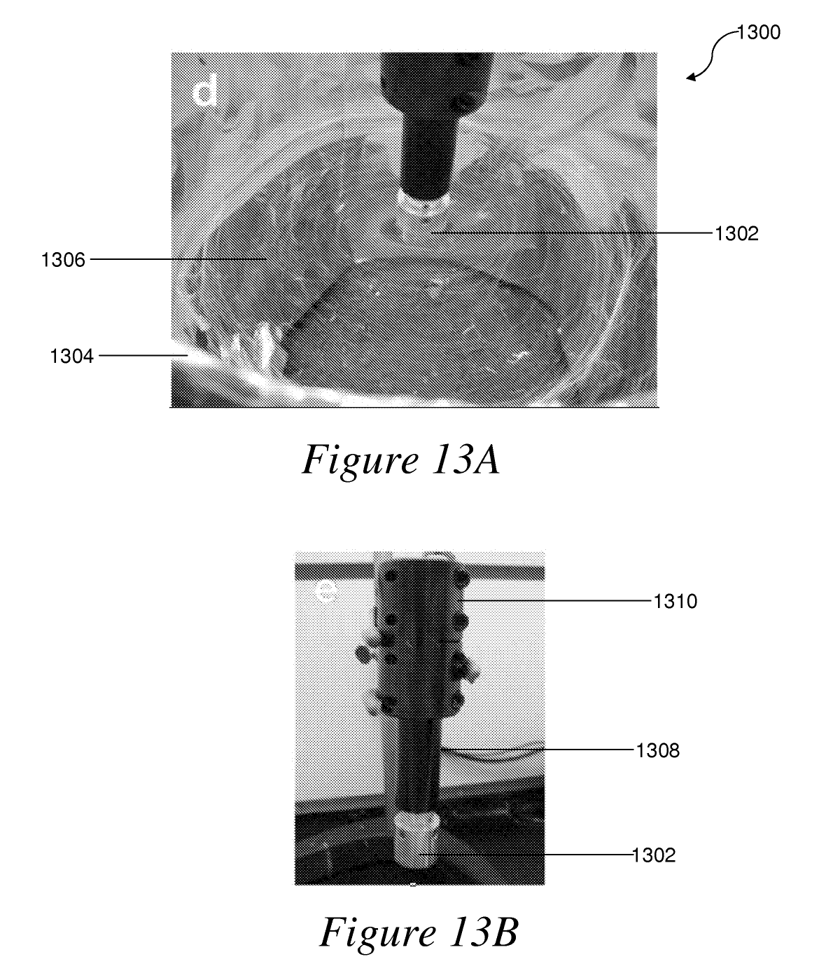

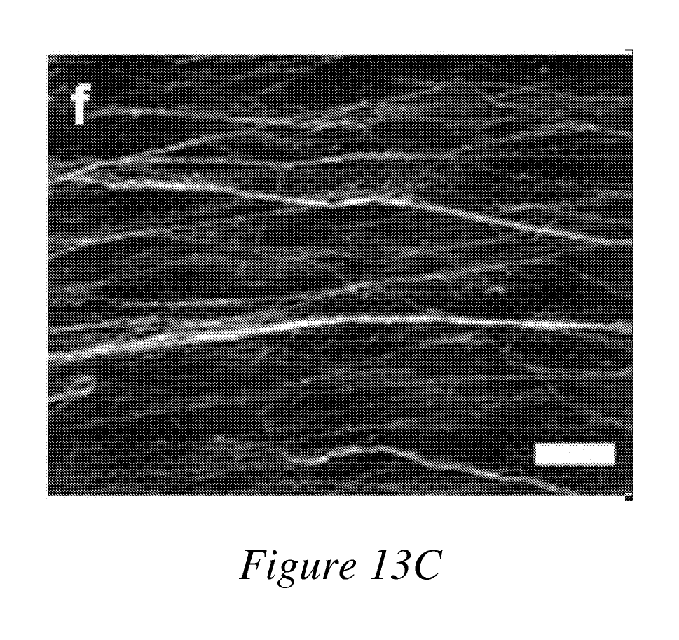

FIG. 13A illustrates a fiber formation device 1300 having one or more reservoirs 1302 containing a material solution for forming fibers, and one or more collection devices 1304 on which fibers are collected. FIG. 13A shows fibers 1306 being formed by the device 1300. FIG. 13B illustrates the reservoir 1302 coupled via one or more mechanical members 1308 to a motion generator 1310 which imparts a rotational motion, a linear motion, or a combination of rotational and linear motions to the reservoir 1302 which causes jets of the material solution to be ejected through one or more orifices of the reservoir 1302. The device 1300 lacks an air foil that could be used to increase the air flow and/or air turbulence experienced by the material solution that exits the reservoir 1302.

The device 1300 includes one or more motion generators 1310. In an exemplary embodiment, the motion generator 1310 imparts a linear motion to the reservoir 1302. In another exemplary embodiment, the motion generator 1310 imparts a rotation motion to the reservoir 1302. An exemplary rotational motion generator is described in International (PCT) Patent Application Serial Number PCT/US10/34662. An exemplary rotational motion generator 1310 may rotate at exemplary speeds that range from about 9 rpm to about 64,000 rpm. In another exemplary embodiment, the motion generator 1310 imparts a combination of linear and rotational motions to the reservoir 1302. In another exemplary embodiment, the motion generator 1310 imparts another type of motion to the reservoir 1302.

FIG. 13C illustrates a microscope view of qualitatively aligned (anisotropic) fibers produced by the fiber formation device 1300 that is not provided with an air foil. The fibers of FIG. 13C are substantially aligned along the left-right axis of the space pictured in the microscope view due to the lower air turbulence experienced by the fibers as they descend through the air.

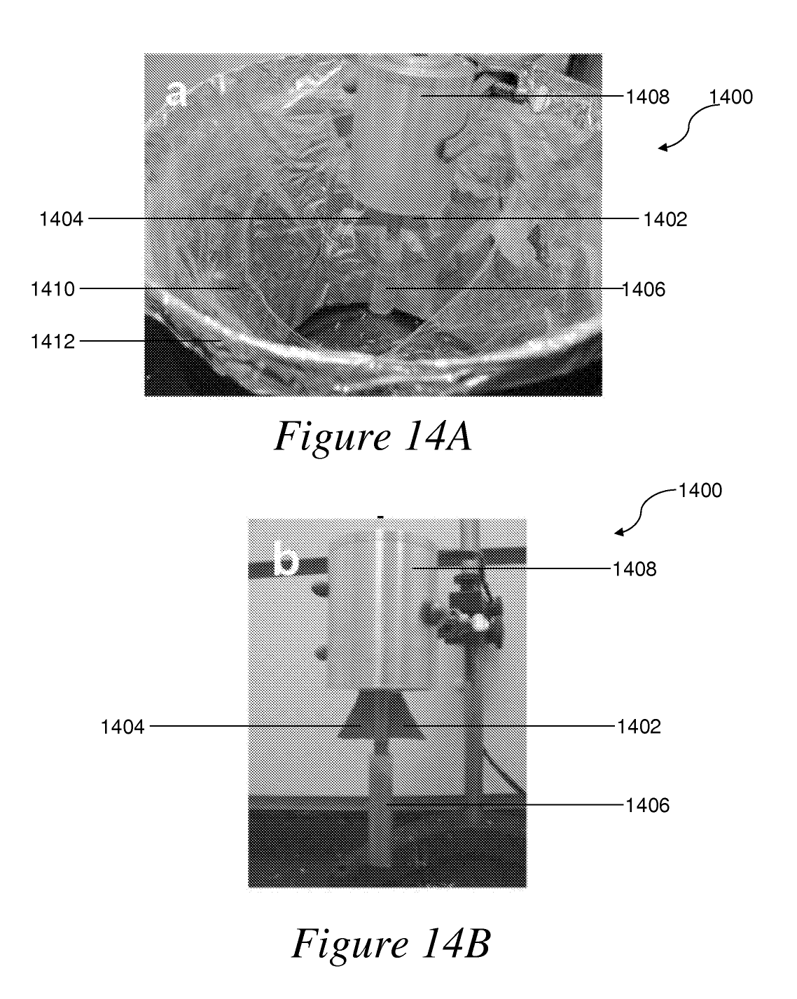

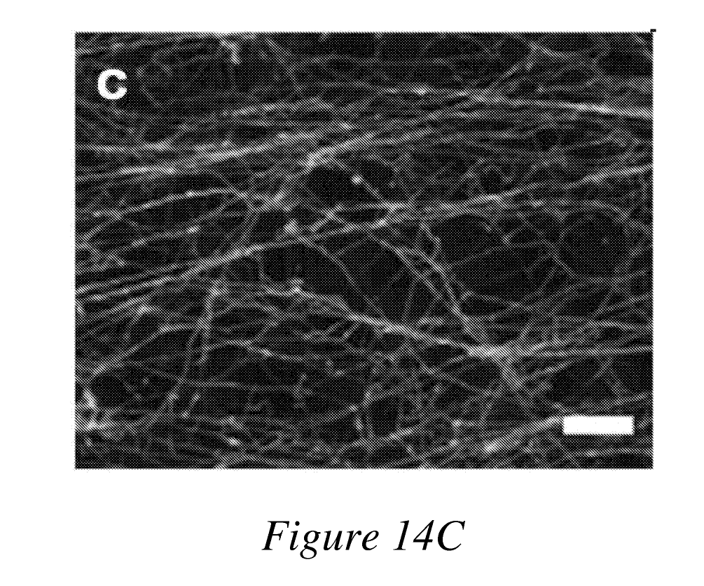

FIGS. 14A and 14B illustrate an exemplary fiber formation device 1400 having exemplary air foils 1402 and 1404 provided adjacent to each other substantially along the same vertical plane, the air foils forming a substantially double-sided triangular shape. The air foils 1402 and 1404 are disposed or formed on or in the vicinity of one or more orifices of a reservoir 1406 that holds a material solution. During fiber formation, the reservoir 1406 is moved linearly in a back and forth manner, rotationally, or in a combination of linear and rotational motions using one or more motion generators 1408, e.g., a motor. The motion of the reservoir 1406 causes one or more jets of the material solution to be ejected from the reservoir. Air drag extends and elongates the jets into fibers 1410 which are deposited on a collection device 1412.

The device 1400 includes one or more motion generators 1408. In an exemplary embodiment, the motion generator 1408 imparts a linear motion to the reservoir 1406. In another exemplary embodiment, the motion generator 1408 imparts a rotation motion to the reservoir 1406. An exemplary rotational motion generator 1408 may rotate at exemplary speeds that range from about 9 rpm to about 64,000 rpm. In another exemplary embodiment, the motion generator 1408 imparts a combination of linear and rotational motions to the reservoir 1406. In another exemplary embodiment, the motion generator 1408 imparts another type of motion to the reservoir 1406.

The air foils 1402 and 1404 are provided on the reservoir 1406 in the exemplary embodiment illustrated in FIGS. 14A and 14B, but may be provided on other components, e.g., on or associated with the motion generator 1408. The air foils 1402 and 1404 are provided vertically above the reservoir 1406 in the exemplary embodiment illustrated in FIGS. 14A and 14B, but may be provided at other locations, e.g., vertically below the reservoir 1406, vertically above the motion generator 1408, vertically below the motion generator 1408, etc.

Without an air foil, there is low air turbulence in the surrounding air as the material jets descend from the reservoir to the collection device. The resulting fibers are collected as a highly aligned scaffold on the collection device. The addition of one or more exemplary air foils increases the air flow and/or air turbulence. This acts in conjunction with or overcomes the rotational speed of the material jets to move and change the alignment of the fibers. Because exemplary reservoirs rotate at high speeds, small disturbances in the air flow pattern caused by exemplary air foils greatly affect air turbulence. The effect of the exemplary air foils on fiber alignment depends on the sizes, shapes and locations of the air foils.

In an exemplary embodiment employing one or more exemplary air foils, the resulting fibers may be unaligned due to the turbulence modification caused by the air foils. FIG. 14C illustrates a microscope view of qualitatively unaligned (isotropic) fibers that may be formed by an exemplary fiber formation device provided with the exemplary air foil of FIGS. 14A and 14B. The fibers of FIG. 14C are not substantially aligned along any axis of the space pictured in the microscope view. Isotropic fibers, formed using exemplary air foils, may be desirable as they may have uniform mechanical properties in all directions.

In another exemplary embodiment employing one or more exemplary air foils, the resulting fibers may be aligned along a particular axis or plane due to the turbulence modification caused by the air foils. FIG. 13C illustrates a microscope view of qualitatively aligned (anisotropic) fibers that may be formed by an exemplary fiber formation device provided with one or more exemplary air foils. The fibers of FIG. 13C are substantially aligned along the left-right axis of the space pictured in the microscope view due to a modified air turbulence experienced by the fibers as they descend through the air. Anisotropic fibers, that formed using exemplary air foils, may be desirable as they may be stronger in a particular direction.

In other exemplary embodiments employing one or more exemplary air foils, the fibers may be aligned in other configurations due to the turbulence modification caused by the air foils, e.g., the fibers may be aligned along a particular axis or plane in space, the fibers may be aligned in complex weave patterns or other patterns, etc.

Exemplary embodiments may configure the sizes, shapes, geometries and/or locations of the exemplary air foils to control the degree of air turbulence and/or air flow created in the system and, thereby, to control the alignment of the resulting fibers.

In exemplary embodiments, the air flow and/or air turbulence in the surroundings of the descending fibers created by the exemplary air foils facilitate in solvent evaporation and therefore fiber formation. The ability of fibers to form in exemplary devices depends on the solvent evaporation rate, the material molecular weight, concentration, viscosity, rotational speed of the reservoir, etc. In the case of slow evaporating solvents, e.g., aqueous solvents, and in the case of reservoirs that spin at low rotational speeds, the air drag experienced by the material jets may not be sufficient to evaporate certain solvents before they reach the collection device. In these cases, in conventional fiber formation devices that do not use exemplary air foils, the solvent would not evaporate and fibers would not form as the air drag experienced by the material jets would not be sufficient to evaporate certain solvents before they reach the collection device.

The addition of exemplary air foils increases air turbulence and/or air drag, which allows the solvent to evaporate. Thus, the use of exemplary air foils allows fiber formation even when the reservoir spins at low rotational speeds and even with slow evaporating solvents. In other cases, the use of exemplary air foils facilitates the formation of fibers.

In an exemplary embodiment, the air flow created in the surroundings of the descending fibers by exemplary air foils facilitates in directing the fibers toward the collection device 1412.

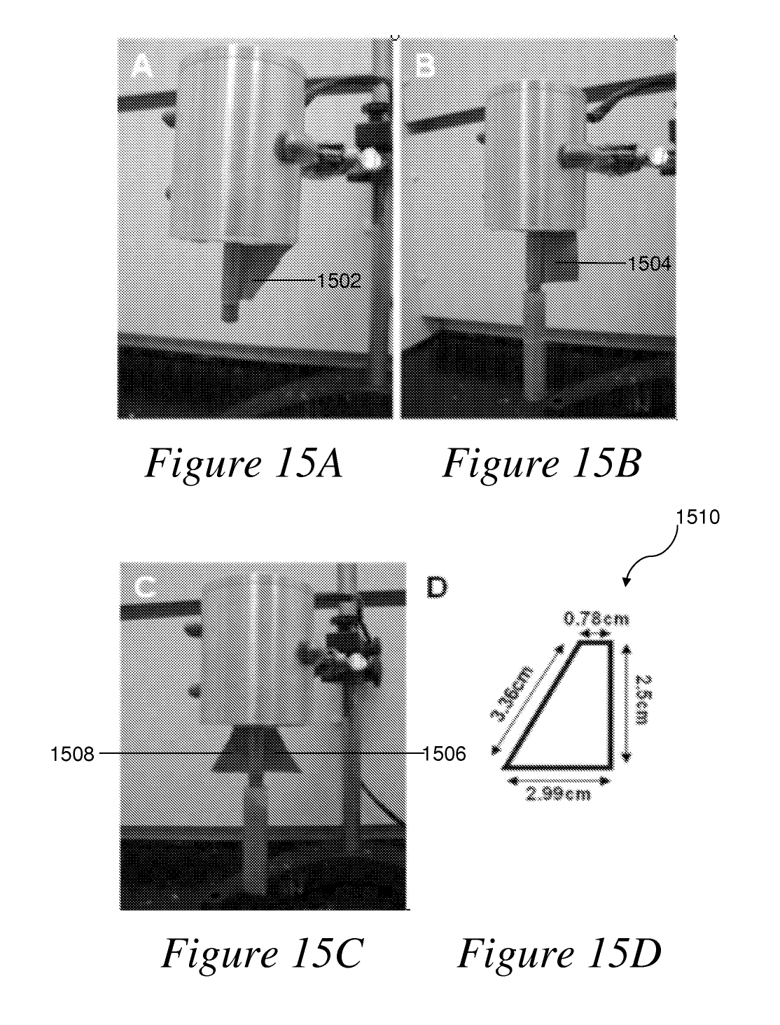

FIGS. 15A-15C illustrate different exemplary configurations of exemplary air foils. FIG. 15A illustrates an exemplary air foil 1502 having a substantially single-sided triangular shape. FIG. 15B illustrates an exemplary air foil 1504 having a substantially single-sided square shape. FIG. 15C illustrates two exemplary air foils 1506 and 1508 provided adjacent to each other substantially along the same vertical plane, the air foils forming a substantially double-sided triangular shape. FIG. 15D illustrates a schematic drawing of an exemplary trapezoid shaped air foil 1510 with first and second parallel sides having exemplary lengths of about 0.78 cm and 2.99 cm, a third side having an exemplary length of about 2.5 cm, and a fourth side having an exemplary length of about 3.36 cm. In exemplary embodiments, the air foils illustrated in FIGS. 15A-15D may be used with a motor that rotates a reservoir at an exemplary speed of about 12,000 rpm, and in an exemplary configuration in which the orifices of the reservoir are separated from the collection device by an exemplary distance of about 10 cm.

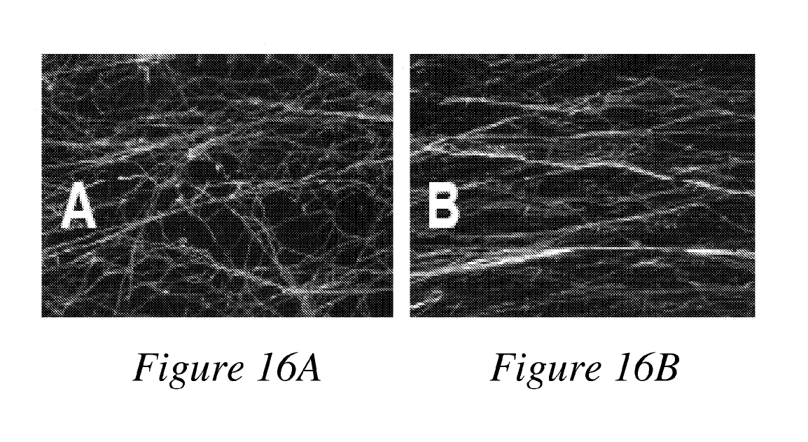

FIGS. 16A and 16B illustrate microscope views of fibers formed by an exemplary fiber formation device with a rotating motor that spins at an exemplary speed of about 12,000 rpm, and in which one or more orifices in the reservoir are separated from the collection device by an exemplary distance of about 10 cm. FIG. 16A illustrates a microscope view of qualitatively unaligned (isotropic) fibers formed by the exemplary fiber formation device provided with the exemplary air foil of FIG. 15D. The fibers of FIG. 16A are not substantially aligned along any axis of the space pictured in the microscope view. FIG. 16B illustrates a microscope view of qualitatively aligned (anisotropic) fibers produced by the exemplary fiber formation device that is not provided with an air foil. The fibers of FIG. 16B are substantially aligned along the left-right axis of the space pictured in the microscope view.

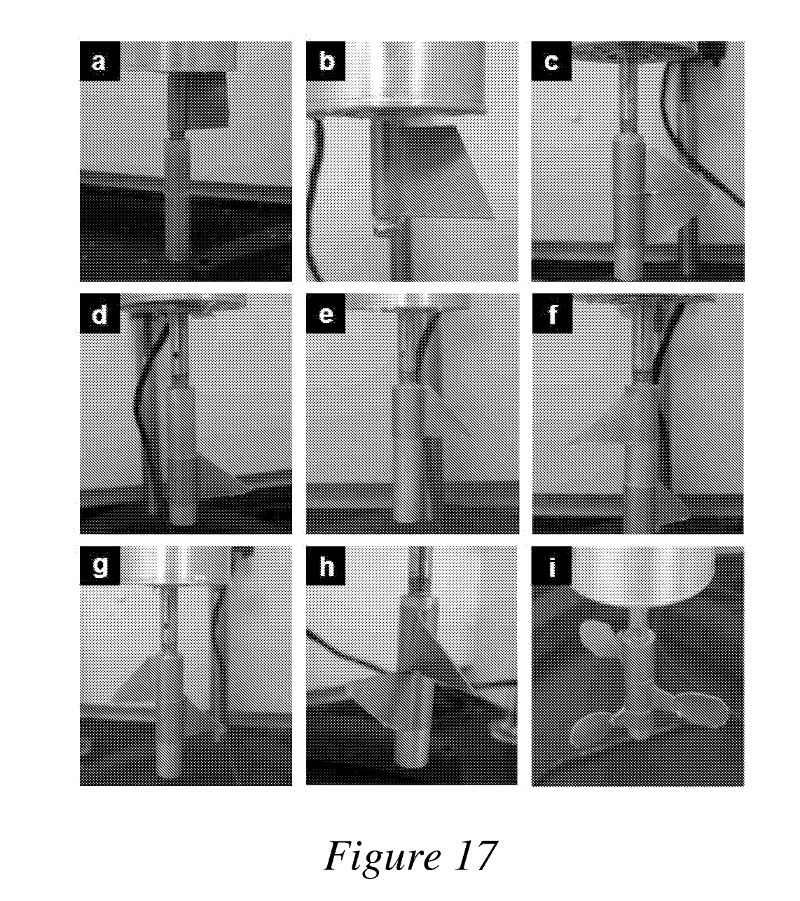

FIGS. 17A-17I illustrate different exemplary configurations of air foils associated with exemplary reservoirs in exemplary fiber formation devices. FIG. 17A illustrates an exemplary air foil having a substantially rectangular shape. FIG. 17B illustrates an exemplary air foil having a substantially trapezoid shape. FIG. 17C illustrates an exemplary air foil having the shape substantially of an isosceles triangle that is placed vertically above the one or more orifices of the reservoir. FIG. 17D illustrates an exemplary air foil having a substantially triangular shape that is placed below the one or more orifices of the reservoir. FIG. 17E illustrates an exemplary air foil having a substantially right triangular shape that is placed above the one or more orifices of the reservoir. FIG. 17F illustrates two exemplary air foils vertically separated from each other, each air foil having a substantially right triangular shape. FIG. 17G illustrates two exemplary air foils disposed adjacent to each other along the same vertical plane, each air foil having a substantially right triangular shape. FIG. 17H illustrates two exemplary air foils disposed adjacent to each other along different vertical planes, each air foil having a substantially right triangular shape. FIG. 17I illustrates three exemplary air foils disposed vertically separated from one another and along different vertical planes, each air foil having a substantially oval shape. Other exemplary air foils may have different shapes and different dimensions than those illustrated in FIGS. 17A-17I.

Exemplary fiber formation devices with one or more air foils may have different applications including, but not limited to, polymeric fibers of custom designed orientation and organization, controllable material properties with varying organization, increased extensibility of polymeric fibers, etc.

In some exemplary embodiments, the systems devices, and methods of the invention do not employ an air foil or blade. In certain embodiments, the systems, devices and methods of the invention employing rotational motion at speeds greater than about 25,000 rpm do not employ an air foil or blade. In other embodiments, the systems, devices and methods of the invention employing rotational motion at speeds greater than about 25,000 rpm employ an air foil or blade.

D. Combination of Exemplary Embodiments Employing Rotational and/or Linear Motion and Exemplary Embodiments for Forming Threaded Polymeric Fibers

The exemplary fiber formation devices, systems and methods employing linear motion, described in connection with FIGS. 1-7 and in PCT/US10/34662 filed May 13, 2010, entitled “Methods And Devices For The Fabrication of 3D Polymeric Fibers, may be used in combination with the exemplary fiber formation devices, systems and methods employing exemplary air jet-spinning vessels, described in connection with FIGS. 8-12.

### E. Combination of Exemplary Embodiments Employing Air Foils and Exemplary Embodiments for Forming Threaded Polymeric Fibers

The exemplary fiber formation devices, systems and methods employing exemplary air foils, described in connection with FIGS. 13-17 and in PCT/US10/34662 filed May 13, 2010, entitled “Methods And Devices For The Fabrication of 3D Polymeric Fibers, may be used in combination with the exemplary fiber formation devices, systems and methods employing exemplary air jet-spinning vessels, described in connection with FIGS. 8-12.

F. Combination of Exemplary Embodiments Employing Rotational and/or Linear Motion and Exemplary Embodiments Employing Air Foils

The exemplary fiber formation devices, systems and methods employing linear motion, described in connection with FIGS. 1-7 and in PCT/US10/34662 filed May 13, 2010, entitled “Methods And Devices For The Fabrication of 3D Polymeric Fibers, may be used in combination with the exemplary fiber formation devices, systems and methods employing exemplary air foils, described in connection with FIGS. 13-17.

G. Combination of Exemplary Embodiments Employing Linear and/or Rotational Motion, Exemplary Embodiments for Forming Threaded Polymeric Fibers, and Exemplary Embodiments Employing Air Foils

The exemplary fiber formation devices, systems and methods employing linear motion, described in connection with FIGS. 1-7 and in PCT/US10/34662 filed May 13, 2010, entitled “Methods And Devices For The Fabrication of 3D Polymeric Fibers, the exemplary fiber formation devices, systems and methods employing exemplary air jet-spinning vessels, described in connection with FIGS. 8-12, and the exemplary fiber formation devices, systems and methods employing exemplary air foils, described in connection with FIGS. 13-17, may be used together in combination.

### H. Exemplary Miniaturized Fiber Formation Devices

Exemplary embodiments provide miniaturized systems, miniaturized devices and methods for forming fibers. Exemplary embodiments may be used to form fibers directly within an animal's body. Exemplary devices may have a range of sizes but are generally sufficiently small to be inserted, wholly or in part, inside a cavity formed inside the body. Some exemplary devices may be as small as a few cubic millimeters. Some exemplary devices may be sufficiently small to fit within the palm of a human hand. Any of the exemplary fiber formation devices discussed elsewhere in this application and in International (PCT) Patent Application Serial Number PCT/US10/34662 may be miniaturized as well.

An exemplary miniaturized fiber formation device includes one or more miniaturized reservoirs for holding a material solution. The reservoir may be formed of a suitable material including, but not limited to, ceramic, metal, polymer, etc., depending on the specific applications of the device. An exemplary reservoir may have a volume ranging from about one microliter to about 100 milliliters for holding the material solution. The reservoir may include one or orifices through which one or more jets of the material solution may exit the reservoir. The orifices may be located at different locations, e.g., the side walls of the reservoir, the bottom walls, the top walls, etc. The orifices may have different cross-sectional shapes and may be provided in different numbers, locations and configurations to control the shape and properties of the resulting fibers.

The reservoir may be coupled to one or more motion generators, e.g., a motor, which imparts a rotational motion, a linear motion, or a combination of rotational and linear motions to the reservoir. In an exemplary embodiment, the motion generator may be directly coupled to the reservoir, e.g., by being placed integrally on the reservoir. In another exemplary embodiment, the motion generator is provided separately from the reservoir and is indirectly coupled to the reservoir, e.g., via one or more mechanical members like rotating rods.

In an exemplary embodiment, the motion generator imparts a linear motion to the reservoir. In another exemplary embodiment, the motion generator imparts a rotation motion to the reservoir. In another exemplary embodiment, the motion generator imparts a combination of linear and rotational motions to the reservoir. In another exemplary embodiment, the motion generator imparts another type of motion to the reservoir.

The motion generator may be non-miniaturized or miniaturized, e.g., may be small enough to fit within the palm of a human hand, so that it may be inserted into a body cavity. A larger motion generator may be provided outside a body cavity to remotely control a miniaturized reservoir, e.g., through cables or a rotating rod. An exemplary rod extending between an external motion generator and a reservoir to be inserted into a body cavity may be formed of a medical grade stainless steel (e.g., 316 alloy). Thus, a larger, more power motion generator may still be used to spin fibers inside a small body cavity using a miniaturized reservoir. Exemplary motion generators, e.g., motors, may spin at exemplary speeds of 100 rpm or higher. An exemplary motor may be, but is not limited to, a dental drill.

An exemplary miniaturized fiber formation device includes one or more collection devices that may be miniaturized or non-miniaturized. The collection device may be stationary or may move in a rotational manner, a linear manner, or a combination of rotational and linear motions. The collection device may be an inert object or a living organism. In an exemplary miniaturized device used for laparoscopic surgeries, an exemplary collection device may be a stomach or other body cavity or organ. In this embodiment, the fibers produced by the exemplary device may be used as a scaffold for tissue regeneration or replacement. In an exemplary embodiment in which the collection device is a cavity in an animal body, the cavity may be expanded to create space for surgical work and to create desirable environmental conditions for the surgery. In exemplary embodiments, the cavity may be expanded using one or more gases, e.g., carbon dioxide, and/or using one or more mechanical components, e.g., expandable spheres, expandable rods.

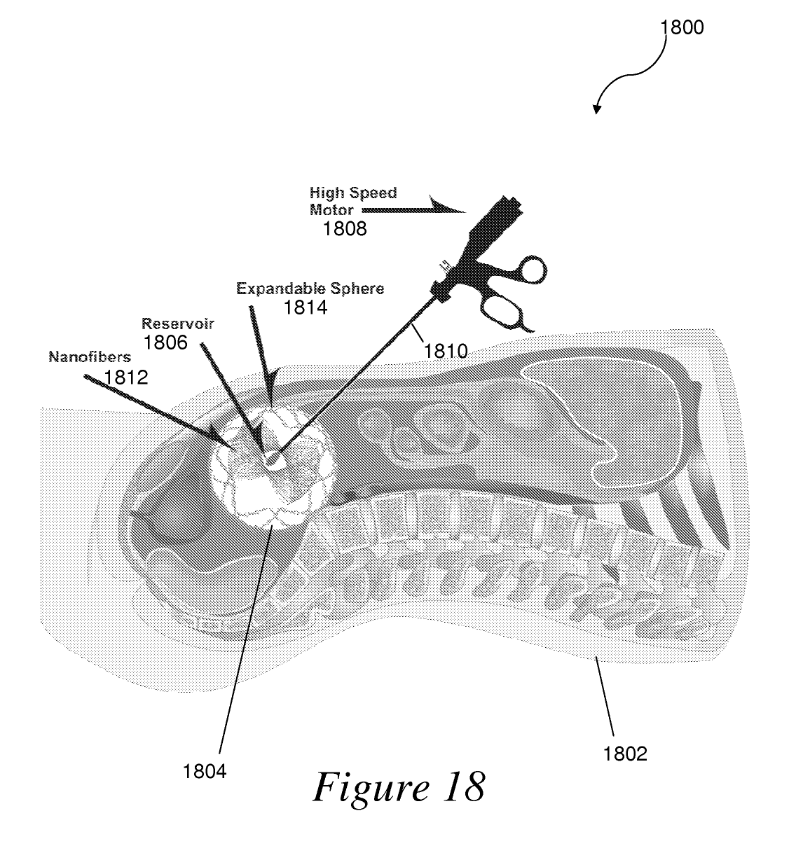

FIG. 18 illustrates an exemplary miniaturized fiber formation device 1800 used as part of a laparoscopic tool for laparoscopic surgeries in a cavity 1804 of an animal body 1802. The cavity 1804 may be expanded using one or more mechanical expansion members, e.g., sphere 1814, to facilitate the formation of fibers in the cavity 1804. The device 1800 includes a miniaturized reservoir 1806 containing a material solution that may be inserted laparoscopically into the cavity 1804. The reservoir 1806 is coupled to a motion generator 1808 via one or more mechanical members, e.g., rod 1810. The motion generator 1808 imparts a motion to the reservoir 1806.

In an exemplary embodiment, the motion generator may be non-miniaturized and may remain outside the body 1802 during surgery. The exemplary non-miniaturized motion generator may be used to remotely move the reservoir 1806, as illustrated in the exemplary embodiment of FIG. 18. In another exemplary embodiment, the motion generator may be miniaturized and may be provided on or adjacent to the reservoir 1806 for insertion into the body 1802 during surgery.

The material solution being ejected out of the miniaturized reservoir 1806 may result in the formation of polymeric fibers 1812 inside the cavity 1804. The exemplary device 1800 may be used to produce biodegradable, biocompatible scaffolds in vivo.

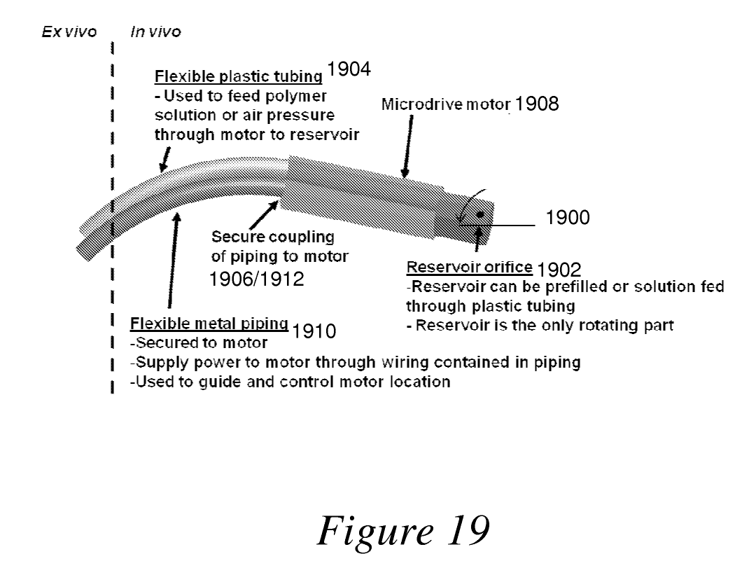

FIG. 19 illustrates an exemplary miniaturized reservoir 1900 containing a material solution that may be inserted through a catheter into a body cavity in order to form polymeric fibers. The reservoir 1900 includes one or more orifices 1902 through which jets of the material solution may exit the reservoir 1900. In an exemplary embodiment, the reservoir 1900 may be the only moving component of the device. The reservoir 1900 may move in a rotational motion, a linear motion, or a combination of rotational and linear motions.

In an exemplary embodiment, the reservoir 1900 may be pre-filled with the material solution and may not be coupled to external tubings. In another exemplary embodiment, the material solution may be fed into the reservoir 1900 through a tubing 1904 from outside the cavity. The material solution may be fed into the reservoir 1900 continuously or discontinuously one or more times during fiber formation. The rate at which the material solution is fed into the reservoir 1900 may be constant or may be varied. In an exemplary embodiment, the tubing 1904 may be used to introduce air pressure into the reservoir 1900. An exemplary tubing 1904 may be a flexible plastic tubing. The tubing 1904 may be securely coupled to the reservoir 1900 using one or more coupling mechanisms 1906.

In an exemplary embodiment, a miniaturized motion generator 1908, e.g., a microdrive motor, is provided integrally with the reservoir 1900. In other exemplary embodiments, a larger motion generator may be provided separately from the reservoir outside the body cavity. A flexible metal piping 1910 may be provided to supply electrical power to the motion generator 1908 through electrically conductive wiring contained in the piping 1910. In an exemplary embodiment, the piping 1910 may be used to guide and control the location of the motion generator as it is introduced into the body cavity. In an exemplary embodiment, the piping 1910 may be used to conduct control instructions encoded, for example, in power signals, optical signals or in other signals, to control the speed and activation of the motion generator 1908. The piping 1910 may be covered with an electrical insulator to protect the wiring. The piping 1910 may be securely coupled to the reservoir 1908 using one or more coupling mechanisms 1912.

FIGS. 56A, 56B and 56C illustrate an exemplary miniaturized fiber formation device 5600 that employs high speed rotational motion. FIG. 56A illustrates the device 5600 as held by a hand 5608. FIG. 56B illustrates a close-up view of the device 5600. FIG. 56C illustrates a snapshot in time of a high speed video of the device 5600 in operation. The device 5600 may include a custom miniature reservoir 5602 that may, in an exemplary embodiment, be formed using a laser micro-welder. The reservoir 5602 may be provided with one or more orifices through which the polymer material may be ejected. In an exemplary embodiment, the reservoir 5602 may be periodically or continually be supplied with a polymer material through, for example, a supply channel provided in a body portion 5604 of the device 5600. The body portion 5604 may be configured to be held by a hand 5608 and used to change the orientation of the reservoir 5602.

The reservoir 5602 may be coupled to a motion generator 5606, for example, a motor that is driven by an air-turbine. In exemplary embodiments, the motion generator 5606 may rotate the reservoir 5602 at rotational speeds of about 50,000 to about 110,000 rpm, although exemplary rotational speeds are not limited to this exemplary range. In an exemplary embodiment, the rotational speed may be about 108,000 rpm.

In an alternative embodiment, the reservoir may not be rotated, but may be pressurized to eject the polymer material from the reservoir through one or more orifices. For example, a mechanical pressurizer may be applied to one or more surfaces of the reservoir to decrease the volume of the reservoir, and thereby eject the material from the reservoir. In another exemplary embodiment, a fluid pressure may be introduced into the reservoir to pressurize the internal volume of the reservoir, and thereby eject the material from the reservoir.

The components of exemplary miniaturized fiber formation devices that are inserted into a body cavity, such as a mouth or abdomen, are typically sterilized before insertion into the body cavity. In exemplary embodiments, the insertable components of an exemplary miniaturized fiber formation device or the entirety of an exemplary miniaturized fiber formation device may be formed of materials that may be sterilized without degradation, e.g., by autoclaving, using UV light, using ethylene oxide sterilization, etc.

Exemplary miniaturized fiber formation devices may be used to form fibers from a range of materials described in more detail below.

Exemplary miniaturized fiber formation devices may have many applications including, but not limited to, use in laparoscopic surgeries, in vivo manufacturing of organs or tissues, miniaturization for surgical applications, mass production of biogenic polymer, e.g., protein, fibers, mass production of ultra strong biogenic polymer, e.g., protein, fibers, bio-functional fibrous scaffolds for in vitro tissue engineering applications, bio-functional fibrous scaffolds for in vivo tissue engineering applications, bio-functional suture threads, ultra-strong fiber and fabric production, bio-functional protein or polymer filters, protective clothing or coverings, etc.

The small sizes of exemplary miniaturized fiber formation devices allow insertion into a body cavity, for example, through a catheter, a port, or a main artery. Exemplary devices may be used for in vivo manufacturing of organs or tissues. Exemplary devices may be used to build a cylindrical organ, cavity filling tissue, organ banding, etc. Exemplary devices may be used for modular assembly of a tissue construct. Tissue or organ sections may be assembled from varying positions or at varying times using exemplary devices.

Exemplary miniaturized fiber formation devices may be used for non-medical or biologic applications such as fiber reinforcing small cavities on high performance sporting, or military equipment, ultra-small fibrous constructs, or large delicate constructs where very small disruptions to the structure are necessary to deliver fibrous coatings. Exemplary devices may be adapted into handheld devices for at home or forward deployable fiber fabrication for customizable wound dressings or fabrics.

### I. Exemplary Orifices and Nozzles

In exemplary fiber formation devices, an exemplary reservoir includes one or more orifices through which a material solution may be ejected from the reservoir during fiber formation. The devices include sufficient orifices for ejecting the polymer during operation, such as 1, 2, 3, 4, 5, 6, 7, 8, 9, 10, 11, 12, 13, 14, 15, or more orifices. The orifices may be provided on any surface or wall of the reservoir, e.g., side walls, top walls, bottom walls, etc. In exemplary embodiments in which multiple orifices are provided, the orifices may be grouped together in close proximity to one another, e.g., on the same surface of the reservoir, or may be spaced apart from one another, e.g., on different surfaces of the reservoir.

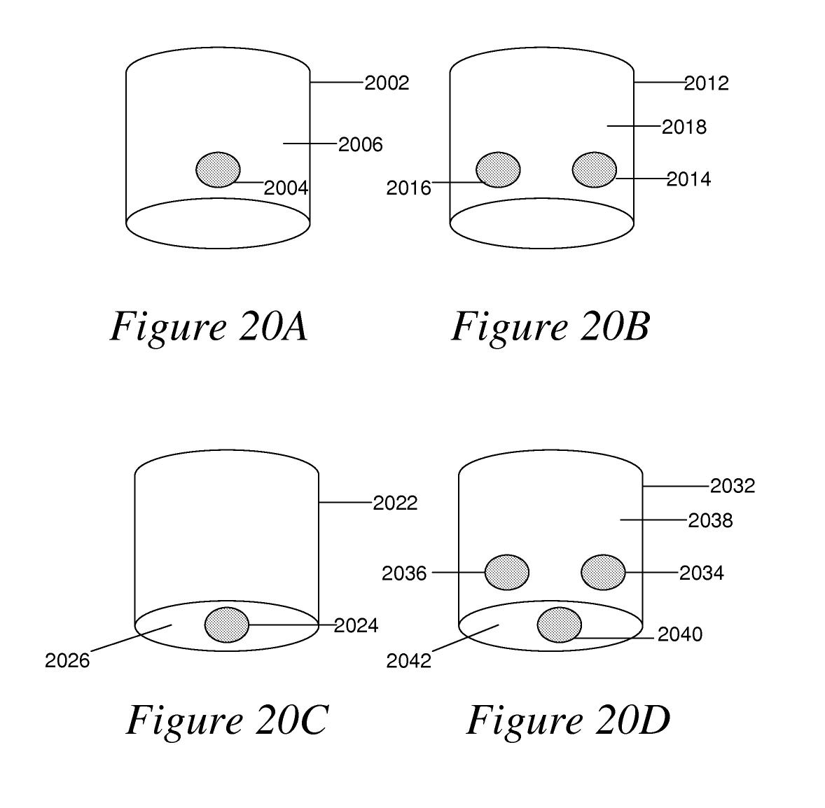

FIG. 20A illustrates an exemplary reservoir 2002 including an orifice 2004 provided on a side surface or side wall 2006. FIG. 20B illustrates an exemplary reservoir 2012 including orifices 2014 and 2016 provided on a side surface or side wall 2018. FIG. 20C illustrates an exemplary reservoir 2022 including an orifice 2024 provided on a bottom surface or bottom wall 2026. FIG. 20D illustrates an exemplary reservoir 2032 including orifices 2034 and 2036 provided on a side surface or side wall 2038 and an orifice 2040 provided on a bottom surface or bottom wall 2042. One of ordinary skill in the art will appreciate that the exemplary number, placement and configuration of the orifices of FIGS. 20A-20D are illustrative, and that other exemplary reservoirs may have different number, placement and configuration of orifices than those illustrated.

The orifices may be of the same diameter or of different diameters, e.g., diameters of about 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1.0, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or about 1000 micrometers.

Diameters intermediate to the above-recited values are also intended to be part of this invention.

The length of the one or more orifices may be the same or different, e.g., diameters of about 0.0015, 0.002, 0.0025, 0.003, 0.0035, 0.004, 0.0045, 0.005, 0.0055, 0.006, 0.0065, 0.007, 0.0075, 0.008, 0.0085, 0.009, 0.0095, 0.01, 0.015, 0.02, 0.025, 0.03, 0.035, 0.04, 0.045, 0.05, 0.055, 0.06, 0.065, 0.07, 0.075, 0.08, 0.085, 0.09, 0.095, or 0.1 m. Lengths intermediate to the above recited lengths are also contemplated to be part of the invention.

In exemplary fiber formation devices, one or more nozzles may be provided associated with one or more orifices of a reservoir through which a material solution is ejected from the reservoir. An exemplary nozzle may include a body portion that projects from a side-wall of a reservoir substantially orthogonally to the side-wall, and an orifice at a terminal end of the body portion that is exposed to the external environment. A polymer material provided in the reservoir may flow out of the reservoir, through the body portion of the nozzle and out of the nozzle through the orifice of the nozzle in order to form a fiber.

In some exemplary embodiments, exemplary nozzles may be fabricated separately from a reservoir and may be patched onto the reservoir. In other exemplary embodiments, exemplary nozzles may be formed integrally with a reservoir. In some exemplary embodiments, exemplary nozzles may be formed of silicon and aluminum using photolithography and Deep Reactive Ion Etching (DRIE). In some exemplary embodiments, exemplary nozzles may be formed using Focused Ion Beam (FIB) or E-Beam lithography techniques. In another exemplary embodiment, exemplary nozzles are provided replaceably on orifices so that one nozzle provided on an orifice may be replaced by another nozzle. In these exemplary embodiments, the same orifice and the same reservoir may be used to form polymeric fibers with different surface topographies.

Exemplary nozzles may have cross-sectional configurations and shapes that impart the configurations to the outer surface of polymeric fibers formed by exemplary fiber formation devices, which increases the surface area of the polymeric fibers and the complexity of the surface topographies of the polymeric fibers. Exemplary nozzles convolute the surface of the polymeric fibers and create small structures on the surface including, but not limited to, projections, ridges, craters, spirals, etc. The fibers formed by exemplary nozzles retain the surface topographies and convolutions imparted by the nozzles. Exemplary polymeric fibers may range in diameter from about 1 nanometer to about 100 microns, and exemplary structures may range in size from about 1 nanometer to about 500 nanometers. Exemplary polymeric fibers may have any number of such structures on the outer surface including, but not limited to, from one to hundreds or thousands.

An exemplary nozzle is provided integrally or removably on a reservoir so that the nozzle is associated with a single orifice. In another exemplary embodiment, exemplary nozzles are provided replaceably on orifices so that one nozzle provided on an orifice may be replaced by another nozzle. In these exemplary embodiments, the same orifice and the same reservoir may be used to form polymeric fibers with different surface topographies.

The convolution of the surface and the structures on the surface of the polymeric fibers impart unique properties to the fibers. In an exemplary embodiment, a polymeric fiber with hundreds or thousands of structural projections on its surface formed using exemplary nozzles has a hydrophobic property, i.e., the polymeric fibers act similar to a lotus leaf in nature to repel water. In an exemplary embodiment, polymeric fibers with high surface areas formed using exemplary nozzles may be used for different applications including, but not limited to, photovoltaic cells, controlled drug delivery, etc. Exemplary polymeric fibers with high surface areas formed using exemplary nozzles may be used to increase the tensile strength of already strong fibers, e.g., Kevlar, carbon fiber, etc.

Some conventional technologies, e.g., pasta makers, millimeter-sized orifice extruders, use orifice configurations to configure the cross-sectional areas of macro-scale materials and fibers. However, conventional technologies cannot be used to configure the cross-sectional areas or surface topographies of fibers in the micron and nanometer ranges. This is because, surface tension plays a larger role with decreasing fiber diameters, which tends to return the fibers to a cylindrical shape unless the fibers are dried rapidly.

Exemplary embodiments overcome the above-described deficiency in conventional technologies by rapidly drying fibers formed using exemplary nozzles by rapidly removing the solvent in the material solution. The drying action of the fibers may be controlled by controlling one or more factors including, but not limited to, viscosity of the material solution, surface tension of the material solution, diffusion, etc. For example, in exemplary embodiments, the viscosity and/or material type of the material solution may be varied, the surrounding environment may be heated and/or dehydrated, and/or the centrifugal forces on the reservoir may be varied, etc., in order to produce unique polymeric fiber surface topographies that would otherwise return to a cylindrical shape.

Some exemplary (e.g., a star shape) may expose the polymer material to contact or be in proximity to the outer edges inside the nozzle over a larger surface area than in other nozzle shapes (e.g., a circular shape). That is, in certain nozzle shapes, the polymer material contacts or is in proximity to the outer edge inside the nozzle over a larger surface area. As such, the polymer material experiences higher shear forces due to the larger contact surface area with the inside of the nozzle. The higher shear forces facilitate protein unfolding as the polymer material is ejected from the nozzle and improve and facilitate fiber formation.

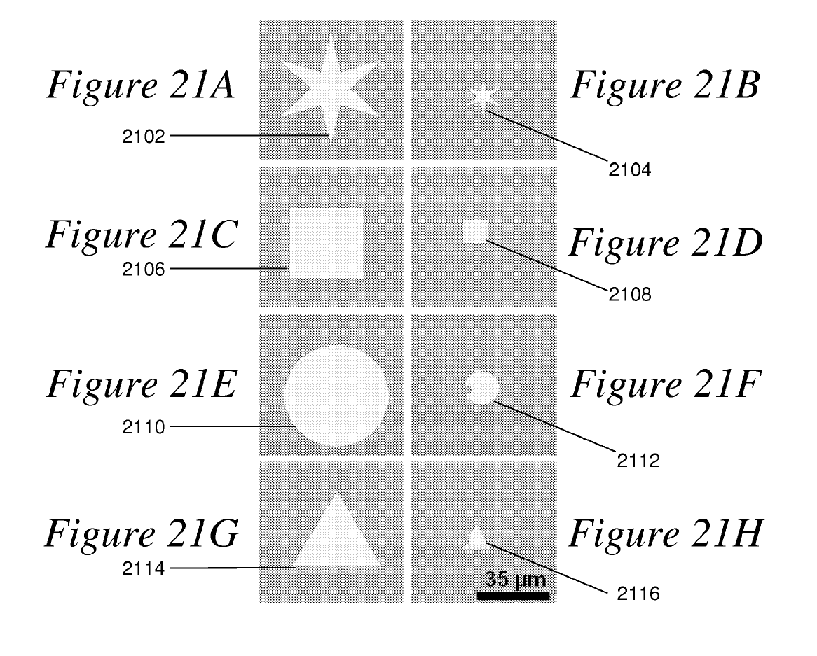

FIGS. 21A-21H illustrate exemplary cross-sectional configurations or shapes of nozzles that may be used to increase the surface area and/or topographical complexities of polymeric fibers. FIG. 21A illustrates an exemplary star-shaped cross-section of an exemplary nozzle 2102, and FIG. 21B illustrates an exemplary smaller star-shaped cross-section of an exemplary nozzle 2104. An exemplary star shape may have any desired number of points including, but not limited to, three to about a thousand points. Exemplary star point lengths (i.e., the length from the center of a star-shaped nozzle to a point of the start shape) may range from about 0.5 microns to about 1 mm (e.g., about 1, 2, 3, 4, 5, 6, 7, 8, 9, 10, 50, 100, 150, 200, 250, 300, 350, 400, 450, 500, 600, 650, 700, 750, 800, 850, 900, 950, or 1000 microns) in some exemplary embodiments. Lengths intermediate to the above recited lengths are also contemplated to be part of the invention. FIG. 21C illustrates an exemplary rectangular cross-section of an exemplary nozzle 2106, and FIG. 21D illustrates an exemplary smaller rectangular cross-section of an exemplary nozzle 2108. FIG. 21E illustrates an exemplary circular cross-section of an exemplary nozzle 2110, and FIG. 21F illustrates an exemplary smaller circular cross-section of an exemplary nozzle 2112. FIG. 21G illustrates an exemplary triangular cross-section of an exemplary nozzle 2114, and FIG. 21H illustrates an exemplary smaller triangular cross-section of an exemplary nozzle 2116.

In other exemplary embodiments, the cross-sectional shapes of exemplary nozzles may include asymmetric features to encourage polymeric fibers spiraling as the material solution exits through the nozzles. The spiraling may be used to form complex polymeric fiber surface textures. In some exemplary embodiments, the cross-sectional shapes of exemplary nozzles may have more complex features than those illustrated including, but not limited to, one or more circular ribbons, one or more circular wavy ribbons, one or more oval ribbons, one or more oval way ribbons, one or more rectangular ribbons, one or more rectangular way ribbons, one or more polygonal ribbons, one or more polygonal wavy ribbons, one or more multi-point stars (e.g., one or more stars, each having a number of points that ranges from four to hundreds), one or more slits, one or more crosses, etc.

In some exemplary embodiments, an exemplary nozzle may have one or more discrete openings having the same configuration or different configurations. In some exemplary embodiments, the cross-sectional shapes of exemplary nozzles may include asymmetric features to encourage polymeric fibers spiraling as the material solution exits through the nozzles. The spiraling may be used to form complex polymeric fiber surface textures. In some exemplary embodiments, the cross-sectional shapes of exemplary nozzles may have more complex features than those illustrated including, but not limited to, one or more circular ribbons, one or more circular wavy ribbons, one or more oval ribbons, one or more oval way ribbons, one or more rectangular ribbons, one or more rectangular way ribbons, one or more polygonal ribbons, one or more polygonal wavy ribbons, one or more multi-point stars (e.g., one or more stars, each having a number of points that ranges from four to hundreds), one or more slits, one or more crosses, etc.

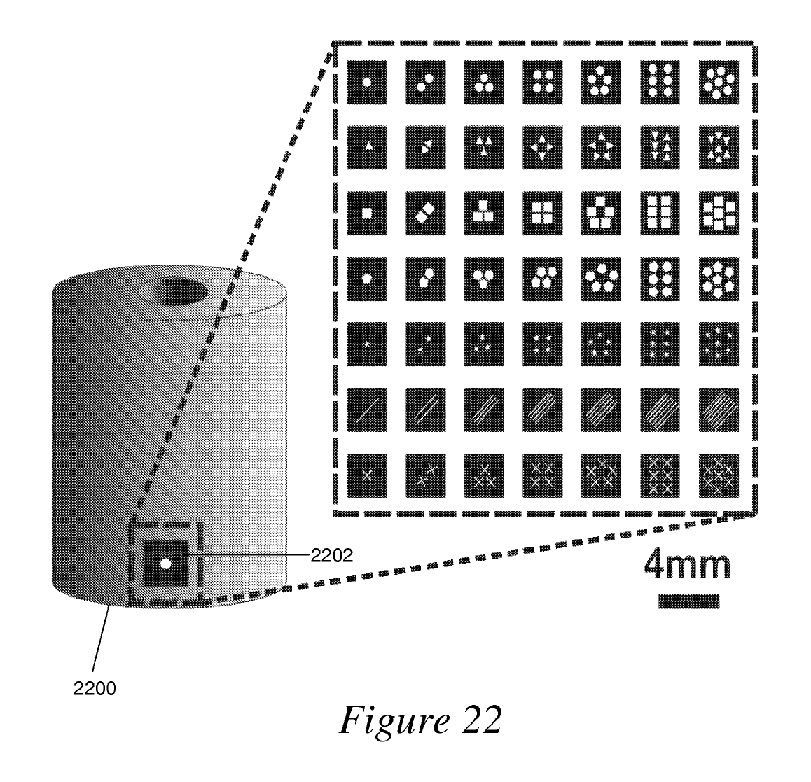

FIG. 22 illustrates additional exemplary cross-sectional configurations or shapes of exemplary nozzles 2202 associated with orifices of an exemplary reservoir 2200. The exemplary nozzles illustrated in FIG. 22 have exemplary dimensions ranging from about one micron to about five mm (e.g., about 1, 2, 3, 4, 5, 6, 7, 8, 9, 10, 50, 100, 150, 200, 250, 300, 350, 400, 450, 500, 600, 650, 700, 750, 800, 850, 900, 950, 1000, 1500, 2000, 2500, 3000, 3500, 4000, 4500, or 5000 microns). Dimensions intermediate to the above recited dimensions are also contemplated to be part of the invention. Other exemplary nozzles may have sizes different from those illustrated in FIG. 22. The exemplary nozzles illustrated in FIG. 22 include one to seven discrete orifices and cross-sectional shapes. Other exemplary nozzles may have a number of discrete orifices different from those illustrated in FIG. 22, e.g., 1-1000 orifices or more.

In exemplary fiber formation devices using exemplary nozzles illustrated in FIGS. 21A-21H and FIG. 22, the material solution is ejected from a reservoir through orifices that are particularly configured in cross-section as illustrated, which results in the formation of structural features on the surface of the resulting polymeric fibers and/or which increases the surface area of the resulting polymeric fibers compared with polymeric fibers formed with conventional nozzles.

One of ordinary skill in the art will appreciate that the exemplary cross-sectional configurations of the nozzles of FIGS. 21A-21H and 22 are illustrative, and that other exemplary nozzles may have different configurations than those illustrated.

In exemplary embodiments, one or more factors associated with the orifices including, but not limited to, orifice diameter, orifice length, rotation speed of the orifices, etc., may be controlled to control the folded/unfolded state of the fibers. The unfolding strength of biogenic polymers, e.g., proteins, typically depends on the pulling rate or shear velocity. The force required to unfold a protein is on the order of 1 pN and varies for different protein domains. For example, fibronection (FN) is a multimodular 450 kDa protein that is roughly 120 nm in length. It is also known that FN exists in two distinct conformations: compact and extended. Globular FN in solution is in the compact conformation (diameter is 2 nm; length is 130 nm long; 2 strands folded over each other are 65 nm each). As such, one of ordinary skill in the art can assume that the molecule adapts a spherical morphology in the compact conformation. In this morphology, one of ordinary skill in the art can assume the volume of one molecule is:

Volume of FN=4.18 nm³=4.18×10⁻²¹ mL=4.18×10⁻⁹ pL

Volume of an exemplary orifice=4.43×10⁻¹² mL(assuming an exemplary orifice is 500 μm; other exemplary orifices may be 600 μm down to 300 μm or 5 μm)

If the starting concentration of FN is 1 mg/mL, this means that the number of FN molecules exiting the orifice=1.05×10⁹.

Because biogenic polymer, e.g., proteins, are expensive, exemplary embodiments provide a solution (i.e., make orifice size smaller) to increase packing of a biogenic polymer, such as a protein, e.g., fibronectin, to increase onset of tension, which leads to protein “unfolding”/extension during fiber formation. Therefore, in exemplary embodiments smaller orifices are employed to yield greater protein packing, higher shear forces, and to induce biogenic polymer, e.g., protein, unfolding as the biogenic polymer travels through the reservoir.

### J. Use of Exemplary Embodiments in Configuring Fiber Surface Texture and Porosity

Exemplary embodiments may be used to create fibers which have a desired surface texture, e.g., rough, smooth, etc. Exemplary embodiments may also be used to create fibers and/or multi-fiber structures (e.g., meshes, mats, etc.) having a desired porosity, i.e., having a desired pore size.

Fiber surface texture and porosity is a function of different factors including, but not limited to, the rotational and/or linear speed of the reservoir, the volatility of the solvent in the material solution which affects the solvent evaporation rate, the mechanical characteristics of the material solution, and the temperature and the humidity of the atmosphere surrounding the fibers as they are formed.

In an exemplary embodiment, exemplary fiber formation devices configure the rotational and/or linear speed of the reservoir to configure the porosity of the fibers. For example, the speed of the reservoir may be increased to increase the porosity, and vice versa.

In an exemplary embodiment, exemplary fiber formation devices configure the rotational and/or linear speed of the reservoir to configure the surface texture of the fibers.

In an exemplary embodiment, the type of material in the material solution may be altered to configure the surface texture and porosity of the fibers.

The evaporation rate of the solvent in the material solution affects the surface texture and porosity of the fibers. Increasing solvent evaporation rates typically result in smoother fibers having lower porosity. In an exemplary embodiment, the type of solvent may be altered to alter solvent volatility, and therefore the solvent evaporation rate. A solvent with a higher volatility may be used to form smoother fibers having lower porosity, and vice versa.

In an exemplary embodiment, the temperature may be increased to increase the solvent evaporation rate, and vice versa. Higher temperatures may be used to form smoother fibers having lower porosity, and vice versa. In certain embodiments, the fibers may be formed in an environment at exemplary temperatures including, but not limited to, about 20, 21, 22, 23, 24, 25, 26, 27, 28, 29, or about 30° C.

In an exemplary embodiment, the humidity may be decreased to increase the solvent evaporation rate, and vice versa. Lower humidity may be used to form smoother fibers having lower porosity, and vice versa. In certain embodiments, the fibers may be formed in an environment at exemplary humidity including, but not limited to, about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or about 90% humidity.

For example, increasing humidity from about 30% to about 50% results in the fabrication of porous fibers, while decreasing humidity to about 25% results in the fabrication of smooth fibers. As smooth fibers have more tensile strength than porous fibers, in one embodiment, the devices of the invention are maintained and the methods of the invention are performed in controlled humidity conditions, e.g., humidity varying by about less than about 10%.

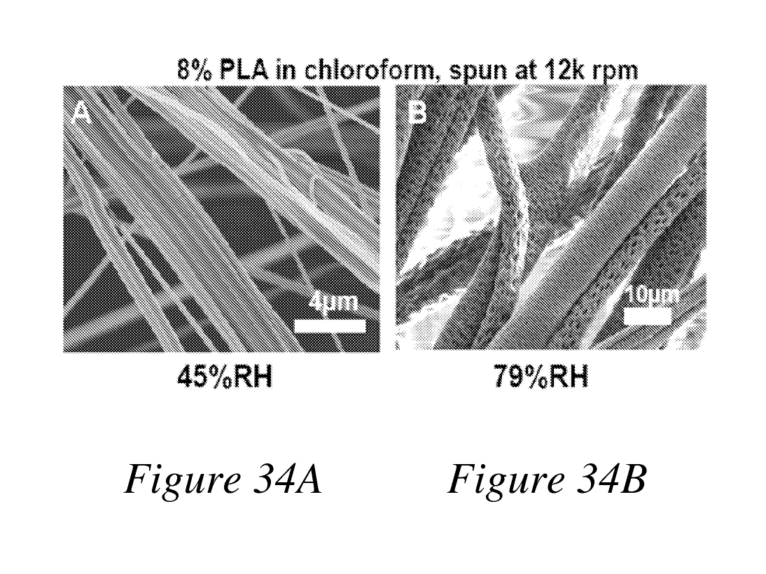

FIGS. 34A and 34B illustrate exemplary fibers formed with 8 wt % polylactic acid dissolved in chloroform which is rotated in an exemplary reservoir at about 12,000 rpm. The smooth and less porous fibers in FIG. 34A are formed at a low environmental humidity of about 45% RH. The rougher and more porous fibers of FIG. 34 B are formed at a higher environmental humidity of about 75% RH. This shows that a higher humidity results in rougher and more porous fibers.

In an exemplary embodiment, the nozzles of the reservoir may be configured to increase the jet surface area of the material solution to increase the solvent evaporation rate, and vice versa.

In other exemplary embodiments, one or more of the above factors may be altered in combination to affect the surface texture and porosity of the fibers.

### K. Use of Exemplary Embodiments in Implantations in the Body

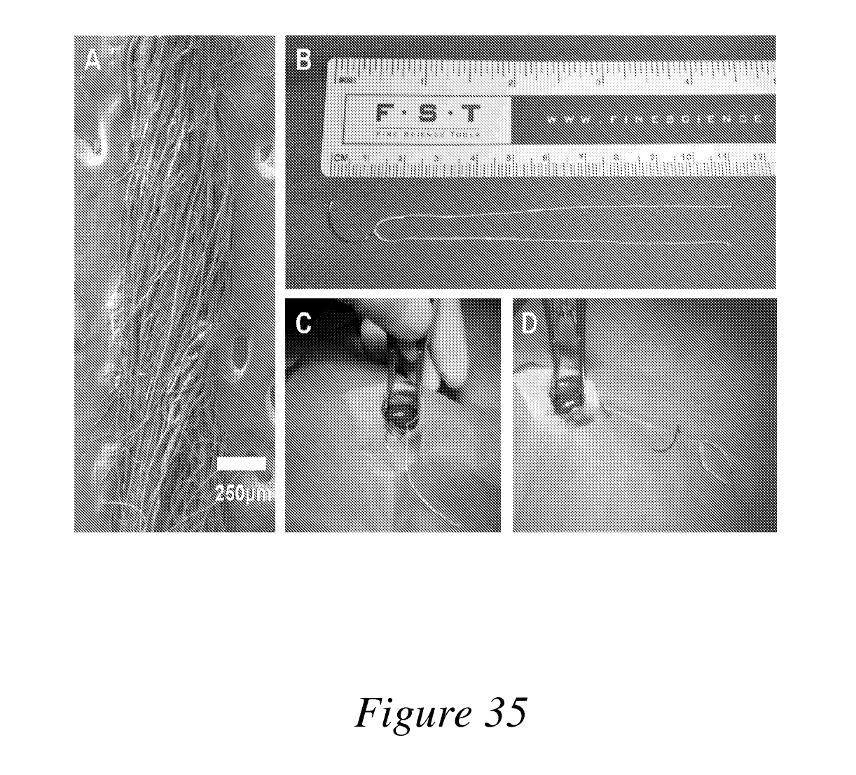

Exemplary embodiments may be used to form fibers that are implanted into a body, for example, as a cell delivery device. FIGS. 35A-35D illustrate fibers produced from 12% polylactic acid solutions by exemplary fiber formation devices that may be manually wound into microthreads and implanted as a cell delivery device. FIG. 35A illustrates an SEM image of individual nanofibers wound into a 500 μm thread. FIG. 35B illustrates a macroscale image of the microthread threaded onto a suture needle. FIG. 35C illustrates the PLA microthread sutured into the left ventricular wall of an adult rat heart. FIG. 35D illustrates excess thread that may be trimmed away while the microthread section remains in the heart for cell delivery and stability.

Exemplary applications of implantable fibers include, but are not limited to, cell delivery devices, cell stability devices, pacemakers, etc.

Natural polymers, synthetic polymers, biogenic polymers, e.g., proteins, etc., may be used to form the threads using exemplary fiber formation devices. The threads may be functionalized to aid in reducing immune response and in promoting cell viability and integration.

### L. Use of Exemplary Embodiments in Forming Conductive Fibers

Exemplary fiber formation devices may be used to form fibers that are thermally conductive and that may be used to conduct thermal energy, i.e., heat.

Exemplary fiber formation devices may be used to form fibers that are magnetically reactive. Examples of magnetically active materials that may be used to form fibers include, but are not limited, to ferrofluids (colloidal suspensions of magnetic particles) and various dispersions of electrically conducting polymers. Ferrofluids containing particles approximately 10 nanometers in diameter, polymer-encapsulated magnetic particles about 1-2 microns in diameter, and polymers with a glass transition temperature below room temperature are particularly useful.

Exemplary fiber formation devices may be used to form fibers that are electrically conductive and that may be used to conduct electrical energy, e.g., as wires. The fibers formed may include conductive particles, e.g., particles of metal like gold, that impart an electrically conductive property to the fibers. In an exemplary embodiment, the material solution used to form the fibers may include the conductive particles. In another exemplary embodiment, the conductive particles may be integrated into the fibers as the fibers are being formed and/or after formation.

Examples of electrically active materials that may be used to form fibers are polymers including, but not limited to, electrically conducting polymers such as polyanilines and polypyrroles, ionically conducting polymers such as sulfonated polyacrylamides are related materials, and electrical conductors such as carbon black, graphite, carbon nanotubes, metal particles, and metal-coated plastic or ceramic materials.

In an exemplary embodiment, the fibers may have a fixed electrical impedance.

In another exemplary embodiment, the fibers may have a variable electrical impedance. In an exemplary embodiment, the structural configuration of the fibers may be adjusted to vary the electrical impedance. For example, the fiber structure may be squeezed together before use or during use to increase the concentration of the conductive particles, which decreases the electrical impedance, and vice versa.

Exemplary conductive fibers formed by exemplary fiber formation devices may be used in various electrically conductive applications including, but not limited to, integrated circuits, medical devices that are supplied with electrical power, etc.

### M. Exemplary Polymers

Any polymer may be used to fabricate polymeric fibers using exemplary embodiments.

Exemplary polymers for use in the devices and methods of exemplary embodiments may be biocompatible or non-biocompatible, synthetic or natural and those such as those that are synthetically designed to have shear induced unfolding. and include, for example, poly(urethanes), poly(siloxanes) or silicones, poly(ethylene), poly(vinyl pyrrolidone), poly(2-hydroxy ethyl methacrylate), poly(N-vinyl pyrrolidone), poly(methyl methacrylate), poly(vinyl alcohol), poly(acrylic acid), polyacrylamide, poly(ethylene-co-vinyl acetate), poly(ethylene glycol), poly(methacrylic acid), polylactides (PLA), polyglycolides (PGA), poly(lactide-co-glycolides) (PLGA), polyanhydrides, polyphosphazenes, polygermanes, polyorthoesters, polyesters, polyamides, polyolefins, polycarbonates, polyaramides, polyimides, and copolymers and derivatives thereof.

Exemplary polymers for use in the devices and methods of exemplary embodiments may be naturally occurring polymers e.g., biogenic polymers, such as proteins, polysaccharides, lipids, nucleic acids or combinations thereof.

Exemplary biogenic polymers, e.g., fibrous proteins, for use in the devices and methods of exemplary embodiments include, but are not limited to, extracellular matric proteins, silk (e.g., fibroin, sericin, etc.), keratins (e.g., alpha-keratin which is the main protein component of hair, horns and nails, beta-keratin which is the main protein component of scales and claws, etc.), elastins (e.g., tropoelastin, etc.), fibrillin (e.g., fibrillin-1 which is the main component of microfibrils, fibrillin-2 which is a component in elastogenesis, fibrillin-3 which is found in the brain, fibrillin-4 which is a component in elastogenesis, etc.), fibrinogen/fibrins/thrombin (e.g., fibrinogen which is converted to fibrin by thrombin during wound healing), fibronectin, laminin, collagens (e.g., collagen I which is found in skin, tendons and bones, collagen II which is found in cartilage, collagen III which is found in connective tissue, collagen IV which is found in extracellular matrix (ECM) protein, collagen V which is found in hair, etc.), vimentin, neurofilaments (e.g., light chain neurofilaments NF-L, medium chain neurofilaments NF-M, heavy chain neurofilaments NF-H, etc.), amyloids (e.g., alpha-amyloid, beta-amyloid, etc.), actin, myosins (e.g., myosin I-XVII, etc.), titin which is the largest known protein (also known as connectin), etc.

Exemplary biogenic polymers, e.g., fibrous polysaccharides, for use in the devices and methods of exemplary embodiments include, but are not limited to, chitin which is a major component of arthropod exoskeletons, hyaluronic acid which is found in extracellular space and cartilage (e.g., D-glucuronic acid which is a component of hyaluronic acid, D-N-acetylglucosamine which is a component of hyaluronic acid, etc.), etc.

Exemplary glycosaminoglycans (GAGs)—carbohydrate polymers found in the body—for use in the devices and methods of exemplary embodiments include, but are not limited to, heparan sulfate founding extracelluar matrix, chondroitin sulfate which contributes to tendon and ligament strength, keratin sulfate which is found in extracellular matrix, etc.

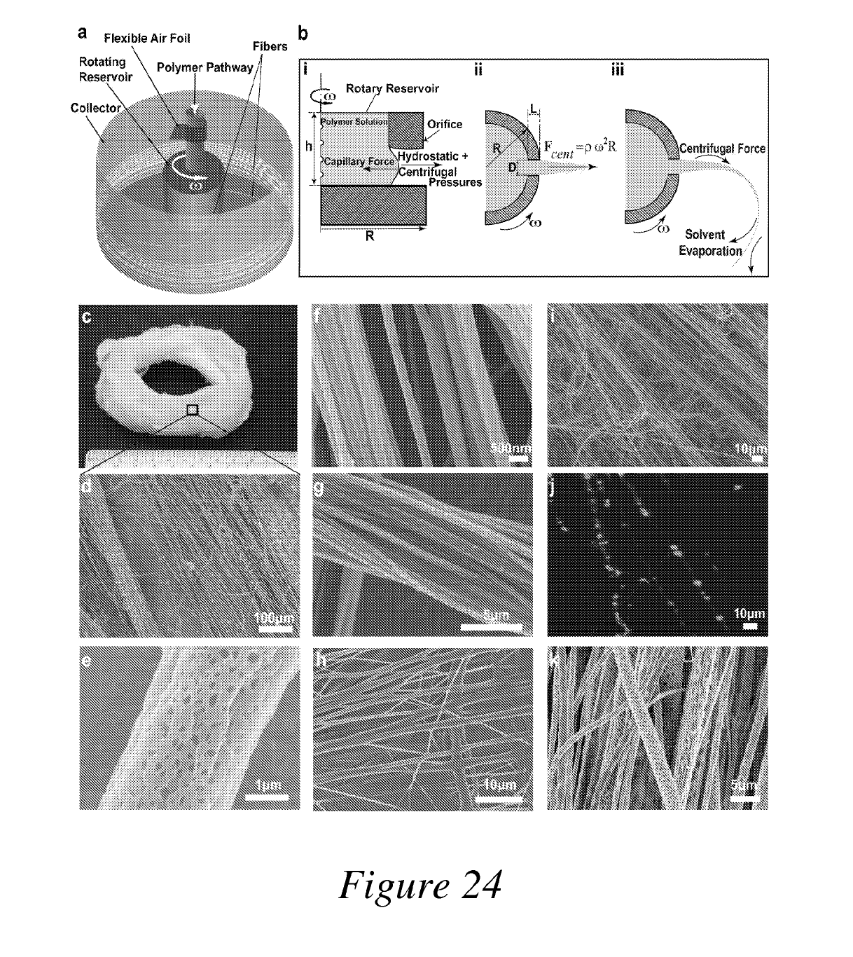

In certain embodiments of the invention, the methods include mixing a biologically active agent, e.g., a polypeptide, protein, nucleic acid molecule, nucleotide, lipid, biocide, antimicrobial, or pharmaceutically active agent, with the polymer during the fabrication process of the polymeric fibers. For example, as depicted in FIG. 24J polymeric fibers prepared using the devices and methods of the invention were contacted with encapsulated fluorescent polystyrene beads.

In other embodiments, a plurality of living cells is mixed with the polymer during the fabrication process of the polymeric fibers. In such embodiments, biocompatible polymers (e.g., hydrogels) may be used.

Sufficient speeds and times for operating the devices of the invention to form a polymeric fiber are dependent on the concentration of the polymer and the desired features of the formed polymeric fiber. For example, as shown in the Examples, an 8% weight solution of polylactic acid rotated at 10,000 rpm allowed the formation of continuous polymeric fibers.

In one embodiment, the polymer is not sugar, e.g., raw sugar, or sucrose. In another embodiment, the polymer is not floss sugar.

In one embodiment, a polymer for use in the methods of the invention is a synthetic polymer. In one embodiment, the polymer is biocompatible. Suitable biocompatible polymers, include, but are not limited to, for example, poly(urethanes), poly(siloxanes) or silicones, poly(ethylene), poly(vinyl pyrrolidone), poly(2-hydroxy ethyl methacrylate), poly(N-vinyl pyrrolidone), poly(methyl methacrylate), poly(vinyl alcohol), poly(acrylic acid), polyacrylamide, poly(ethylene-co-vinyl acetate), poly(ethylene glycol), poly(methacrylic acid), polylactides (PLA), polyglycolides (PGA), poly(lactide-co-glycolides) (PLGA), polyanhydrides, polyphosphazenes, polygermanes, and polyorthoesters, and copolymers and derivatives thereof.

In another embodiment, polymers for use in the polymeric fibers of the invention are not biocompatible. Suitable non-biocompatible polymers, include, but are not limited to, for example, polyesters, polyamides, polyolefins, polycarbonates, polyaramides, polyimides, and copolymers and derivatives thereof.

In yet another embodiment, polymers for use in the polymeric fibers of the invention are naturally occurring polymers, e.g., biogenic polymers. Non-limiting examples of such naturally occurring polymers include, for example, polypeptides, proteins, e.g., capable of fibrillogenesis, polysaccharides, e.g., alginate, lipids, nucleic acid molecules, and combinations thereof.

In one embodiment, a single polymer is used to fabricate the polymeric fibers of the invention. In another embodiment, two, three, four, five, or more polymers are used to fabricate the polymeric fibers of the invention. In one embodiment the polymers for use in the methods of the invention may be mixtures of two or more polymers and/or two or more copolymers. In one embodiment the polymers for use in the methods of the invention may be a mixture of one or more polymers and or more copolymers. In another embodiment, the polymers for use in the methods of the invention may be a mixture of one or more synthetic polymers and one or more naturally occurring polymers.

A polymer for use in the methods of the invention may be fed into the reservoir as a polymer solution. Accordingly, the methods of the invention may further comprise dissolving the polymer in a solvent (e.g., chloroform, water, ethanol, isopropanol) prior to feeding the polymer into the reservoir.

Alternatively, the polymer may be fed into the reservoir as a polymer melt and, thus, in one embodiment, the reservoir is heated at a temperature suitable for melting the polymer, e.g., heated at a temperature of about 100° C.-300° C., 100° C.-200° C., about 150-300° C., about 150-250° C., or about 150-200° C., 200° C.-250° C., 225° C.-275° C., 220° C.-250° C., or about 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, or about 300° C. Ranges and temperatures intermediate to the recited temperature ranges are also part of the invention. In such embodiments, the reservoir may further comprise a heating element.

In one embodiment, the polymeric fibers formed according to the methods of the invention are further contacted with an agent to produce or increase the size of pores or number of pores per surface unit area in the polymeric fibers.

The polymeric fibers formed according to the methods of the invention may be contacted with additional agents and optionally cultured in an appropriate medium, such as a tissue culture medium. Contacting the polymeric fibers with the additional agents will allow the agents to, for example, coat (fully or partially) the fibers, or in the case of for example cells, to intercalate between fibers. Contacting the polymer with additional agents during the fabrication of the polymeric fibers also allows the agents to be incorporated into the polymeric fibers themselves.

In one embodiment, a plurality of polymeric fibers may be contacted, e.g., seeded, with a plurality of living cells, e.g., vascular smooth muscle cells, myocytes (e.g., cardiac myocytes), skeletal muscle, myofibroblasts, airway smooth muscle cells, osteoblasts, myoblasts, neuroblasts, fibroblasts, glioblasts, germ cells, hepatocytes, chondrocytes, keratinocytes, connective tissue cells, glial cells, epithelial cells, endothelial cells, vascular endothelial cells, hormone-secreting cells, cells of the immune system, neural cells, and cells that will differentiate into contractile cells (e.g., stem cells, e.g., embryonic stem cells or adult stem cells, progenitor cells or satellite cells). In one embodiment, polymeric fibers treated with a plurality of living cells may be cultured in an appropriate medium in vitro. Such cultured cells exhibit characteristics and functions typical of such cells in vivo. The plurality of living cells may comprise one or more types of cells, such as described in U.S. Provisional Application No. 61/306,736 and PCT Application No. PCT/US09/060,224, entitled “Tissue Engineered Mycocardium and Methods of Productions and Uses Thereof”, filed Oct. 9, 2009, the entire contents of each of which are incorporated herein by reference.

The cells may be normal cells, abnormal cells (e.g., those derived from a diseased tissue, or those that are physically or genetically altered to achieve a abnormal or pathological phenotype or function), normal or diseased muscle cells derived from embryonic stem cells or induced pluripotent stem cells.

The term “progenitor cell” is used herein to refer to cells that have a cellular phenotype that is more primitive (e.g., is at an earlier step along a developmental pathway or progression than is a fully differentiated cell) relative to a cell which it can give rise to by differentiation. Often, progenitor cells also have significant or very high proliferative potential. Progenitor cells can give rise to multiple distinct differentiated cell types or to a single differentiated cell type, depending on the developmental pathway and on the environment in which the cells develop and differentiate.

The term “progenitor cell” is used herein synonymously with “stem cell.”

The term “stem cell” as used herein, refers to an undifferentiated cell which is capable of proliferation and giving rise to more progenitor cells having the ability to generate a large number of mother cells that can in turn give rise to differentiated, or differentiable daughter cells. The daughter cells themselves can be induced to proliferate and produce progeny that subsequently differentiate into one or more mature cell types, while also retaining one or more cells with parental developmental potential. The term “stem cell” refers to a subset of progenitors that have the capacity or potential, under particular circumstances, to differentiate to a more specialized or differentiated phenotype, and which retains the capacity, under certain circumstances, to proliferate without substantially differentiating. In one embodiment, the term stem cell refers generally to a naturally occurring mother cell whose descendants (progeny) specialize, often in different directions, by differentiation, e.g., by acquiring completely individual characters, as occurs in progressive diversification of embryonic cells and tissues. Cellular differentiation is a complex process typically occurring through many cell divisions. A differentiated cell may derive from a multipotent cell which itself is derived from a multipotent cell, and so on. While each of these multipotent cells may be considered stem cells, the range of cell types each can give rise to may vary considerably. Some differentiated cells also have the capacity to give rise to cells of greater developmental potential. Such capacity may be natural or may be induced artificially upon treatment with various factors. In many biological instances, stem cells are also “multipotent” because they can produce progeny of more than one distinct cell type, but this is not required for “stem-ness.” Self-renewal is the other classical part of the stem cell definition. In theory, self-renewal can occur by either of two major mechanisms. Stem cells may divide asymmetrically, with one daughter retaining the stem state and the other daughter expressing some distinct other specific function and phenotype. Alternatively, some of the stem cells in a population can divide symmetrically into two stems, thus maintaining some stem cells in the population as a whole, while other cells in the population give rise to differentiated progeny only. Formally, it is possible that cells that begin as stem cells might proceed toward a differentiated phenotype, but then “reverse” and re-express the stem cell phenotype, a term often referred to as “dedifferentiation” or “reprogramming” or “retrodifferentiation”.

The term “embryonic stem cell” is used to refer to the pluripotent stem cells of the inner cell mass of the embryonic blastocyst (see U.S. Pat. Nos. 5,843,780, 6,200,806, the contents of which are incorporated herein by reference). Such cells can similarly be obtained from the inner cell mass of blastocysts derived from somatic cell nuclear transfer (see, for example, U.S. Pat. Nos. 5,945,577, 5,994,619, 6,235,970, which are incorporated herein by reference). The distinguishing characteristics of an embryonic stem cell define an embryonic stem cell phenotype. Accordingly, a cell has the phenotype of an embryonic stem cell if it possesses one or more of the unique characteristics of an embryonic stem cell such that that cell can be distinguished from other cells. Exemplary distinguishing embryonic stem cell characteristics include, without limitation, gene expression profile, proliferative capacity, differentiation capacity, karyotype, responsiveness to particular culture conditions, and the like.

The term “adult stem cell” or “ASC” is used to refer to any multipotent stem cell derived from non-embryonic tissue, including fetal, juvenile, and adult tissue. Stem cells have been isolated from a wide variety of adult tissues including blood, bone marrow, brain, olfactory epithelium, skin, pancreas, skeletal muscle, and cardiac muscle. Each of these stem cells can be characterized based on gene expression, factor responsiveness, and morphology in culture. Exemplary adult stem cells include neural stem cells, neural crest stem cells, mesenchymal stem cells, hematopoietic stem cells, and pancreatic stem cells.

In one embodiment, progenitor cells suitable for use in the claimed devices and methods are Committed Ventricular Progenitor (CVP) cells as described in PCT Application No. PCT/US09/060,224, entitled “Tissue Engineered Mycocardium and Methods of Productions and Uses Thereof”, filed Oct. 9, 2009, the entire contents of which are incorporated herein by reference.

Cells for seeding can be cultured in vitro, derived from a natural source, genetically engineered, or produced by any other means. Any natural source of prokaryotic or eukaryotic cells may be used. Embodiments in which the polymeric fibers contacted with a plurality of living cells are implanted in an organism can use cells from the recipient, cells from a conspecific donor or a donor from a different species, or bacteria or microbial cells.

In one embodiment of the invention, a plurality of polymeric fibers is contacted with a plurality of muscle cells and cultured such that a living tissue is produced.

In another embodiment of the invention, a plurality of polymeric fibers is contacted with a plurality of muscle cells and cultured such that a living tissue is produced, and the living tissue is further contacted with neurons, and cultured such that a living tissue with embedded neural networks is produced.

In one particular embodiment, the living tissue is an anisotropic tissue, e.g., a muscle thin film.

In other embodiments of the invention, a plurality of polymeric fibers is contacted with a biologically active polypeptide or protein, such as, collagen, fibrin, elastin, laminin, fibronectin, integrin, hyaluronic acid, chondroitin 4-sulfate, chondroitin 6-sulfate, dermatan sulfate, heparin sulfate, heparin, and keratan sulfate, and proteoglycans. In one embodiment, the polypeptide or protein is lipophilic.

In still other embodiments, the polymeric fibers are contacted with nucleic acid molecules and/or nucleotides, or lipids.

A plurality of polymeric fibers may also be contacted with a pharmaceutically active agent. Suitable pharmaceutically active agents include, for example, anesthetics, hypnotics, sedatives and sleep inducers, antipsychotics, antidepressants, antiallergics, antianginals, antiarthritics, antiasthmatics, antidiabetics, antidiarrheal drugs, anticonvulsants, antigout drugs, antihistamines, antipruritics, emetics, antiemetics, antispasmodics, appetite suppressants, neuroactive substances, neurotransmitter agonists, antagonists, receptor blockers and reuptake modulators, beta-adrenergic blockers, calcium channel blockers, disulfuram and disulfuram-like drugs, muscle relaxants, analgesics, antipyretics, stimulants, anticholinesterase agents, parasympathomimetic agents, hormones, anticoagulants, antithrombotics, thrombolytics, immunoglobulins, immunosuppressants, hormone agonists/antagonists, vitamins, antimicrobial agents, antineoplastics, antacids, digestants, laxatives, cathartics, antiseptics, diuretics, disinfectants, fungicides, ectoparasiticides, antiparasitics, heavy metals, heavy metal antagonists, chelating agents, gases and vapors, alkaloids, salts, ions, autacoids, digitalis, cardiac glycosides, antiarrhythmics, antihypertensives, vasodilators, vasoconstrictors, antimuscarinics, ganglionic stimulating agents, ganglionic blocking agents, neuromuscular blocking agents, adrenergic nerve inhibitors, anti-oxidants, vitamins, cosmetics, anti-inflammatories, wound care products, antithrombogenic agents, antitumoral agents, antiangiogenic agents, anesthetics, antigenic agents, wound healing agents, plant extracts, growth factors, emollients, humectants, rejection/anti-rejection drugs, spermicides, conditioners, antibacterial agents, antifungal agents, antiviral agents, antibiotics, biocidal agents, anti-biofouling agents, tranquilizers, cholesterol-reducing drugs, antitussives, histamine-blocking drugs, or monoamine oxidase inhibitors.

Other suitable pharmaceutically active agents include growth factors and cytokines. Growth factors useful in the present invention include, but are not limited to, transforming growth factor-α (“TGF-α”), transforming growth factor-β (“TGF-β”), platelet-derived growth factors including the AA, AB and BB isoforms (“PDGF”), fibroblast growth factors (“FGF”), including FGF acidic isoforms 1 and 2, FGF basic form 2, and FGF 4, 8, 9 and 10, nerve growth factors (“NGF”) including NGF 2.5s, NGF 7.0s and beta NGF and neurotrophins, brain derived neurotrophic factor, cartilage derived factor, bone growth factors (BGF), basic fibroblast growth factor, insulin-like growth factor (IGF), vascular endothelial growth factor (VEGF), granulocyte colony stimulating factor (G-CSF), insulin like growth factor (IGF) I and II, hepatocyte growth factor, glial neurotrophic growth factor (GDNF), stem cell factor (SCF), keratinocyte growth factor (KGF), transforming growth factors (TGF), including TGFs alpha, beta, beta1, beta2, and beta3, skeletal growth factor, bone matrix derived growth factors, and bone derived growth factors and mixtures thereof. Cytokines useful in the present invention include, but are not limited to, cardiotrophin, stromal cell derived factor, macrophage derived chemokine (MDC), melanoma growth stimulatory activity (MGSA), macrophage inflammatory proteins 1 alpha (MIP-1alpha), 2, 3 alpha, 3 beta, 4 and 5, IL-1, IL-2, IL-3, IL-4, IL-5, IL-6, IL-7, IL-8, IL-9, IL-10, IL-11, IL-12, IL-13, TNF-α, and TNF-β. Immunoglobulins useful in the present invention include, but are not limited to, IgG, IgA, IgM, IgD, IgE, and mixtures thereof.

Other agents that may be used to contact the polymeric fibers of the invention, include, but are not limited to, growth hormones, leptin, leukemia inhibitory factor (LIF), tumor necrosis factor alpha and beta, endostatin, angiostatin, thrombospondin, osteogenic protein-1, bone morphogenetic proteins 2 and 7, osteonectin, somatomedin-like peptide, osteocalcin, interferon alpha, interferon alpha A, interferon beta, interferon gamma, interferon 1 alpha, amino acids, peptides, polypeptides, and proteins, e.g., structural proteins, enzymes, and peptide hormones.

For agents such as nucleic acids, any nucleic acid can be used to contact the polymeric fibers. Examples include, but are not limited to deoxyribonucleic acid (DNA), ent-DNA, and ribonucleic acid (RNA). Embodiments involving DNA include, but are not limited to, cDNA sequences, natural DNA sequences from any source, and sense or anti-sense oligonucleotides. For example, DNA can be naked (e.g., U.S. Pat. Nos. 5,580,859; 5,910,488) or complexed or encapsulated (e.g., U.S. Pat. Nos. 5,908,777; 5,787,567). DNA can be present in vectors of any kind, for example in a viral or plasmid vector. In some embodiments, nucleic acids used will serve to promote or to inhibit the expression of genes in cells inside and/or outside the polymeric fibers. The nucleic acids can be in any form that is effective to enhance uptake into cells.

Agents used to treat the polymeric fibers of the invention may also be cell fragments, cell debris, organelles and other cell components, tablets, and viruses as well as vesicles, liposomes, capsules, nanoparticles, and other agents that serve as an enclosure for molecules. In some embodiments, the agents constitute vesicles, liposomes, capsules, or other enclosures that contain agents that are released at a time after contacting, such as at the time of implantation or upon later stimulation or interaction. In one illustrative embodiment, transfection agents such as liposomes contain desired nucleotide sequences to be incorporated into cells that are located in or on the polymeric fibers.

Magnetically or electrically reactive materials are examples of other agents that are optionally used to contact the polymeric fibers of the present invention. Examples of magnetically active materials include but are not limited to ferrofluids (colloidal suspensions of magnetic particles), and various dispersions of electrically conducting polymers. Ferrofluids containing particles approximately 10 nanometers in diameter, polymer-encapsulated magnetic particles about 1-2 microns in diameter, and polymers with a glass transition temperature below room temperature are particularly useful. Examples of electrically active materials are polymers including, but not limited to, electrically conducting polymers such as polyanilines and polypyrroles, ionically conducting polymers such as sulfonated polyacrylamides are related materials, and electrical conductors such as carbon black, graphite, carbon nanotubes, metal particles, and metal-coated plastic or ceramic materials.

Suitable biocides for contacting the polymeric fibers of the invention, include, but are not limited to, organotins, brominated salicylanilides, mercaptans, quaternary ammonium compounds, mercury compounds, and compounds of copper and arsenic.

Antimicrobial agents, which include antibacterial agents, antiviral agents, antifungal agents, and anti-parasitic agents, may also be used to contact the polymeric fibers of the invention.

The present invention is also directed to the polymeric fibers produced using the methods and device of the invention, as well as, tissues, membranes, filters, and drug delivery device, e.g., polymeric fibers treated with, e.g., a pharmaceutically active agent, comprising the polymeric fibers of the invention.

### N. Use of Polymeric Fibers Formed Using Exemplary Embodiments

The polymeric fibers of the invention may be used in a broad range of applications, including, but not limited to, manufacture of engineered tissue and organs, including structures such as patches or plugs of tissues or matrix material, prosthetics, and other implants, tissue scaffolding for, e.g., fractal neural and/or vascular networks, repair or dressing of wounds, hemostatic devices, devices for use in tissue repair and support such as sutures, surgical and orthopedic screws, and surgical and orthopedic plates, natural coatings or components for synthetic implants, cosmetic implants and supports, repair or structural support for organs or tissues, substance delivery, bioengineering platforms, platforms for testing the effect of substances upon cells, cell culture, catalytic substrates, photonics, filtration, protective clothing, cell scaffolding, drug delivery, wound healing, food products, enzyme immobilization, use in a biosensor, forming a membrane, forming a filter, forming a fiber, forming a net, forming a food item, forming a medicinal item, forming a cosmetic item, forming a fiber structure inside a body cavity, forming a non-lethal weapon, forming packaging material (package wrapping material, spill containment, e.g., a chemical or oil spill, and the like and numerous other uses.

item, forming a fiber structure inside a body cavity, and the like.

Mat, mesh and/or woven structures formed with exemplary fibers may be used in non-lethal weapons, for example, nets.

Biogenic polymer fibrous structures may be formed by exemplary fiber formation devices, systems and methods with different and hierarchical porosities in a single construct. The fibrous structures may, for example, be used to facilitate nutrition and vascularisation in tissues at the millimeter scale, to accommodate and mechanically support cells at the micrometer scale, and to facilitate the expression of extracellular matrix components with desired chemical and mechanical functions.

Three-dimensional nano-fibrous scaffolds may be formed by exemplary fiber formation devices, systems and methods to provide one or more biomolecular templates from β-sheet proteins, silk fibroin, fibrinogen, vitronectin, amyloid-β proteins, and the like. That is, the nano-fibrous scaffolds may be formed of fundamental building blocks of human body tissues and may be used to provide motility, elasticity, stability and protection of cells and tissues.

Biogenic polymer assemblies with defined dimensional scales formed by exemplary fiber formation devices, systems and methods may be used as a wound healing patch to enhance healing processes by providing essential proteins on or in the wound area to significantly shorten the healing time.

Biogenic polymers formed by exemplary fiber formation devices, systems and methods may be used as biofunctional textiles.

One of the benefits of the polymeric fibers of the invention is that they can be used to tightly control the biotic/abiotic interface. In other words, the polymeric fibers of the invention can be used to direct the growth and/or development of specific cell and/or tissue types.

For example, in one embodiment, the polymeric fibers of the invention may be used to prepare a membrane, which is useful as, for example, a dressing for wounds or injuries of any type. Stem cells, fibroblasts, epithelial cells, and/or endothelial cells may be included to allow tissue growth. In certain embodiments, use of the polymeric fibers will, in addition to providing support, will direct and/or impede desired cells types to the area of a wound or injury. For example, use of the polymeric fibers to repair the heart may include the addition of any suitable substance that will direct cells to differentiate into, for example, myocytes, rather than, for example, fibroblasts, and/or encourage the migration of a desired cell type to migrate to the area of the wound. Such methods will ensure that the repair is biologically functional and/or discourage, for example restonosis. Such use of the polymeric fibers may be combined with other methods of treatment, repair, and contouring.

In another embodiment, a polymeric fiber membrane can be inserted as a filler material into wounds to enhance healing by providing a substrate that does not have to be synthesized by fibroblasts and other cells, thereby decreasing healing time and reducing the metabolic energy requirement to synthesize new tissue at the site of the wound.

Several uses of polymeric fiber membranes are possible in the field of surgical repair or construction. For example, membranes of the present invention may be used to make tissue or orthopedic screws, plates, sutures, or sealants that are made of the same material as the tissue in which the devices will be used.

In other exemplary embodiments, polymeric fiber membranes may be used to form, e.g., a sleeve to use as reinforcement for aneurysms or at the site of an anastamosis. Such sleeves are placed over the area at which reinforcement is desired and sutured, sealed, or otherwise attached to the vessel. Polymeric fiber membranes may also be used as hemostatic patches and plugs for leaks of cerebrospinal fluid. Yet another use is as an obstruction of the punctum lacryma for a patient suffering from dry eye syndrome.

Polymeric fiber membranes may also be used to support or connect tissue or structures that have experienced injury, surgery, or deterioration. For example, such membranes may be used in a bladder neck suspension procedure for patients suffering from postpartum incontinence. Rectal support, vaginal support, hernia patches, and repair of a prolapsed uterus are other illustrative uses. The membranes may be used to repair or reinforce weakened or dysfunctional sphincter muscles, such as the esophageal sphincter in the case of esophageal reflux. Other examples include reinforcing and replacing tissue in vocal cords, epiglottis, and trachea after removal, such as in removal of cancerous tissue.

Other uses for the membranes of the invention include, for example, preparing an obstruction or reinforcement for an obstruction to a leak. For example, to seal openings in lungs after lung volume reduction (partial removal).

Another exemplary us of the polymeric fibers of the invention is as a barrier for the prevention of post-operative induced adhesion(s).

Yet another exemplary use of the polymeric fibers of the invention is to serve as a template for nerve growth.

In another embodiment of the invention, the polymeric fibers may be used to prepare a filter. Such filters are useful for filtration of contaminants, biological agents and hazardous but very small particles, e.g., nanoparticles. For example, a polymeric fiber filter of the invention may be used to purify liquids, such as water, e.g., drinking water, oil, e.g., when used in an automobile oil filter. In another embodiment, a polymeric fiber filter may be used to purify air when used in, e.g., a face mask, to filter out viruses, bacteria and hazardous nanoparticles.

The polymeric fibers of the invention may also be incorporated into biosensor devices, e.g., a device that uses a biological element (e.g., enzyme, antibody, whole cell, etc.) to monitor the presence of various chemicals on a substrate by enabling highly specific interactions between biological molecules to be detected and utilized, e.g., as. a biorecognition surface. Such biosensors may be used in various applications such as the monitoring of pollutants in water, air, and soil, and in the detection of medically important molecules such as hormones, sugars, and peptides in body fluids, and for pathogen detection.

In yet other embodiments of the invention, the polymeric fibers may be used to prepare textiles. In one embodiment, the textile are biological protective textiles, e.g., textiles that provide protection from toxic agents, e.g., biological and chemical toxins. For example, the polymeric fibers may include, e.g., chlorhexidine, which can kill most bacteria, or an oxime that can break down organophosphates, chemicals that are the basis of many pesticides, insecticides and nerve gases.

In another embodiment, the polymeric fibers of the invention may be used to prepare food products. For example, polymeric fibers may be made of an edible polymer, e.g., alginate, to which a flavoring, e.g., fruit flavoring or chocolate, may be added. In one embodiment, the food product is not cotton candy.

In another embodiment, the polymeric fibers of the invention may be used to prepare furniture upholstery.

In another embodiment, the polymeric fibers of the invention may be used to form or manufacture medical devices.

Exemplary fiber formation devices may be used to form fibers that are thermally conductive and that may be used to conduct thermal energy, i.e., heat. Exemplary fiber formation devices may be used to form fibers that are magnetically reactive. Examples of magnetically active materials that may be used to form fibers include, but are not limited, to ferrofluids (colloidal suspensions of magnetic particles) and various dispersions of electrically conducting polymers. Ferrofluids containing particles approximately 10 nanometers in diameter, polymer-encapsulated magnetic particles about 1-2 microns in diameter, and polymers with a glass transition temperature below room temperature are particularly useful.

Exemplary fiber formation devices may be used to form fibers that are electrically conductive and that may be used to conduct electrical energy, e.g., as wires. The fibers formed may include conductive particles, e.g., particles of metal like gold, that impart an electrically conductive property to the fibers. In an exemplary embodiment, the material solution used to form the fibers may include the conductive particles. In another exemplary embodiment, the conductive particles may be integrated into the fibers as the fibers are being formed and/or after formation. Examples of electrically active materials that may be used to form fibers are polymers including, but not limited to, electrically conducting polymers such as polyanilines and polypyrroles, ionically conducting polymers such as sulfonated polyacrylamides are related materials, and electrical conductors such as carbon black, graphite, carbon nanotubes, metal particles, and metal-coated plastic or ceramic materials.

In an exemplary embodiment, the fibers may have a fixed electrical impedance. In another exemplary embodiment, the fibers may have a variable electrical impedance. In an exemplary embodiment, the structural configuration of the fibers may be adjusted to vary the electrical impedance. For example, the fiber structure may be squeezed together before use or during use to increase the concentration of the conductive particles, which decreases the electrical impedance, and vice versa.

Exemplary conductive fibers formed by exemplary fiber formation devices may be used in various electrically conductive applications including, but not limited to, integrated circuits, medical devices that are supplied with electrical power, etc.

In another embodiment, the polymeric fibers of the invention may be used to create fibers inside the cavity of a body, e.g., inside an organ like the heart.

Another use of the polymeric fibers of the present invention is the delivery of one or more substances to a desired location and/or in a controlled manner. In some embodiments, the polymeric fibers are used to deliver the materials, e.g., a pharmaceutically active substance. In other embodiments, the polymeric fibers materials are used to deliver substances that are contained in the polymeric fibers or that are produced or released by substances contained in the polymeric fibers materials. For example, polymeric fibers containing cells can be implanted in a body and used to deliver molecules produced by the cells after implantation. The present compositions can be used to deliver substances to an in vivo location, an in vitro location, or other locations. The present compositions can be applied or administered to these locations using any method.

The ability to seed the polymeric fibers of the invention with living cells also provides the ability to build tissue, organs, or organ-like tissues. Cells included in such tissues or organs can include cells that serve a function of delivering a substance, seeded cells that will provide the beginnings of replacement tissue, or both.

In one embodiment of the invention, a plurality of polymeric fibers are treated with a plurality of living cells and cultured under appropriate conditions to produce a bioengineered tissue.

In some embodiments, polymeric fibers contacted or seeded with living cells are combined with a drug such that the function of the implant will improve. For example, antibiotics, anti-inflammatories, local anesthetics or combinations thereof, can be added to the cell-treated polymeric fibers of a bioengineered organ to speed the healing process.

Examples of bioengineered tissue include, but are not limited to, bone, dental structures, joints, cartilage, (including, but not limited to articular cartilage), skeletal muscle, smooth muscle, cardiac muscle, tendons, menisci, ligaments, blood vessels, stents, heart valves, corneas, ear drums, nerve guides, tissue or organ patches or sealants, a filler for missing tissues, sheets for cosmetic repairs, skin (sheets with cells added to make a skin equivalent), soft tissue structures of the throat such as trachea, epiglottis, and vocal cords, other cartilaginous structures such as articular cartilage, nasal cartilage, tarsal plates, tracheal rings, thyroid cartilage, and arytenoid cartilage, connective tissue, vascular grafts and components thereof, and sheets for topical applications, and repair of organs such as livers, kidneys, lungs, intestines, pancreas visual system, auditory system, nervous system, and musculoskeletal system.

In one particular embodiment, a plurality of polymeric fibers are contacted with a plurality of living muscle cells and cultured under appropriate conditions to guide cell growth with desired anisotropy to produce a muscle thin film (MTF) or a plurality of MTFs prepared as described in PCT Publication No. WO 2008/051265 and U.S. Provisional Application No. 61/174,511, entitled “High Throughput Assays for Determining Muscle Cell Function and Devices for Use Therein”, filed, May 1, 209, the entire contents of each of which are incorporated herein by reference.

Polymeric fibers contacted with living cells can also be used to produce prosthetic organs or parts of organs. Mixing of committed cell lines in a three dimensional polymeric fiber matrix can be used to produce structures that mimic complex organs. The ability to shape the polymeric fibers allows for preparation of complex structures to replace organs such as liver lobes, pancreas, other endocrine glands, and kidneys. In such cases, cells are implanted to assume the function of the cells in the organs. Preferably, autologous cells or stem cells are used to minimize the possibility of immune rejection.

In some embodiments, polymeric fibers contacted with living cells are used to prepare partial replacements or augmentations. For example, in certain disease states, organs are scarred to the point of being dysfunctional. A classic example is hepatic cirrhosis. In cirrhosis, normal hepatocytes are trapped in fibrous bands of scar tissue. In one embodiment of the invention, the liver is biopsied, viable liver cells are obtained, cultured in a plurality of polymeric fibers, and re-implanted in the patient as a bridge to or replacement for routine liver transplantations.

In another example, by growing glucagon secreting cells, insulin secreting cells, somatostatin secreting cells, and/or pancreatic polypeptide secreting cells, or combinations thereof, in separate cultures, and then mixing them together with polymeric fibers, an artificial pancreatic islet is created. These structures are then placed under the skin, retroperitoneally, intrahepatically or in other desirable locations, as implantable, long-term treatments for diabetes.

In other examples, hormone-producing cells are used, for example, to replace anterior pituitary cells to affect synthesis and secretion of growth hormone secretion, luteinizing hormone, follicle stimulating hormone, prolactin and thyroid stimulating hormone, among others. Gonadal cells, such as Leydig cells and follicular cells are employed to supplement testosterone or estrogen levels. Specially designed combinations are useful in hormone replacement therapy in post and perimenopausal women, or in men following decline in endogenous testosterone secretion. Dopamine-producing neurons are used and implanted in a matrix to supplement defective or damaged dopamine cells in the substantia nigra. In some embodiments, stem cells from the recipient or a donor can be mixed with slightly damaged cells, for example pancreatic islet cells, or hepatocytes, and placed in a plurality of polymeric fibers and later harvested to control the differentiation of the stem cells into a desired cell type. In other embodiments thyroid cells can be seeded and grown to form small thyroid hormone secreting structures. This procedure is performed in vitro or in vivo. The newly formed differentiated cells are introduced into the patient.

Bioengineered tissues are also useful for measuring tissue activities or functions, investigating tissue developmental biology and disease pathology, as well as in drug discovery and toxicity testing.

Accordingly, the present invention also provides methods for identifying a compound that modulates a tissue function. The methods include providing a bioengineered tissue produced according to the methods of the invention, such as a muscle thin film; contacting the bioengineered tissue with a test compound; and determining the effect of the test compound on a tissue function in the presence and absence of the test compound, wherein a modulation of the tissue function in the presence of the test compound as compared to the tissue function in the absence of the test compound indicates that the test compound modulates a tissue function, thereby identifying a compound that modulates a tissue function.

In another aspect, the present invention also provides methods for identifying a compound useful for treating or preventing a disease. The methods include providing a bioengineered tissue produced according to the methods of the invention, e.g., a muscle thin film; contacting a bioengineered tissue with a test compound; and determining the effect of the test compound on a tissue function in the presence and absence of the test compound, wherein a modulation of the tissue function in the presence of the test compound as compared to the tissue function in the absence of the test compound indicates that the test compound modulates a tissue function, thereby identifying a compound useful for treating or preventing a disease.

The methods of the invention generally comprise determining the effect of a test compound on an bioengineered tissue as a whole, however, the methods of the invention may comprise further evaluating the effect of a test compound on an individual cell type(s) of the bioengineered tissue.

The methods of the invention may involve contacting a single bioengineered tissue with a test compound or a plurality of bioengineered tissues with a test compound.

As used herein, the various forms of the term “modulate” are intended to include stimulation (e.g., increasing or upregulating a particular response or activity) and inhibition (e.g., decreasing or downregulating a particular response or activity).

As used herein, the term “contacting” (e.g., contacting a bioengineered tissue with a test compound) is intended to include any form of interaction (e.g., direct or indirect interaction) of a test compound and a bioengineered tissue. The term contacting includes incubating a compound and a bioengineered tissue (e.g., adding the test compound to a bioengineered tissue).

Test compounds, may be any agents including chemical agents (such as toxins), small molecules, pharmaceuticals, peptides, proteins (such as antibodies, cytokines, enzymes, and the like), and nucleic acids, including gene medicines and introduced genes, which may encode therapeutic agents, such as proteins, antisense agents (i.e., nucleic acids comprising a sequence complementary to a target RNA expressed in a target cell type, such as RNAi or siRNA), ribozymes, and the like.

The test compound may be added to a bioengineered tissue by any suitable means. For example, the test compound may be added drop-wise onto the surface of a bioengineered tissue of the invention and allowed to diffuse into or otherwise enter the bioengineered tissue, or it can be added to the nutrient medium and allowed to diffuse through the medium. In the embodiment where the bioengineered tissue is cultured in a multi-well plate, each of the culture wells may be contacted with a different test compound or the same test compound. In one embodiment, the screening platform includes a microfluidics handling system to deliver a test compound and simulate exposure of the microvasculature to drug delivery.

Numerous physiologically relevant parameters, e.g., insulin secretion, conductivity, neurotransmitter release, lipid production, bile secretion, e.g., muscle activities, e.g., biomechanical and electrophysiological activities, can be evaluated using the polymeric fiber tissues of the invention. For example, in one embodiment, the polymeric fiber tissues of the present invention can be used in contractility assays for muscular cells or tissues, such as chemically and/or electrically stimulated contraction of vascular, airway or gut smooth muscle, cardiac muscle or skeletal muscle. In addition, the differential contractility of different muscle cell types to the same stimulus (e.g., pharmacological and/or electrical) can be studied.

In another embodiment, the bioengineered tissues of the present invention can be used for measurements of solid stress due to osmotic swelling of cells. For example, as the cells swell the polymeric fiber tissues will bend and as a result, volume changes, force and points of rupture due to cell swelling can be measured.

In another embodiment, the bioengineered tissues of the present invention can be used for pre-stress or residual stress measurements in cells. For example, vascular smooth muscle cell remodeling due to long term contraction in the presence of endothelin-1 can be studied.

Further still, the bioengineered tissues of the present invention can be used to study the loss of rigidity in tissue structure after traumatic injury, e.g., traumatic brain injury. Traumatic stress can be applied to vascular smooth muscle bioengineered tissues as a model of vasospasm. These bioengineered tissues can be used to determine what forces are necessary to cause vascular smooth muscle to enter a hyper-contracted state. These bioengineered tissues can also be used to test drugs suitable for minimizing vasospasm response or improving post-injury response and returning vascular smooth muscle contractility to normal levels more rapidly.

In other embodiments, the bioengineered tissues of the present invention can be used to study biomechanical responses to paracrine released factors (e.g., vascular smooth muscle dilation due to release of nitric oxide from vascular endothelial cells, or cardiac myocyte dilation due to release of nitric oxide).

In other embodiments, the bioengineered tissues of the invention can be used to evaluate the effects of a test compound on an electrophysiological parameter, e.g., an electrophysiological profile comprising a voltage parameter selected from the group consisting of action potential, action potential duration (APD), conduction velocity (CV), refractory period, wavelength, restitution, bradycardia, tachycardia, reentrant arrhythmia, and/or a calcium flux parameter, e.g., intracellular calcium transient, transient amplitude, rise time (contraction), decay time (relaxation), total area under the transient (force), restitution, focal and spontaneous calcium release. For example, a decrease in a voltage or calcium flux parameter of a bioengineered tissue comprising cardiomyocytes upon contacting the bioengineered tissue with a test compound, would be an indication that the test compound is cardiotoxic.

In yet another embodiment, the bioengineered tissues of the present invention can be used in pharmacological assays for measuring the effect of a test compound on the stress state of a tissue. For example, the assays may involve determining the effect of a drug on tissue stress and structural remodeling of the bioengineered tissues. In addition, the assays may involve determining the effect of a drug on cytoskeletal structure and, thus, the contractility of the bioengineered tissues.

In still other embodiments, the bioengineered tissues of the present invention can be used to measure the influence of biomaterials on a biomechanical response. For example, differential contraction of vascular smooth muscle remodeling due to variation in material properties (e.g., stiffness, surface topography, surface chemistry or geometric patterning) of bioengineered tissues can be studied.

In further embodiments, the bioengineered tissues of the present invention can be used to study functional differentiation of stem cells (e.g., pluripotent stem cells, multipotent stem cells, induced pluripotent stem cells, and progenitor cells of embryonic, fetal, neonatal, juvenile and adult origin) into contractile phenotypes. For example, the polymeric fibers of the invention are treated with undifferentiated cells, e.g., stem cells, and differentiation into a contractile phenotype is observed by thin film bending. Differentiation can be observed as a function of: co-culture (e.g., co-culture with differentiated cells), paracrine signaling, pharmacology, electrical stimulation, magnetic stimulation, thermal fluctuation, transfection with specific genes and biomechanical perturbation (e.g., cyclic and/or static strains)

In another embodiment, the bioengineered tissues of the invention may be used to determine the toxicity of a test compound by evaluating, e.g., the effect of the compound on an electrophysiological response of a bioengineered tissue. For example, opening of calcium channels results in influx of calcium ions into the cell, which plays an important role in excitation-contraction coupling in cardiac and skeletal muscle fibers. The reversal potential for calcium is positive, so calcium current is almost always inward, resulting in an action potential plateau in many excitable cells. These channels are the target of therapeutic intervention, e.g., calcium channel blocker sub-type of anti-hypertensive drugs. Candidate drugs may be tested in the electrophysiological characterization assays described herein to identify those compounds that may potentially cause adverse clinical effects, e.g., unacceptable changes in cardiac excitation, that may lead to arrhythmia.

For example, unacceptable changes in cardiac excitation that may lead to arrhythmia include, e.g., blockage of ion channel requisite for normal action potential conduction, e.g., a drug that blocks Na⁺ channel would block the action potential and no upstroke would be visible; a drug that blocks Ca²⁺ channels would prolong repolarization and increase the refractory period; blockage of K⁺ channels would block rapid repolarization, and, thus, would be dominated by slower Ca²⁺ channel mediated repolarization.

In addition, metabolic changes may be assessed to determine whether a test compound is toxic by determining, e.g., whether contacting a bioengineered tissue with a test compound results in a decrease in metabolic activity and/or cell death. For example, detection of metabolic changes may be measured using a variety of detectable label systems such as fluormetric/chrmogenic detection or detection of bioluminescence using, e.g., AlamarBlue fluorescent/chromogenic determination of REDOX activity (Invitrogen), REDOX indicator changes from oxidized (non-fluorescent, blue) state to reduced state (fluorescent, red) in metabolically active cells; Vybrant MTT chromogenic determination of metabolic activity (Invitrogen), water soluble MTT reduced to insoluble formazan in metabolically active cells; and Cyquant NF fluorescent measurement of cellular DNA content (Invitrogen), fluorescent DNA dye enters cell with assistance from permeation agent and binds nuclear chromatin. For bioluminescent assays, the following exemplary reagents is used: Cell-Titer Glo luciferase-based ATP measurement (Promega), a thermally stable firefly luciferase glows in the presence of soluble ATP released from metabolically active cells.

The bioengineered tissues of the invention are also useful for evaluating the effects of particular delivery vehicles for therapeutic agents e.g., to compare the effects of the same agent administered via different delivery systems, or simply to assess whether a delivery vehicle itself (e.g., a viral vector or a liposome) is capable of affecting the biological activity of the bioengineered tissue. These delivery vehicles may be of any form, from conventional pharmaceutical formulations, to gene delivery vehicles. For example, the devices of the invention may be used to compare the therapeutic effect of the same agent administered by two or more different delivery systems (e.g., a depot formulation and a controlled release formulation). The bioengineered tissues of the invention may also be used to investigate whether a particular vehicle may have effects of itself on the tissue. As the use of gene-based therapeutics increases, the safety issues associated with the various possible delivery systems become increasingly important. Thus, the bioengineered tissues of the present invention may be used to investigate the properties of delivery systems for nucleic acid therapeutics, such as naked DNA or RNA, viral vectors (e.g., retroviral or adenoviral vectors), liposomes and the like. Thus, the test compound may be a delivery vehicle of any appropriate type with or without any associated therapeutic agent.

Furthermore, the bioengineered tissues of the present invention are a suitable in vitro model for evaluation of test compounds for therapeutic activity with respect to, e.g., a muscular and/or neuromuscular disease or disorder. For example, the bioengineered tissues of the present invention (e.g., comprising muscle cells) may be contacted with a candidate compound by, e.g., immersion in a bath of media containing the test compound, and the effect of the test compound on a tissue activity (e.g., a biomechanical and/or electrophysiological activity) may measured as described herein, as compared to an appropriate control, e.g., an untreated bioengineered tissue. Alternatively, a bioengineered tissue of the invention may be bathed in a medium containing a candidate compound, and then the cells are washed, prior to measuring a tissue activity (e.g., a biomechanical and/or electrophysiological activity) as described herein. Any alteration to an activity determined using the bioengineered tissue in the presence of the test agent (as compared to the same activity using the device in the absence of the test compound) is an indication that the test compound may be useful for treating or preventing a tissue disease, e.g., a neuromuscular disease.

Additional contemplated uses of the polymeric fibers of the invention are disclosed in, for example, PCT Publication Nos.: WO 2008/045506, WO 2003/099230, and WO 2004/032713, the entire contents of which are incorporated herein by reference.

This invention is further illustrated by the following examples which should not be construed as limiting. The contents of all references, patents and published patent applications cited throughout this application, as well as the Figures, are hereby incorporated herein in their entirety by reference.

### EXAMPLES

### Materials and Methods

The following materials and methods were used in the Examples below.

### Polymers and Solvents

A variety of synthetic and naturally occurring polymers including polyethylene oxide (PEO, Mv=1,000 kD Sigma-Aldrich, Milwaukee, Wis.), gelatin type A from Sigma, poly(lactic acid) (PLA polymer 2002D, NatureWorks®, Minnetonka, Minn.) with a melt index of 4-8 g/10 min (ASTM D1238) and poly(acrylic acid) (PAA, Mv=450 kD, Sigma-Aldrich) were used. Chloroform (99.9% HPLC grade), hydrochloric acid, sodium hydroxide, and acetic acid (glacial) were purchased from Sigma-Aldrich (Milwaukee, Wis.) and dimethylformamide (98.5%) was purchased from VWR (San Dimas, Calif.). Fluorescent Microspheres (FluoSpheres®, 2% solid suspension, 0.2 μm diameter) was purchased from Molecular Probes, Inc. (Eugene, Oreg.). All reagents were used as received without further purification.

### Fabrication

A. Solution Preparation:

PEO was dissolved at a concentration of 5 wt % in deionized (18 Ω/cm) water (Millipore, Billerica, Mass.) at room temperature. Gelatin powder was dissolved at a concentration of 14 wt % in 20 v/v % acetic acid at 30° C. PAA at a concentration of 8 wt % was dissolved in deionized water at room temperature and then neutralized with sodium hydroxide to reach both half and full neutralized states. PLA was dissolved in chloroform at varied concentration of 4-10 wt % at room temperature. To prepare polymer emulsions, gelatin solution was added slowly to 8 wt % PLA in chloroform in the ratio of 1:50 (vol.) and vortexed for 5 min prior to RJS. For microsphere encapsulated samples, 10 μL of microsphere suspension was added under dark conditions to PEO solution and vortexed for 10 min. prior to RJS. The concentration of beads was 5-6×10⁶ per ml of polymer solution. For tissue engineering studies, PLA was dissolved at concentrations of 8 wt % in chloroform:dimethylformamide (80:20) before fiber fabrication.

B. Fiber Fabrication:

The exemplary rotary jet-spinning process (RJS) system consisted of a polypropylene reservoir with a diameter of 12.5 mm and height of 25.4 mm (FIG. 23A). The reservoir had two sidewall orifices with diameter (D) of 340 μm and L:D ratio of 9, where L is the orifice length depicted in FIG. 24B. The perforated reservoir was attached to the shaft of a brushless motor (model BND23 from Peromatic GmbH, Switzerland) and rotation speed was controlled by a circuit board. The circuit is equipped with a manual rotation speed control to change the rotation of the motor before or during RJS. The polymer solution was continuously fed to the reservoir via polyethylene tube connected to a 50 ml syringe placed in the cradle of syringe pump (KD Scientific, Holliston, Mass.). Rotation started immediately after filling the reservoir. The resulting fibers were collected on a stationary round collection device. Collected fibers were removed and weighed after certain period of time to evaluate production rate. The production rate was 5-6 grams/hour which is ˜10 times higher than the production rate of standard electrospinning. To study effect of orifice geometry on fiber geometry, another orifice with diameter of 650 μm and L:D ratio of 5 was built.

C. Preparation of Fibrous Scaffold for Cell Culture:

Fibrous scaffolds from PLA and gelatin were prepared as described above and were affixed to 25 mm glass coverslips using polydimethylsiloxane adhesive at the edges. After sample mounting, gelatin polymeric fibers were cross-linked by exposing to vapor of 4 ml gluteraldehyde in a 9 cm×10 cm×12 cm sealed container for 12 hours. Following cross-linking, samples were allowed to dry overnight to vaporize any remnant gluteraldehyde, and rinsed with 1×PBS. Samples were then sterilized by soaking in ethanol with exposure to a germicidal lamp in a laminar flow hood for 8 hours. After sterilization, PLA fibers were incubated in 50 μg/ml fibronectin solution for 24 hours and rinsed with 1×PBS before cell culturing.

D. Cell Culture:

Neonatal rat left ventricular cardiomyocytes were isolated from 2-day old neonatal Sprague-Dawley rats as previously reported (Feinberg, A. W., et al. (2007) Science 317(5843):1366-1370). All procedures were approved by the Harvard Animal Care and Use Committee. Reagents were obtained from Sigma unless otherwise indicated. Ventricles were surgically isolated and homogenized by washing in Hanks balanced salt solution followed by digestion with trypsin and collagenase with agitation overnight at 4° C. Subsequently, cells were re-suspended in M199 culture medium supplemented with 10% (v/v) heat-inactivated fetal bovine serum (FBS), 10 mM HEPES, 3.5 g/L glucose, 2 mM L-glutamine, 2 mg/L vitamin B-12, and 50 U/mL penicillin and seeded onto the polymeric fiber scaffolds at a density of 350,000 cells/mL. Samples were incubated under standard conditions at 37° C. and 5% CO₂. After an additional 48 hours the media was exchanged with maintenance media (M199 media supplemented as above but with 2% FBS) to minimize growth of fibroblasts inevitably present in the primary harvest cardiomyocyte population.

### Sample Characterization

A. Viscosity Measurements:

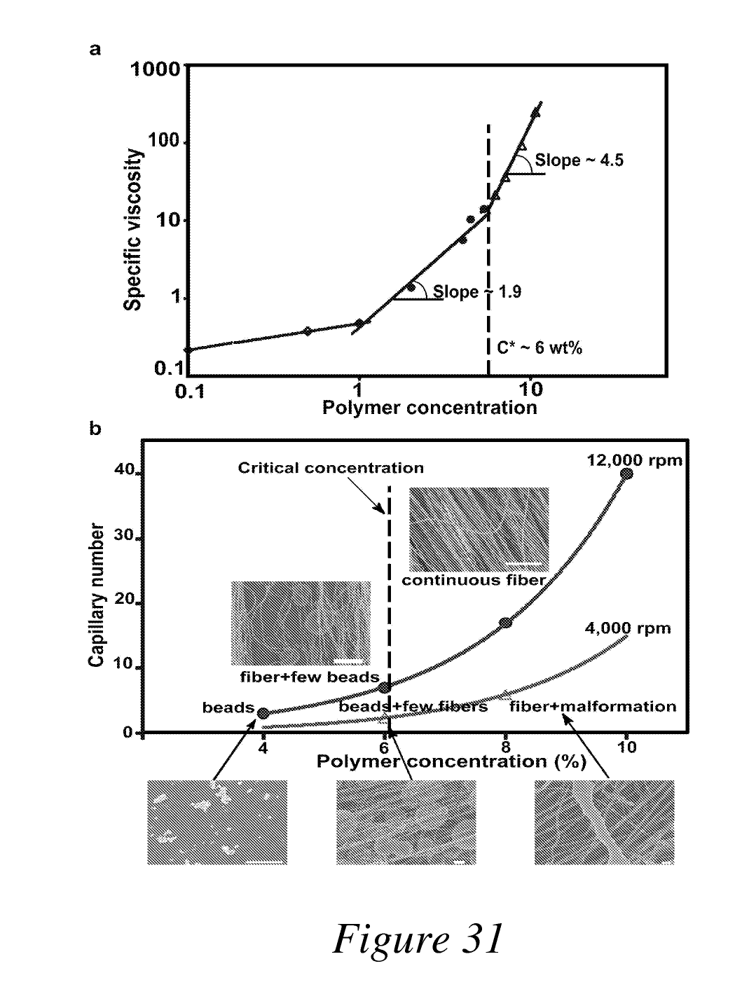

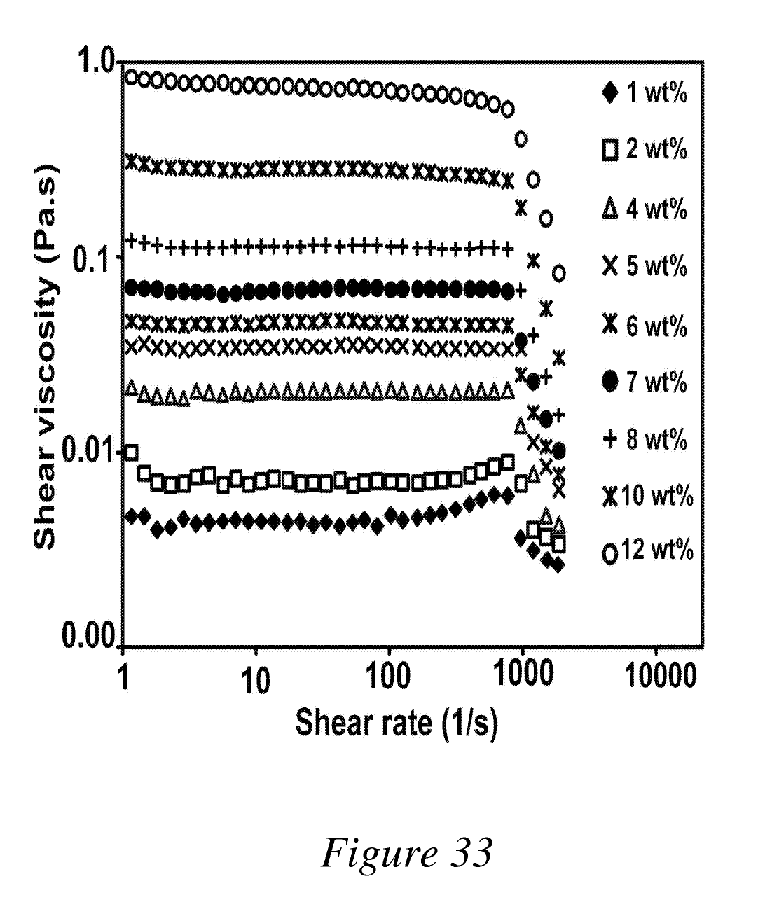

Rheological measurements were made on freshly prepared PLA solutions for determining the concentration regimes. PLA solutions ranging from 0.1 to 12 wt % were loaded into the viscometer (Model AR-G2, TA instruments, New Castle, Del.) fitted with a cone and plate spindle (model 987864, 40 mm cone diameter, 3°, 59′, 56″ cone angle and 109 μm gap) and viscosities were measured under steady state shear rate from 0.1-3,000 s⁻¹. All PLA solutions showed Newtonian behavior over low range of shear rates; however, it should be noted that shear thinning occurred at higher shear rates. The zero-shear viscosity (η₀) was determined over the Newtonian region. FIG. 33, shows the flow behavior of PLA solutions ranging from 0.1 to 12 wt % at variable shear rates. The critical polymer concentration was calculated based on the zero-shear viscosities over the Newtonian region. The polymer contribution to the η₀ was studied by defining the specific viscosity (ηₛₚ) in:

$$Specific viscosity ( {η}_{sp} ) = \frac{{η}_{0} - {η}_{s}}{{η}_{s}} \qquad ( S1 )$$

where ηₛ is solvent viscosity. The ηₛₚ is plotted as a function of concentration in FIG. 31A for the PLA solutions. Changes in the slope marked the onset of the semidilute unentangled, semidilute entangled and concentrated regimes (Wang, C., et al. (2009) Polymer 50(25):6100-6110). The concentrated regime (c*) was found to be 6 wt %.

B. Surface Tension Measurement:

The surface tension of the polymer solution was measured based on Du Nouy ring method with Sigma700 Tensiometer (KSV instruments) (Grant, J., et al. (2008) Biomacromolecules 9(8):2146-2152).

C. Scanning Electron Microscopy:

Fiber samples removed from the collection device and mounted on sample stubs and coated with Pt/Pd using a sputter coater (Denton Vacuum, Moorestown, N.J.) to minimize charging during imaging. The samples were imaged using Zeiss Ultra field-emission scanning electron microscope (Carl Zeiss, Dresden, Germany). Images were acquired and analyzed using image analysis software (Image J, National Institutes of Health, US). A total of 100-300 fibers were analyzed (5 random fields of view per sample) to determine the fiber diameter. The fiber diameter distribution were reported as first, second and third quartile as 25^{th}, 50^{th} and 75^{th} percentile. To observe cardiac cell morphology on fibrous scaffolds by SEM, after 4 days culturing the samples were fixed with 2% of glutaraldehyde/paraformaldehyde for 4 hours and dehydrated with a graded concentration (30-100%) ethanol. Then the samples were dried with a critical point dryer and sputter coated with Pt/Pd for 90 s before imaging.

D. Immunostaining:

Cardiomyocytes were fixed 4 days after seeding. Media was removed, cells were rinsed in 37° C. PBS, then immediately fixed in a 4% solution of paraformaldehyde with 0.01% Triton X-100 in phosphate-buffered saline at 37° C. During the 15 minute fixation period, cells were equilibrated at room temperature. After fixation, myocytes were rinsed in room temperature PBS and stained. Myocytes were stained by inverting the coverslip on a solution of PBS containing 4′,6′-diamidino-2-phenylindole hydrochloride (DAPI, 30 nM) (Invitrogen, Eugene, Oreg.). The first stain also contained a 1:100 dilution of anti-sarcomeric α-actinin monoclonal antibody (clone EA-53, Sigma, St. Louis, Mo.) and was incubated for 1 h at RT. Before the secondary stain, coverslips were rinsed in PBS. Secondary stains contained a 1:200 dilution of alexa-fluor 488 goat anti-mouse IgG (H+L) antibody (Invitrogen, Eugene, Oreg.). After incubation, coverslips were rinsed and mounted on glass coverslides until imaged.

E. Confocal Microscopy:

Dispersion of fluorescent beads into the fibers was imaged with Zeiss LSM 5 LIVE Confocal Microscopy (Carl Zeiss, Dresden, Germany). Images were acquired under 40×/1.3 Oil DIC objective lens with 488 nm wavelength emission. Images of cardiomyocytes on PLA and gelatin fibers were acquired under 40×/1.3 Oil DIC objective lenses with 405 nm and 488 nm wavelength emissions. Images were analyzed and displayed using ImageJ (NIH, Bethesda, Md.).

F. Jet Break-Up Analysis:

To elucidate the mechanism of jet break-up and bead formation, the capillary number (Ca) was calculated for all samples based on definition of ratio of Weber number (We) to Reynolds number (Re). For calculating these two dimensionless numbers, jet exit velocity was estimated first in the rotating frame by measuring the difference in liquid height, Δh, and using the following formula:

V=Δh·(D/2)²/R²·t (S2)

where R is radius of reservoir, D is diameter of the orifice, and t is the duration of experiments. Thereby, the jet exit velocity, U, based on the stationary frame was calculated as:

U=\sqrt{V²+R²ω²} (S3)

where ω is the rotation speed in rad·s⁻¹.

### Example 1

### Rotary Spinning System: A Novel 3D Polymeric Fiber Assembly Fabrication

In order to produce polymeric fibers, e.g., nano-scale fibers, a high speed rotating nozzle was exploited to form a polymer jet which undergoes extensive stretching before solidification (FIG. 24A). Termed rotary jet-spinning (RJS), the RJS system consisted of a reservoir with two side wall orifices that was attached to the shaft of a motor with controllable rotation speed. To facilitate the fiber collection a flexible air foil is placed on the shaft above the reservoir. The polymer solution was continuously fed to the reservoir at a rate sufficient to maintain a constant hydrostatic pressure and continuous flow. The resulting fibers were collected either on a stationary, surrounding cylindrical collection device or on coverslips which were held against the collection device wall. The fiber production process is composed of (i) jet-initiation to induce flow of the polymer solution through the orifice, (ii) jet-extension to increase surface area of the propelled polymer stream, and (iii) solvent evaporation to solidify and shrink the polymer jet. During the first step (FIG. 24B-i), a combination of hydrostatic pressure and centrifugal pressure at the far end of capillary (Ducree, J., et al. (2007) Journal of Micromechanics and Microengineering 17(7):S103-S115) exceeds the flow-resistant capillary forces and propels the polymer liquid through the nozzle capillary as a jet. The outward radial centrifugal force stretches the polymer jet as it is projected towards the collection device wall (FIG. 24B-ii), but the jet travels in a curled trajectory due to rotation-dependent inertia. Stretching of the extruded polymer jet is critical in reducing jet diameter over the distance from the nozzle to the collection device. Concurrently, the solvent in the polymer solution evaporates, solidifying and contracting the jet (FIG. 24B-iii). The solvent evaporation rate depends on its volatility. If the solvent is highly volatile, the jets form thicker fibers as the rapidly evaporating solvent potentiates rapid solidification, hindering the jet extension. The primary challenges in this process are optimizing the polymer solution properties (viscoelasticity and surface tension), solvent volatility, capillary diameter, and collection device radius to not only produce ultra fine fibers but also prevent jet rupture and the formation of droplets due to Plateau-Rayleigh instability (Oliveira, M. S. N., et al. (2006) Journal of Non-Newtonian Fluid Mechanics 137(1-3):137-148). The jet break-up may be estimated by the capillary number, defined as the ratio of Weber number (We) to Reynolds number (Re), Ca=We/Re, which characterizes the ratio of the viscous force to the surface tension force (Oliveira, M. S. N., et al. (2006) Journal of Non-Newtonian Fluid Mechanics 137(1-3):137-148). Here We=ρU²D/γ and Re=ρUD/η where ρ, η and γ are density, dynamic viscosity and surface tension of polymer solution, respectively, U is the polymer jet exit speed based on a stationary frame (see Supporting Information for measurement of jet speed) and D is the orifice diameter. A lower capillary number results in shorter jet length and earlier jet break-up to isolated droplets (Oliveira, M. S. N., et al. (2006) Journal of Non-Newtonian Fluid Mechanics 137(1-3):137-148).

### Example 2

### Fabrication of Polymeric Fibers Using a Rotary Spinning System

Using a rotary spinning system described herein, 3-dimensional micron, submicron and nano-scale structures from a variety of synthetic and naturally occurring polymers. Polymeric fibers were produced from poly(lactic acid) (PLA) in chloroform (FIGS. 24C-24E), poly(ethylene oxide) in water (FIG. 24F), poly(acrylic acid) in water at different conductivities (neutralized with sodium hydroxide) (FIGS. 24G and 24H), gelatin in mild acetic acid (FIG. 24I), an emulsion of gelatin in PLA (FIG. 24J) and PEO doped with fluorescent spherical beads (FIG. 24K).

The successful production of polymeric fibers using a variety of synthetic and naturally occurring polymers, demonstrates that the devices methods described herein provide a rapid and facile technique of polymeric fiber, e.g., polymeric fiber fabrication without electrical propulsion which is capable of fabricating 3D aligned polymeric fibers, e.g., nanofiber, structures from a variety of polymers.

### Example 3

### Fabrication of Polymeric Fibers Using a Rotary Spinning System

Using a rotary spinning system described herein, 3-dimensional micron, submicron and nano-scale structures of biodegradable polylactic acid (PLA) polymer and hydrophilic polyethylene oxide (PEO) polymer were fabricated.

PLA was dissolved in either chloroform or dichloromethane and PEO was dissolved in either water, or a water/ethanol mixture. Various concentrations of solutions of the aforementioned polymers were prepared by mixing different weights of dry polymer in the corresponding solvents and then fed through a material feeding tube made of polyethylene into a rotating reservoir including two sidewall orifices. The resulting fibers were collected on the stationary collection device. The spatial and hierarchical structure of the produced fibers was changed by altering rotation speed, polymer solution concentration, viscosity of polymer solution, polymer molecular weight, volatility of solvent, geometry of collection device and reservoir. Table 1 describes the production variables and the features of the polymeric fibers fabricated under the various production variables. As described in more detail below, continuous aligned PLA fibers with diameters ranging from 50-3500 nm were produced and by increasing the rotation speed from 4,000 to 12,000 rpm, the fiber diameter (median±median standard error) dropped from 1143±50 to 424±41 nm.

TABLE 1
Composition and parameter values of all PLA solutions ^{a}

| | | | | | | | | | | Fiber Diameter | | |
|---|---|---|---|---|---|---|---|---|---|---|---|---|
| Conc | Rotation | η₀ | γ | ρ | U | | | | Fiber | Parameters (nm) | | |
| wt % | Rpm | mPa · s | mN · m⁻¹ | g · cm⁻³ | cm/s | We | Re | Ca | feature | Q1 | Q2 | Q3 |
| 10 | 12,000 | 282 | 27 | 1.54 | 398 | 150 | 3.8 | 40 | Continuous | 833 | 1630 | 216 |
| | | | | | | | | | Fiber | | | |
| | 4,000 | | | | 133 | 18 | 3.1 | 6 | Continuous | 782 | 1143 | 174 |
| | | | | | | | | | Fiber | | | |
| | 8,000 | | | | 266 | 68 | 6.1 | 11 | Continuous | 369 | 468 | 679 |
| | | | | | | | | | Fiber | | | |
| | 12,000 | | | | 399 | 153 | 9.2 | 17 | Continuous | 285 | 424 | 742 |
| | | | | | | | | | Fiber | | | |
| | 4,000 | | | | 133 | 17 | 7.5 | 2.4 | Fiber + | 255 | 571 | 825 |
| | | | | | | | | | Many beads | | | |
| | 12,000 | | | | 399 | 158 | 23 | 7 | Fiber + | 421 | 566 | 795 |
| | | | | | | | | | Few beads | | | |
| 4 | 12,000 | 21 | 26 | 1.50 | 400 | 158 | 51 | 3 | Only Beads | N/A | N/A | N/A |
| 8* | 12,000 | 113 | 27 | 1.52 | 399 | 285 | 17 | 17 | Continuous | 612 | 962 | 129 |
| | | | | | | | | | Fiber | | | |

^{a} Q1, Q2 and Q3 are first, second and third quartile of fiber diameter distribution which represent 25^{th}, 50^{th} and 75^{th} percentile, respectively. η₀, γ and ρ are shear viscosity, surface tension and density of the solution, U is the jet speed, We, Re and Ca are Weber number, Reynolds number and capillary number, respectively. Orifice geometry for all samples was D = 340 μm, L: D = 9 except for the (*) was D = 650 μm, L: D = 4.5. Fiber diameters can be tailored with the orifice diameters (see Supporting Information for more detail on orifice geometry). These data suggest that by decreasing the length to diameter ratio of the orifice, the pressure drop at the orifice decreases and the rate of solution outflow increases, resulting in larger diameter fibers.

A. The Effect of Polymer Concentration on the Fabrication of 3D Polymeric Fibers

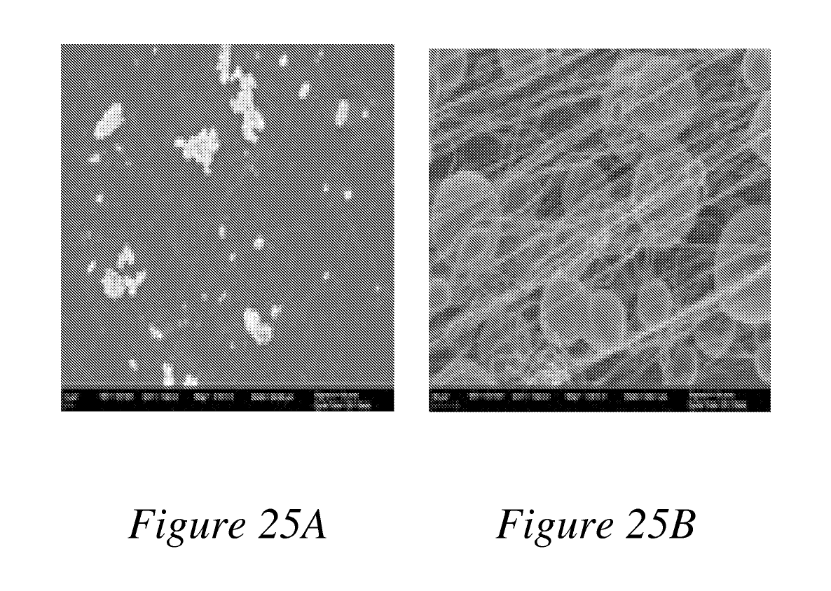

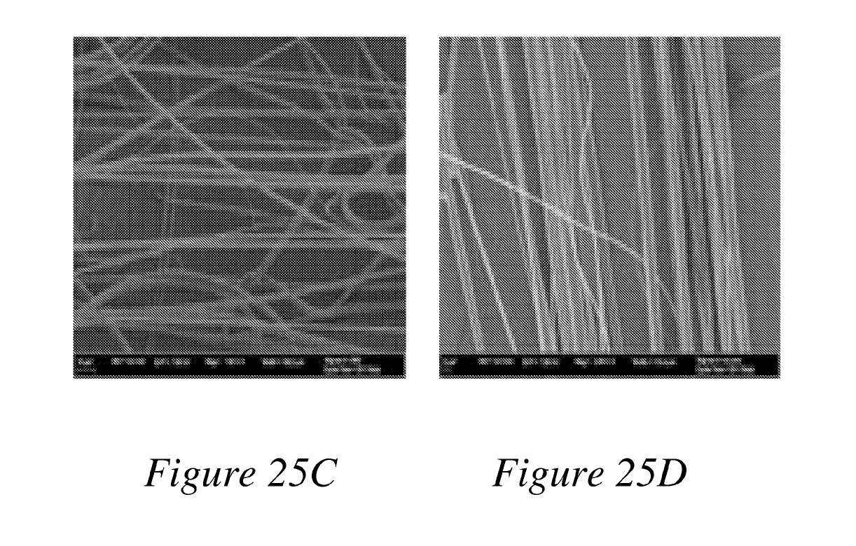

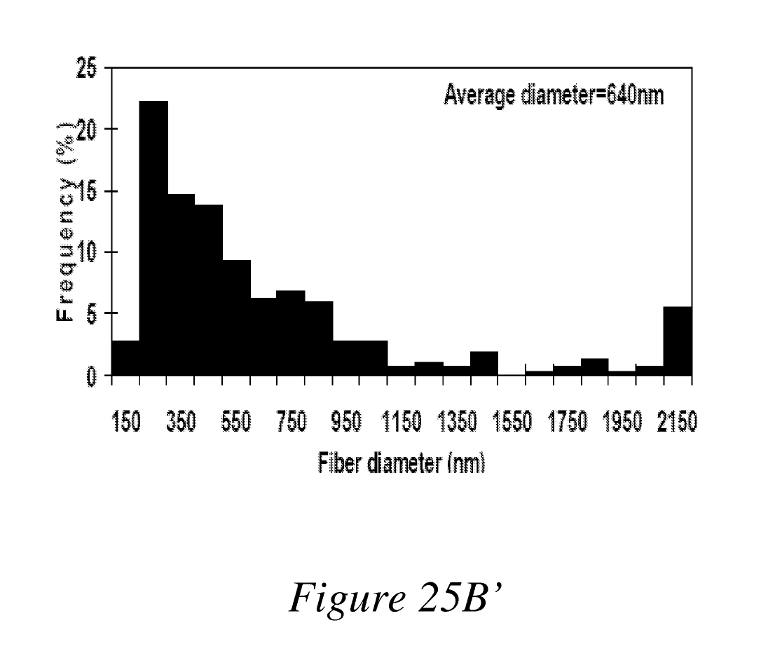

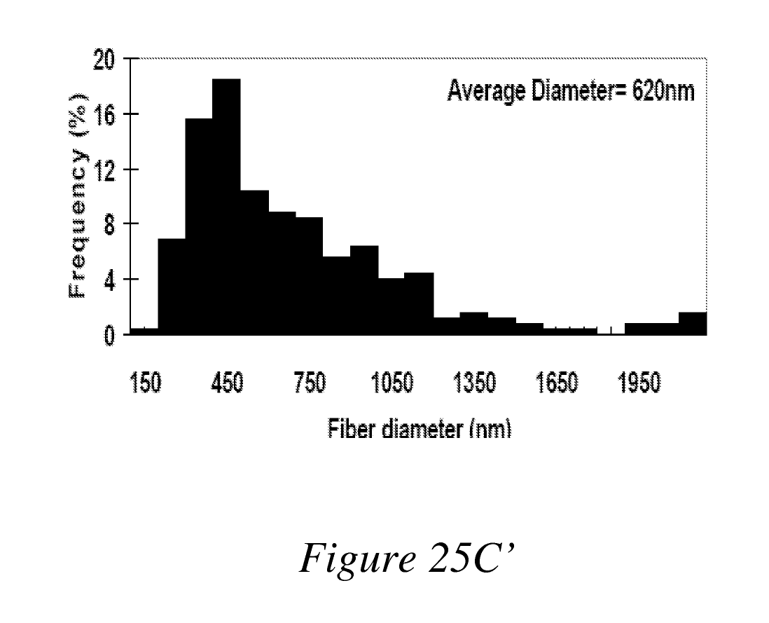

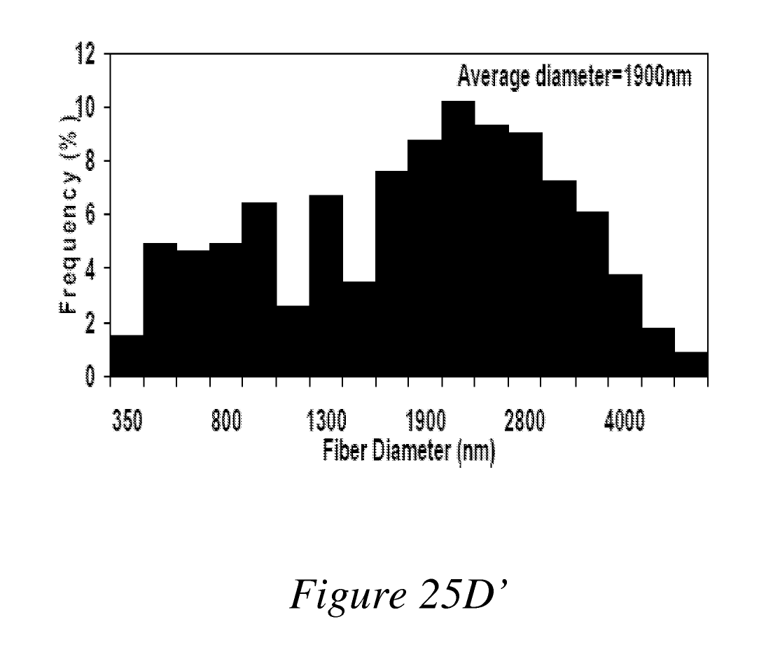

Using a 4% weight solution of polylactic acid (PLA) in chloroform at 10,000 rpm rotation speed, beads are formed due to insufficient polymer entanglement and Rayleigh instability driven by surface tension forces (FIG. 25A). Use of a 6% weight solution of polylactic acid (PLA) in chloroform at 10,000 rpm rotation speed resulted in the formation of beads-on-string due to insufficient polymer entanglement and Rayleigh instability driven by surface tension forces (FIG. 25B). FIG. 25B′ shows the size distribution of the average diameter of the fibers formed in using a 6% weight solution of polylactic acid (PLA) in chloroform at 10,000 rpm rotation speed. Use of an 8% weight solution of polylactic acid (PLA) in chloroform at 10,000 rpm rotation speed resulted in the formation of continuous fibers (FIG. 25C). FIG. 25C′ shows the size distribution of the average diameter of the fibers formed using a 6% weight solution of polylactic acid (PLA) in chloroform at 10,000 rpm rotation speed. Using a 10% weight solution of polylactic acid (PLA) in chloroform at 10,000 rpm rotation speed continuous fibers with a bimodal distribution of diameters are formed (FIG. 25D). FIG. 25D′ shows the size distribution of the average diameter of the fibers formed using a 10% weight solution of polylactic acid (PLA) in chloroform at 10,000 rpm rotation speed.

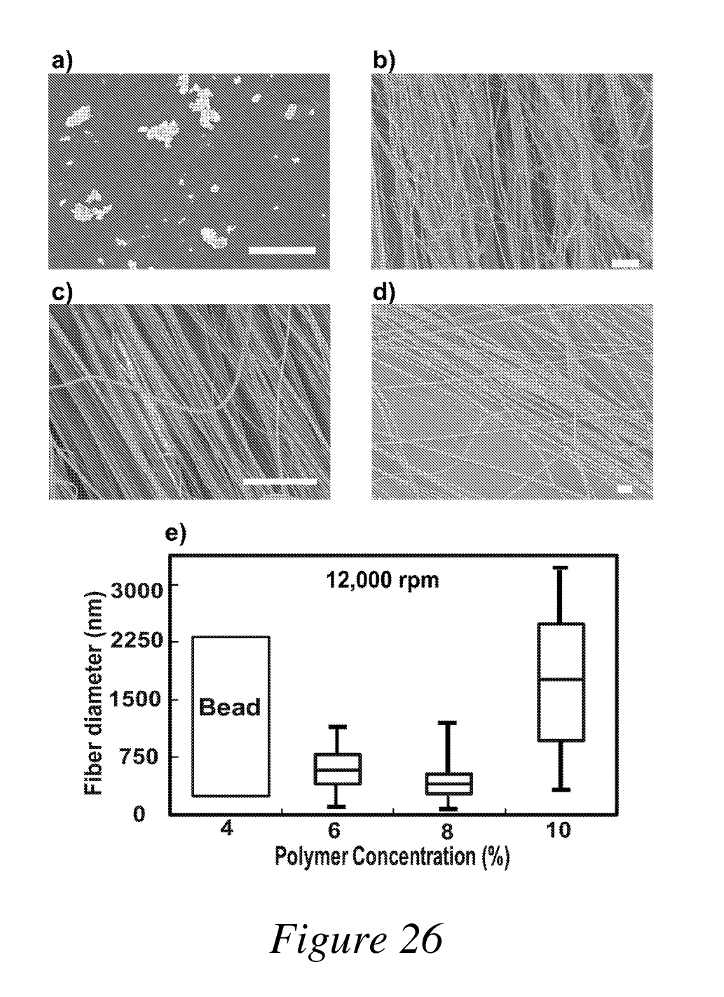

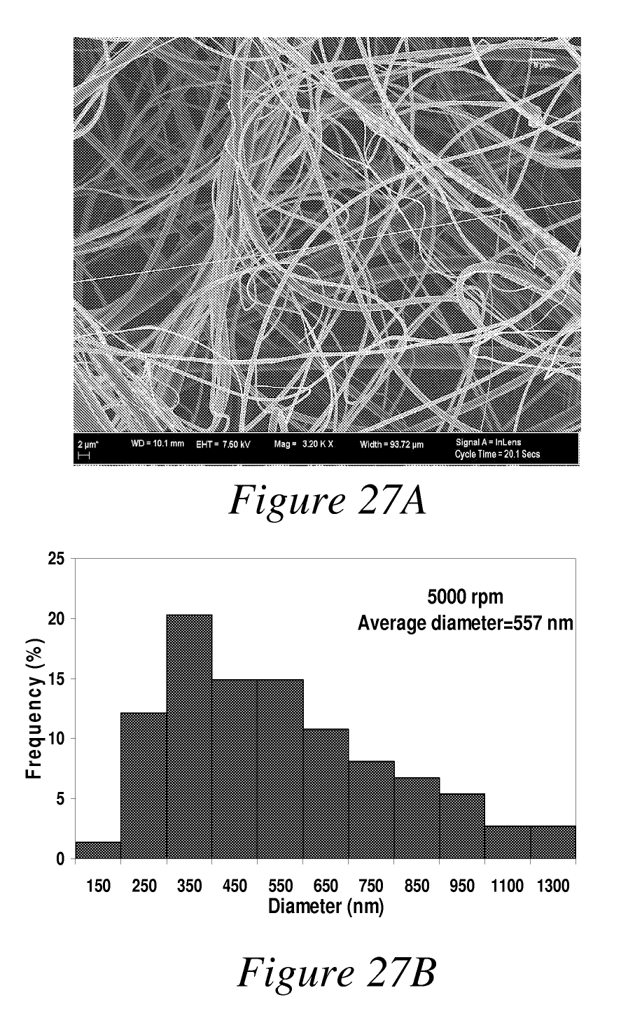

The effect of polymer concentration on the formation of polymeric fibers was also determined at 12,000 rpm rotation speed using polymer solutions of PLA in chloroform at 4%, 6%, 8% and 10% weight/volume in a rotary spinning system as described herein having two opposing sidewall orifices having a diameter of 100 micrometers. As depicted in the scanning electron micrographs shown in FIG. 26, a 4% solution of PLA resulted in the fabrication of beads; both 6% and 8% solutions of PLA resulted in the fabrication of continuous fibers, with the fibers fabricated using an 8% solution of PLA having a smaller diameter than the fibers fabricated using the 6% PLA solution; and a 10% PLA solution resulted in the fabrication of continuous fibers having a bimodal distribution of diameters.

Accordingly, at low polymer concentration only beads or beads-on-string structure were formed, but by increasing polymer concentration to higher than 6% w/v, continuous fibers with less or no beads were formed.

B. The Effect of Rotation Speed on the Average Diameter, Diameter Distribution and Fiber Alignment on 3D Polymeric Fibers

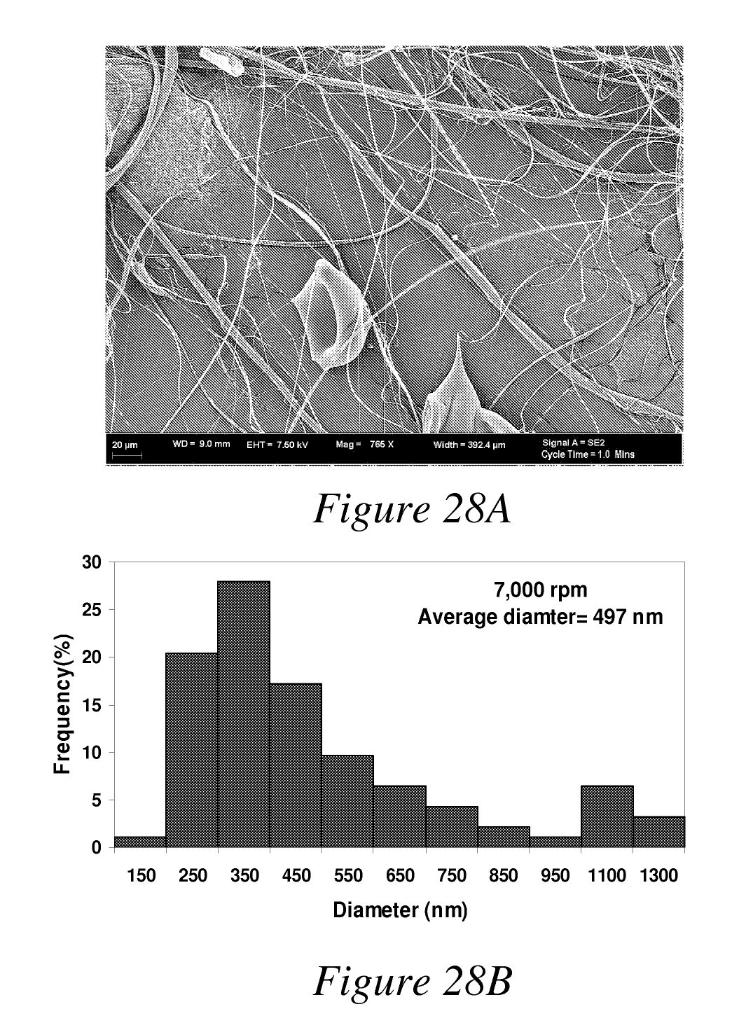

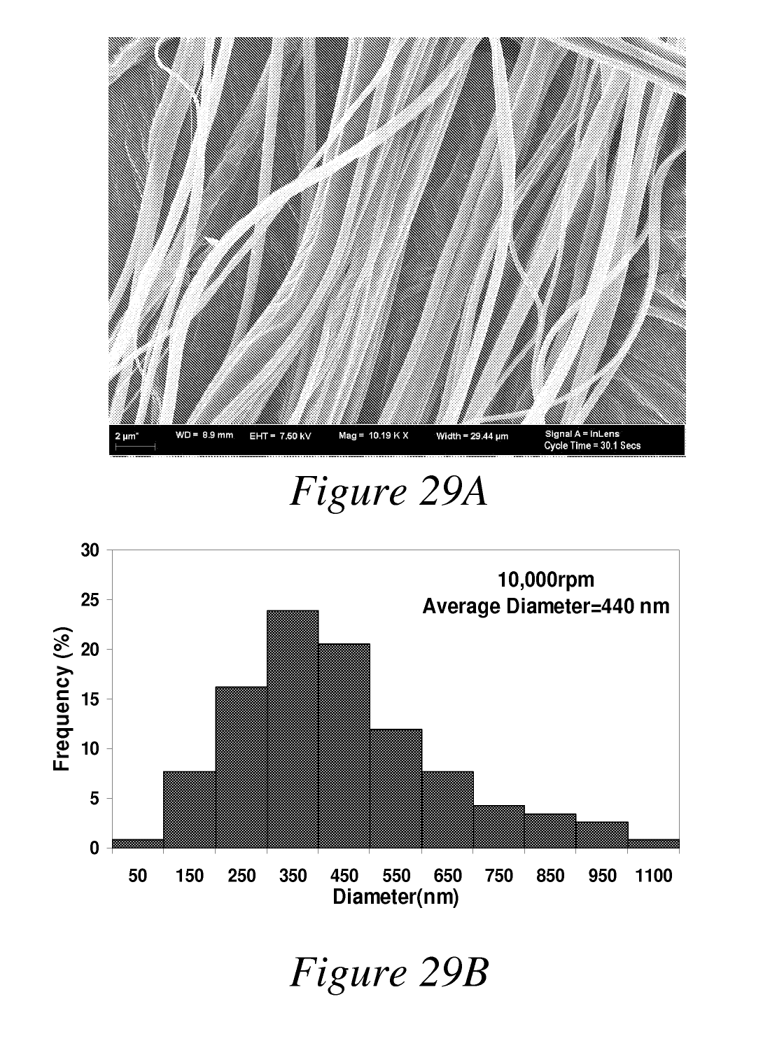

The effect of rotation speed was also determined using an 8% PLA in chloroform polymer solution. At 5,000 rpm rotation speed tangled continuous fibers with an average diameter of 557 nanometers were fabricated (FIGS. 27A and 27B). At 7,000 rpm rotation beads-on-string with an average diameter of 497 nanometers were fabricated (FIGS. 28A and 28B). At 10,000 rpm rotation continuous fibers with an average diameter of 440 nanometers were fabricated (FIGS. 29A and 29B).

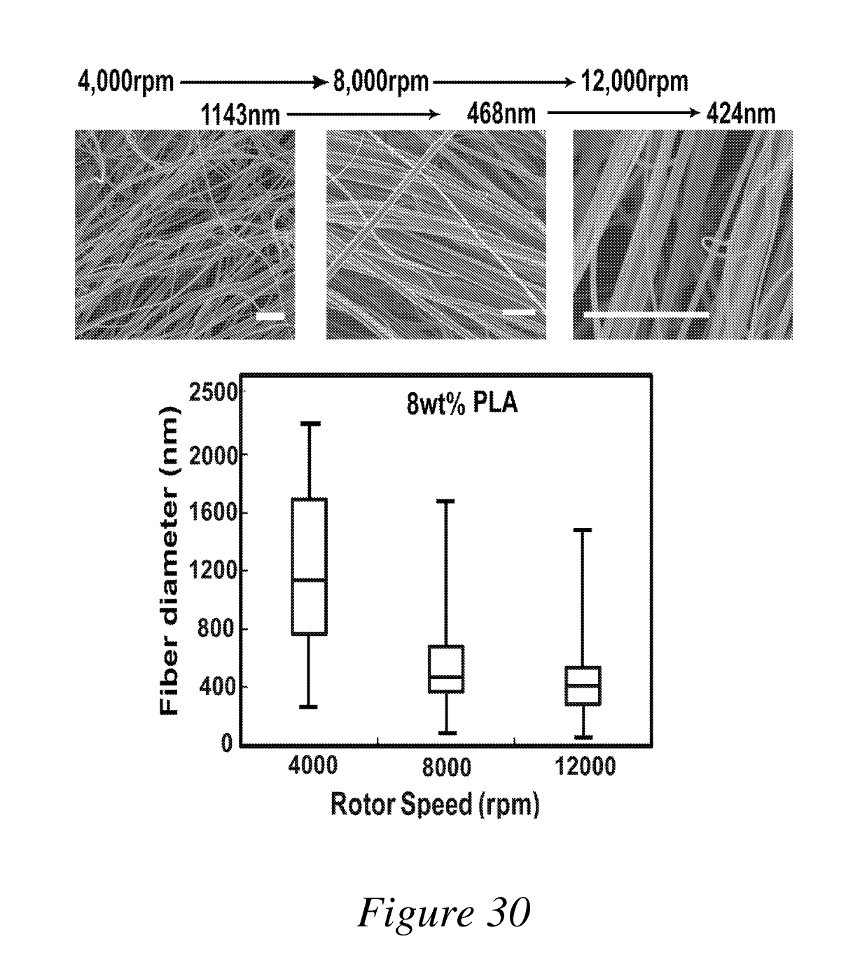

FIG. 30 also depicts the effect of rotation speed on the fabrication of polymeric fibers using an 8% weight/volume solution of PLA in chloroform at 4,000, 8,000, and 12,000 rpm in a rotary spinning system as described herein having two opposing sidewall orifices having a diameter of 100 micrometers. The scanning electron micrographs show that at 4,000 rpm tangled, continuous fibers are produced having an average diameter of 1143 nanometers; at 8,000 rpm, continuous fibers are produced having an average diameter of 468 nanometer; and at 12,000 rpm, continuous fibers are produced having an average diameter of 424 nanometers. The graph in FIG. 30 shows the distribution of fiber diameters formed at various rotation speeds.

Accordingly, by increasing rotor speed average, the diameter of produced fibers can be decreased. In addition, alignment of fibers increased dramatically with increasing rotation speeds.

Without wishing to be bound by theory, the mechanism of RJS fiber formation is the optimization of the competing centrifugal forces and jet surface tension. The surface tension causes jet instability and bead formation (Lord, R. (1878) Proceedings of the London Mathematical Society s1-10(1):4-13) while the centrifugal force accelerates a slender liquid stream where solvent evaporation and polymer chain elongation occur simultaneously. Thus, higher centrifugal force induces greater extension and thinning of the polymer jet which results in thinner fiber diameters. To test this hypothesis, the rotation speed was varied while maintaining a constant PLA solution concentration. The centrifugal force per solution volume increases significantly with rotation speed, while the surface tension remains the same (Table 1). The fiber diameter distribution (FIG. 30) is much wider at lower rotation speed and the probability of bead formation is higher. Next, the rotation speed was held constant while varying the polymer concentration in the solvent. Without wishing to be bound by theory, the surface tension of the polymer solution and its tendency to induce beading could be compensated for by varying the polymer concentration. When the rotation speed was held constant, at low polymer concentrations (4 wt %) RJS resulted in polymer beads. As the polymer concentration (c) (4 wt %<c<10 wt %) was increased, the increased polymer chain entanglement stabilized the jet resulting in fiber formation. This data demonstrates that fiber formation is a function of the polymer concentration where an optimal range of concentrations increases the likelihood of polymer chain entanglement (Shenoy, S. L., et al. (2005) Polymer 46(10):3372-3384), resisting beading and resulting in fine fibers. Beyond this optimal range (10 wt % and higher), the higher solution viscosity limits solvent evaporation and necking, resulting in thicker fibers.

An additional contributor to fiber formation is polymer chain entanglement density. As the polymer concentration increases, a deformable entangled network of polymer chains forms as a direct consequence of chain overlap. In low concentration (c) polymer solutions, lower than critical concentration value, c*, (c<<c*) chain overlapping is absent. As the polymer concentration is increased (c→c*), chain entanglement is still insufficient for formation of bead-free fibers (Shenoy, S. L., et al. (2005) Polymer 46(10):3372-3384; Wang, C., et al. (2009) Polymer 50(25):6100-6110). At solution concentrations above the critical concentration (c>c*), sufficient chain entanglement produces uniform continuous fibers without beads. The specific viscosity of polymer solutions as a function of concentration was measured. As depicted in FIG. 31A, changes in the slope marked the onset of the semidilute unentangled, entangled and concentrated regimes, the latter (c*) occurring at 6 wt % polymer solution concentration.

In order to determine how the capillary number (Ca) and polymer solution concentrations affect the quality of fiber production, bead-free fibers were used to define the highest production quality. The Ca number represents the magnitude of the centrifugally-induced shearing forces relative to the surface tension (Eggers, J. (1997) Reviews of Modern Physics 69(3):865-929. An increased likelihood of continuous fibers at high Ca numbers was observed (FIG. 31B). As expected, for c<c*, RJS produced only beads, however, for c>c*, chain entanglement was sufficient to potentiate fiber formation. At lower rotation speeds and Ca, fiber malformations were occasionally present (FIG. 31B), however, with higher Ca and rotation speeds, higher quality fiber production was achievable. These data demonstrate that by increasing the rotation speed, the polymer jet travels faster and stretches rapidly, enhancing solvent evaporation. Rapid solvent evaporation increases polymer concentration and solution viscosity, the latter due to chain entanglement. This stabilizes the jet and resists surface tension-induced bead formation.

### Example 4

### Fabrication of Tissue Engineered Scaffold Using Polymeric Fibers Fabricated Using a Rotary Spinning System

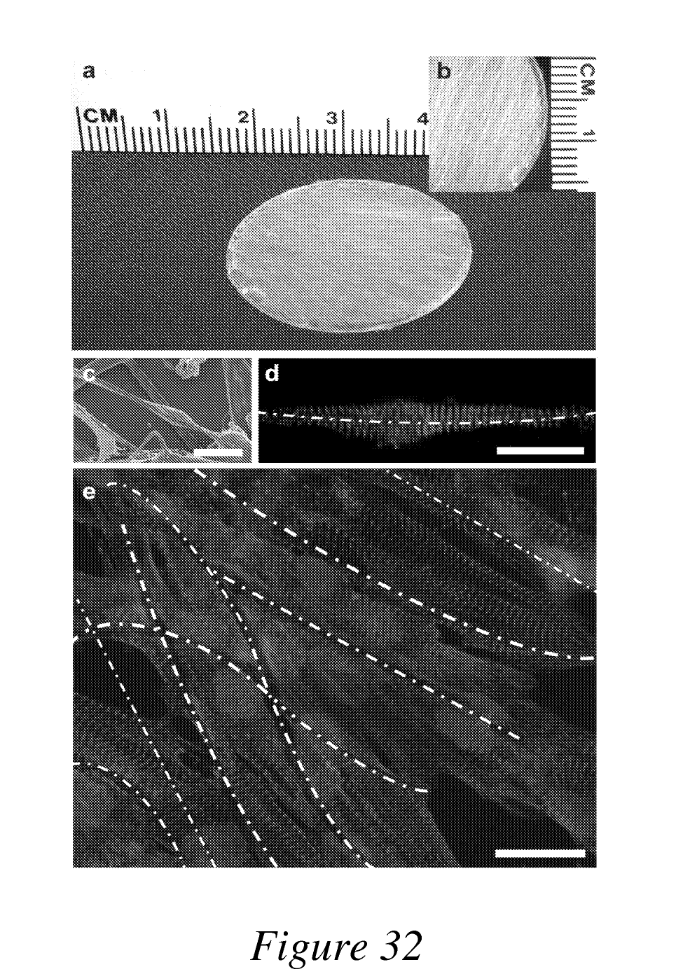

To test the ability of a rotary spinning system described herein to produce tissue engineering scaffolds, anisotropic, fibrous constructs were prepared (FIG. 32A, 32B). Chemically dissociated neonatal rat ventricular myocytes were seeded on the constructs where they bound to, and spontaneously aligned with the fibers (FIG. 32C). Individual myocytes organized their contractile cytoskeleton with respect to the external cue provided by the extracellular fibers, as indicated by the alignment of the sarcomeric Z lines perpendicular to the fiber alignment (FIG. 32D). As depicted in the example in FIG. 32E, multicellular constructs self-organized with respect to the fibers, forming beating, anisotropic muscle with aligned and elongated myocytes and ordered myofibrils, as seen previously observed with other cardiac tissue engineering techniques (Feinberg, A. W., et al. (2007) Science 317(5843):1366-1370; Alford, P. W. et al. (2010) Biomaterials 31(13):3613-3621. Accordingly, use of a rotary spinning system to fabricate polymeric fibers is a simple means of forming anisotropic scaffolds of biodegradable polymeric fibers made from synthetic and natural polymers.

### Examples 5 and 6

Examples 5 and 6, below, describe the development of a mathematical model that predicts the shear stress required to fabricate insoluble nanofibers from biogenic polymers using an exemplary device of the invention employing rotational motion and comprising a rotating reservoir and an orifice. In Example 6, using the mathematical model of shear stress, rotational speed, orifice length, and orifice radius were varied and the model was used to predict the device conditions necessary to fabricate insoluble nanofibers from biogenic polymers, such as fibrous proteins. Example 6 also demonstrates that the predicted conditions indeed permit the fabrication of insoluble nanofibers from synthetic and biogenic polymers, e.g., fibrous proteins, such as fibronectin and silk fibroin.

### Example 5

### Facile Fabrication of Nanofibrous Biogenic Polymers and Products Thereof Using a Rotary Spinning System

This example describes the development of a mathematical model that predicts that insoluble nanofibers can be generated from biogenic polymers using a device as described herein employing rotational motion and comprising a rotating reservoir and an orifice. The mathematical model also demonstrates the mechanism by which insoluble nanofibers can be generated from biogenic polymers using a device as described herein employing rotational motion and comprising a rotating reservoir and an orifice. In particular, the mathematical model described below predicts that a device of the invention comprising a rotating reservoir and an orifice can be used to fabricate insoluble nanofibers from synthetic and/or naturally occurring biogenic polymers (such as proteins containing a beta sheet domain or other shear sensitive structures (e.g., beta strands or polymer backbone rearrangement, e.g., polymers that are color sensitive to shear forces) by shear-force-induced rearrangement processes. In other words, this example predicts how and demonstrates that a device comprising a rotating reservoir and an orifice may be used to facilitate fibrillogenesis of biogenic polymers in vitro.

In vivo it has been demonstrated that polymers undergo coil-stretch transition once they are exposed to a strong elongational flow and in the case of biogenic proteins, it is widely believed that shear stresses arising from fluid flow are capable of deforming or unfolding the secondary structure of protein macromolecule (Jaspe, J., Hagen, S. J., Biophysical Journal, 91, 3415-3424, 2006). Exposure of cryptic binding sites through the shear induced coil-stretched transition allow binding sites of neighboring biogenic polymer chains to come together and irreversibly bind (Ulmer, J., Geiger, B., Spatz, J. P., Soft Matter, 4, 1998-2007, 2008). These binding interactions may be hydrophilic, hydrophobic, ionic, covalent, Van der Waals, hydrogen bonding or physical entanglement depending on the specific biogenic polymer involved.

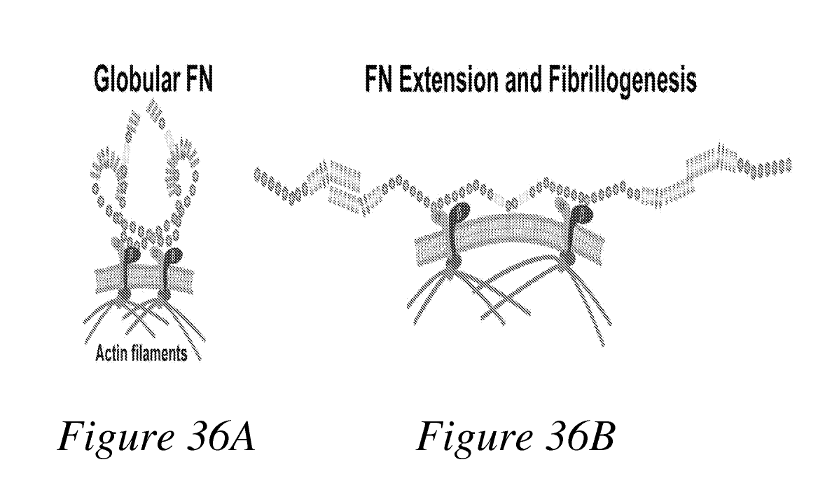

For example, the in vivo production of fibers of the extracellular matrix protein, fibronection, have been well-studied. Globular fibronectin is secreted by cells, binds to cell surface integrins, and is subsequently unfolded by cell traction forces thereby inducing fibrillogenesis (Mao, et al. (2005) Matrix Biology 24:389) (see, e.g, FIGS. 36A and 36B). FIGS. 36A and 36B schematically illustrate the process of in vivo fibrillogenesis. FIG. 36A schematically illustrates that globular fibronectin (FN) secreted by cells binds to cell surface integrins. Fibrillogenesis of FN is induced by unfolding of the protein due to, for example, cell traction forces. FIG. 36B schematically illustrates extension of the FN of FIG. 36A during the process of fibrillogenesis. In vitro, however, manufacture of nanofibers formed of biogenic polymers, e.g., fibrous proteins like FN, has remained a challenge.

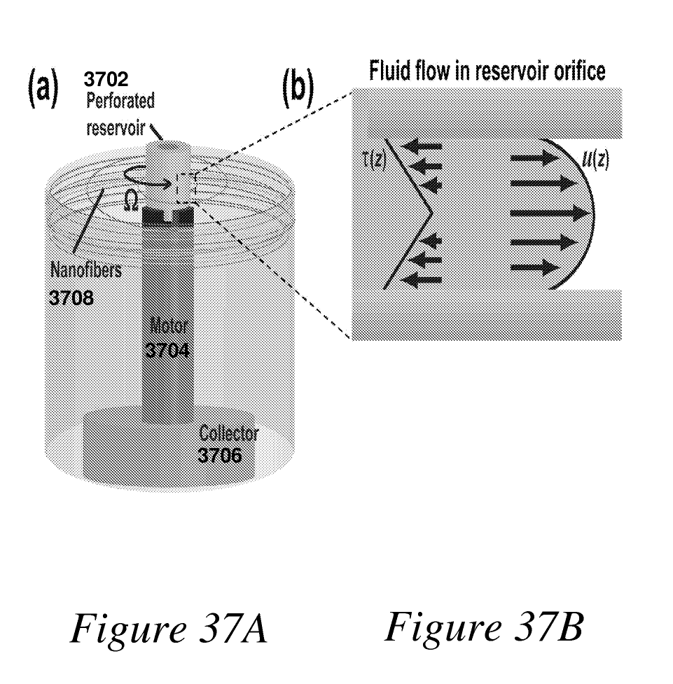

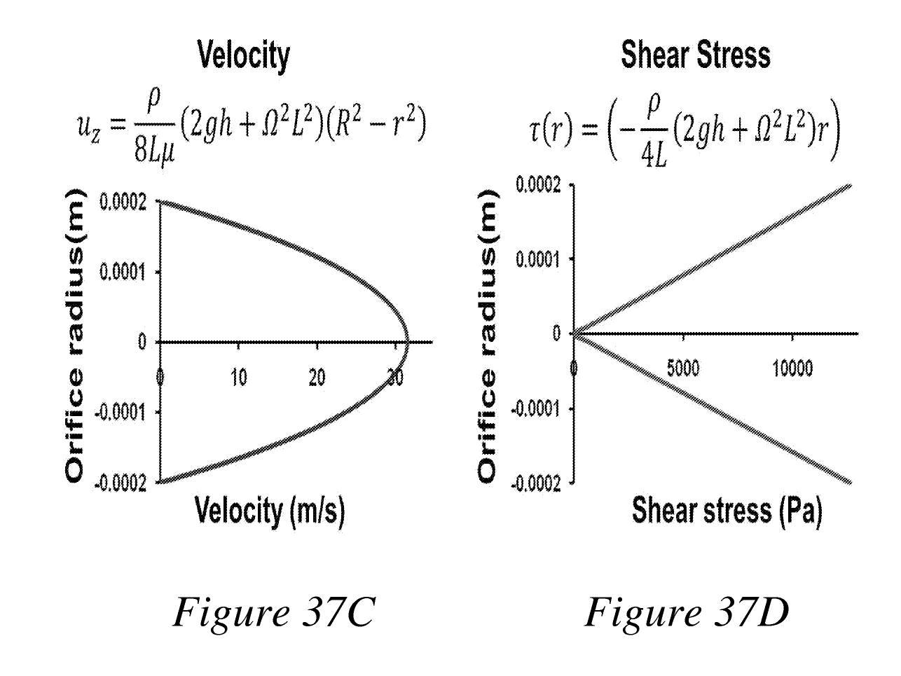

Accordingly, it was determined through theoretical research and experimentation that shear forces in a fluid flow can unfold a polymer, e.g., a biogenic polymer, such as fibronectin, to facilitate fibrillogenesis in order to produce polymer nanofibers with chemical, mechanical, and biological integrity. An exemplary experimental setup is described with reference to FIGS. 37A-37D.

FIG. 37A is a perspective view of an exemplary fiber formation device 3700 that employs rotational motion to eject a polymer material through an orifice. The device 3700 includes a rotating reservoir 3702 that includes one or more orifices for ejecting a polymer material the polymer material. The reservoir 3702 rotates at a rotational speed of Ω rpm. The reservoir 3702 is coupled to a motor 3704 and is surrounded by a collector 3706. The polymer material ejected from the reservoir 3702 forms nanofibers 3708.

FIG. 37B is a cross-sectional side view of the orifice of FIG. 37A to show fluid flow corresponding to the polymer material in the orifice due to the rotational motion. In FIG. 37B, u(z) depicts the linear velocity of the fluid flow in the orifice, and τ(z) denotes the shear forces experienced by the fluid. Referring to FIG. 37B, the flow of a polymer solution through the reservoir is described as circular Poiseuille flow (Kundu, P. K. and I. M. Cohen, Fluid Mechanics. 4th ed. 2008, Oxford, UK: Elsevier). This fluid mechanics model was used to describe the increased solution velocity at the center of an orifice relative to the sidewall of the orifice, and the increased shear force near the sidewall of the orifice relative to the center of the orifice.

FIG. 37C is a graph of exemplary orifice radii in m (along the y-axis) against exemplary velocities u(z) in m/s (along the x-axis). FIG. 37C indicates that the linear velocity is highest at the center of the orifice, lowest at the sidewall of the orifice, and decreases in a substantially parabolic manner from the center toward the sidewall of the orifice. Based on the experimental data and FIG. 37C, the following formula was determined to quantitatively describe and predict the linear velocity u(z) of the polymer material in the orifice.

$${u}_{2} = \frac{ρ}{8 L μ} ( 2 gh + {Ω}^{2} {L}^{2} ) ( {R}^{2} - {r}^{2} )$$

In the above formula, u_{z} represents the linear velocity of the polymer material, ρ represents the density of the polymer material (e.g., 1,500 kg/m³ in an exemplary embodiment), L represents the length of the orifice taken substantially perpendicularly to the height of the reservoir, g represents the standard value of gravitational acceleration (i.e., 9.8 m/s²), h represents the height of the polymer material in the reservoir (e.g., about one cm in an exemplary embodiment), Ω represents an angular speed corresponding to the rotational speed in 1/s, R represents the orifice diameter, and r represents the radial position in the orifice. The above formula indicates that the linear velocity of the polymer material increases with increasing speed (Ω), decreasing orifice radii (r), and increasing orifice length (L).

FIG. 37D is a graph of exemplary orifice radii in m (along the y-axis) against exemplary shear stresses τ(z) in pascals (along the x-axis). FIG. 37D indicates that the linear velocity is highest at the sidewall of the orifice, lowest at the center of the orifice, and increases in a substantially manner from the center toward the sidewall of the orifice. Based on the experimental data and FIG. 37D, the following formula was determined to quantitatively describe and predict the shear stress τ(z) on the polymer material in the orifice:

$$τ ( r ) = ( - \frac{ρ}{4 L} ( 2 gh + {Ω}^{2} {L}^{2} ) r )$$

The above formula indicates that the shear stresses on the polymer material increases with increasing speed (Ω), increasing orifice radii (r), and increasing orifice length (L). For example, intermolecular interactions between a polymer solution and orifice result in maximum shear forces occurring at the interface between the polymer solution and the orifice. This gradient of shear forces causes long polymers, e.g., polymers having long polymer chains, e.g., biogenic polymers, e.g., protein chains, to be unfolded to expose cryptic binding domains.

A derivation of the above predictive model for the shear forces and their role in the unfolding of fibronectin is set forth in Example 7.

The above equations were used to develop a model which can was to predict the shear forces on a fluid flow of a shear sensitive polymer (e,g, a biogenic polymer, such as fibronectin, silk fibroin, etc.). Specifically this method was used to predict the unfolding of the biogenic polymer, fibronectin (FN), in a rotating shear flow, which was used to predict fibrillogenesis. The predictive method used the inputs of solution viscosity (measured by cone and plate rheometry) and rotation speed to output the shear stress on a FN molecule in solution. Previously, data of the tensile forces required to unfold FN were published (Oberhauser et al. 2008). By using Mohr's Law, the tensile stress was converted to a shear stress, and this data was added to the above model to set a threshold for the shear stress required to unfold FN. Based on the above model, process parameters (viscosity, density, rotation speed, orifice diameter, orifice length) which can be tuned to unfold FN in a rotating shear flow were predicted. Other predictable parameters include the percent of volume of FN that will unfold in a range of rotating speeds. By including the Weissenberg number (Wᵢ) into the above model, fiber unfolding was predicted, as well as the time and position in space at which the fibrillogenesis event occurs in the fiber formation devices described herein.

$${W}_{i} = \frac{γ}{{τ}_{relaxation}}$$

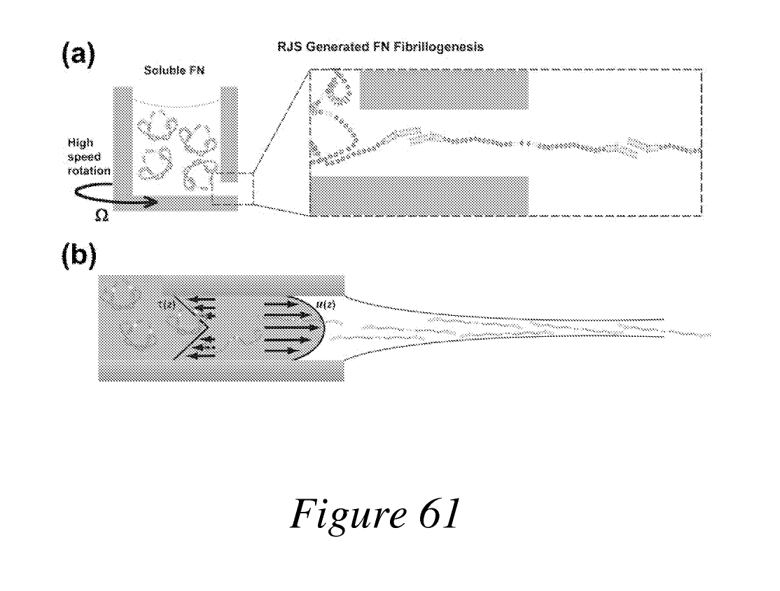

FIG. 61A illustrates a schematic view of a rotating reservoir containing soluble fibronectin in its globular conformation and fibronectin unfolding during fibrillogenesis as it exits through an orifice. FIG. 61B illustrates treatment of the Weissenberg number that was used to predict when fibronectin-fibronectin binding occurs in the rotating fluid flow.

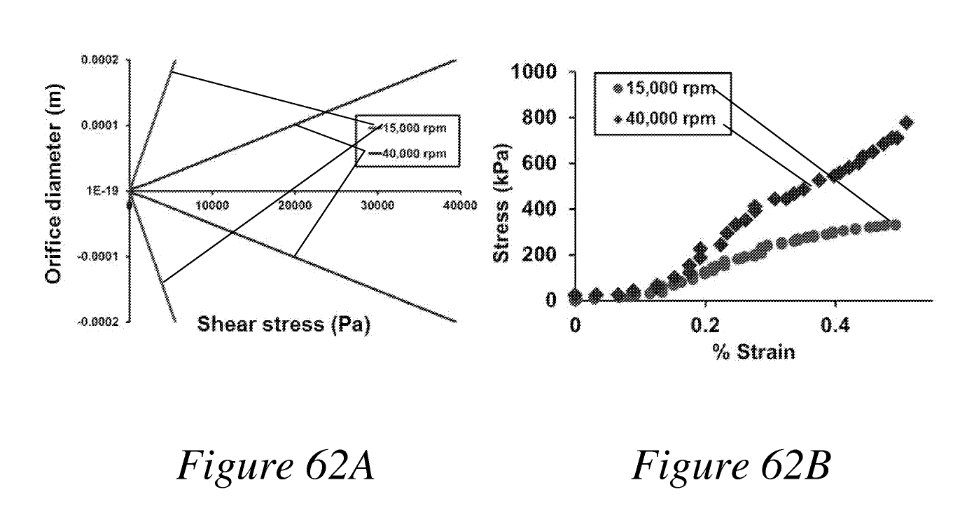

The above predictive model may be used in exemplary embodiments to determine and predict shear forces and stresses on any fluid in a rotating cylinder. The predictions may be made for any suitable polymeric fluid, e.g., biogenic polymer solutions. Silk fibroin, for example, is a shear-sensitive protein that forms beta-sheet structures when exposed to shear. FIG. 62A is a graph of exemplary orifice diameters in m (along the y-axis) versus exemplary shear stresses in Pa (along the x-axis) plotted at exemplary rotational speeds of about 15,000 rpm and about 40,000 rpm. The data is based on 3 wt % silk fibroin solution. Exposing the silk fibroin to the shear stresses in exemplary embodiments induces more beta sheet formation, and thereby producing a stronger fiber as beta sheet structures are noted for their high strength. FIG. 62B is a graph of exemplary fiber tensile stresses in kPa withstood by exemplary fibers (along the y-axis) versus exemplary % strains (along the x-axis) plotted at exemplary rotational speeds of about 15,000 rpm and about 40,000 rpm. The data shows that fibers spun at higher speeds (which result in higher shear forces) can withstand higher fiber tensile stresses and are stronger than fibers spun at lower speeds (which result in lower shear forces). As such, in exemplary embodiments, higher rotational speeds (e.g., about 50,000 rpm in some embodiments) may be used to form strong polymeric fibers.

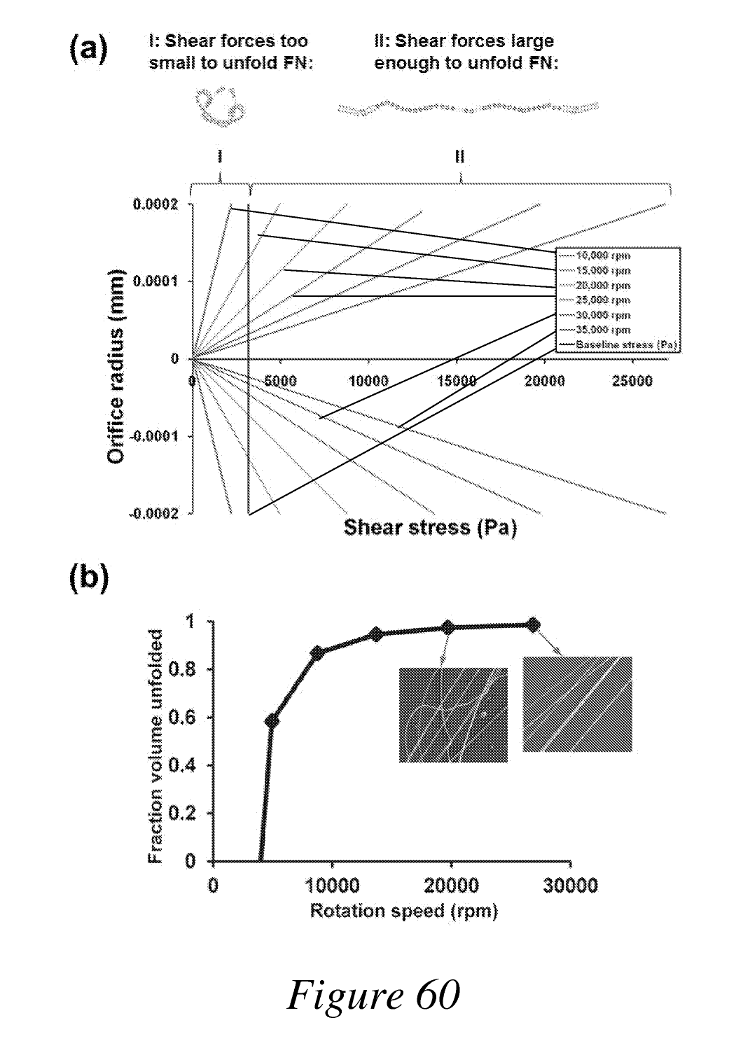

The above predictive model may be used in exemplary embodiments to tune and control different process parameters (e.g., ρ, density, L, orifice length, μ, solution viscosity, h, orifice height, g, gravity, Ω, angular speed, R, orifice diameter, and r, position in the orifice) to control the shear unfolding of a polymer, e.g., a biogenic polymer. FIG. 60A is a graph of exemplary orifice radius in mm (along the y-axis) versus exemplary shear stresses in Pa (along the x-axis) as the rotational speed is controlled, keeping other variables constant and using Mohr's law treatment of tensile testing of single fibronectin molecules. (See, Oberhauser 2008). Two regimes may be defined in FIG. 61A: (I) Shear forces are too small in this parameter space to unfold fibronectin and, thus, fibronectin remains in its globular conformation; (II) Shear forces are sufficiently high in the parameter space to unfold fibronectin. Unfolded fibronectin binds with other fibronectin molecules in the fibrillogenesis event.

FIG. 60B is a graph of the fraction of the volume of fibronectin that is unfolded (along the y-axis) versus the rotational speed in rpm (along the x-axis). The fraction of the volume of fibronectin that is unfolded can be calculated to determine the amount of fibronectin that will be unfolded and formed into insoluble fibers. The exemplary fibers shown insets in FIG. 60C were spun at about 20,000 rpm (for the fibers shown in the left insert) and 30,000 rpm (for the fibers shown in the right insert).

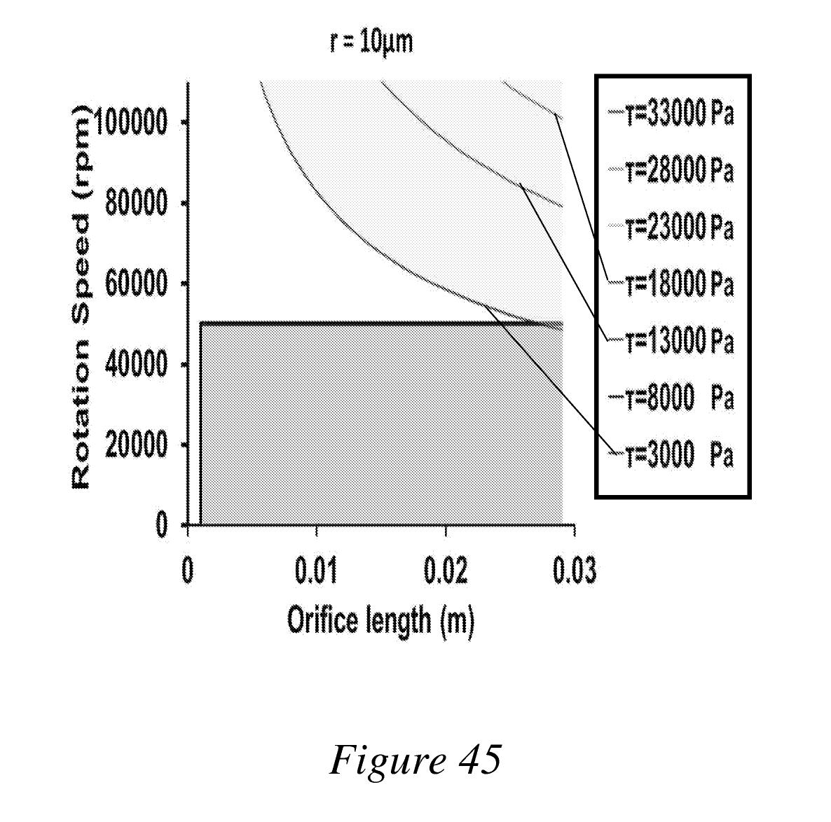

FIG. 45 is a graph of rotational speeds in rpm (along the y-axis) versus exemplary orifice lengths in m (along the x-axis) with an exemplary orifice radius of about 10 μm. The graph plots curves representing shear forces of 3,000 Pa, 13,000 Pa and 18,000 Pa generated by different combinations of rotational speeds and orifice lengths. In this setup, a minimum shear force of about 3,000 Pa is required by to form insoluble polymer fibers. As such, the parameter space above and to the right of the 3,000 Pa curve may be used to form polymer fibers in exemplary embodiments. The area in light gray represents the conditions under which a device comprising a rotating reservoir and an orifice produces sufficient shear force to fabricate an insoluble nanofiber from a biogenic polymer based on the mathematical model described above. That is, for an orifice radius of about 10 μm and orifice lengths ranging from about 0.001 m to about 0.03 m, a minimum rotational speed of about 50,000 rpm (depending on the specific orifice length) is required to achieve fiber formation through fibrillogenesis.

For example, at an exemplary orifice radius of about 10 μm and an exemplary orifice length of about 0.03 m, exemplary rotational speeds may be any speed above 50,000 rpm, for example, from about 50,000 rpm to about 400,000 rpm. At an exemplary orifice radius of about 10 μm and an exemplary orifice length of about 0.02 m, exemplary rotational speeds may be any speed above 60,000 rpm, for example, from about 60,000 rpm to about 400,000 rpm. At an exemplary orifice radius of about 10 μm and an exemplary orifice length of about 0.015 m, exemplary rotational speeds may be any speed above 70,000 rpm, for example, from about 70,000 rpm to about 400,000 rpm. At an exemplary orifice radius of about 10 μm and an exemplary orifice length of about 0.01 m, exemplary rotational speeds may be any speed above 80,000 rpm, for example, from about 80,000 rpm to about 400,000 rpm. Rotational speeds in exemplary embodiments at an exemplary orifice radius of about 10 μm and orifice lengths ranging from about 0.03 m may range from about 50,000 rpm to about 400,000 rpm, e.g., 50,000, 55,000, 60,000, 65,000, 70,000, 75,000, 80,000, 85,000, 90,000, 95,000, 100,000, 105,000, 110,000, 115,000, 120,000, 125,000, 130,000, 135,000, 140,000, 145,000, 150,000 rpm, and the like.

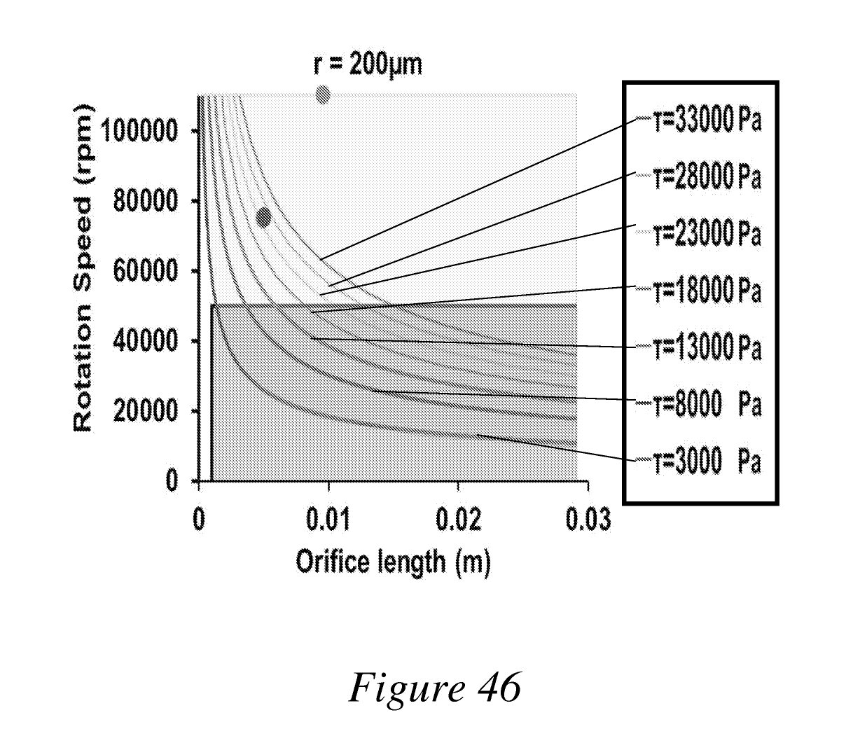

FIG. 46 is a graph of rotational speeds in rpm (along the y-axis) versus exemplary orifice lengths in m (along the x-axis) with an exemplary orifice radius of about 200 μm. The graph plots curves representing shear forces of 3,000 Pa, 8,000 Pa, 13,000 Pa, 18,000 Pa, 23,000 Pa, 28,000 Pa and 33,000 Pa generated by different combinations of rotational speeds and orifice lengths. In this setup, a minimum shear force of about 3,000 Pa is required by to form insoluble polymer fibers. As such, the parameter space above and to the right of the 3,000 Pa curve may be used to form polymer fibers in exemplary embodiments. The area in light gray represents the conditions under which a device comprising a rotating reservoir and an orifice produces sufficient shear force to fabricate an insoluble nanofiber from a biogenic polymer based on the mathematical model described above. That is, for an orifice radius of about 200 μm and orifice lengths ranging from about 0.001 m to about 0.03 m, a minimum rotational speed of about 16,000 rpm (depending on the specific orifice length) is required to achieve fiber formation through fibrillogenesis.

For example, at an exemplary orifice radius of about 200 μm and an exemplary orifice length of about 0.03 m, exemplary rotational speeds may be any speed above 16,000 rpm, for example, from about 16,000 rpm to about 400,000 rpm. Another exemplary range is from about 50,000 rpm to about 400,000 rpm. At an exemplary orifice radius of about 200 μm and an exemplary orifice length of about 0.02 m, exemplary rotational speeds may be any speed above 18,000 rpm, for example, from about 18,000 rpm to about 400,000 rpm. At an exemplary orifice radius of about 200 μm and an exemplary orifice length of about 0.01 m, exemplary rotational speeds may be any speed above 20,000 rpm, for example, from about 20,000 rpm to about 400,000 rpm. Rotational speeds in exemplary embodiments at an exemplary orifice radius of about 200 μm and orifice lengths ranging from about 0.001 m may range from about 50,000 rpm to about 400,000 rpm, e.g., 50,000, 55,000, 60,000, 65,000, 70,000, 75,000, 80,000, 85,000, 90,000, 95,000, 100,000, 105,000, 110,000, 115,000, 120,000, 125,000, 130,000, 135,000, 140,000, 145,000, 150,000 rpm, and the like.

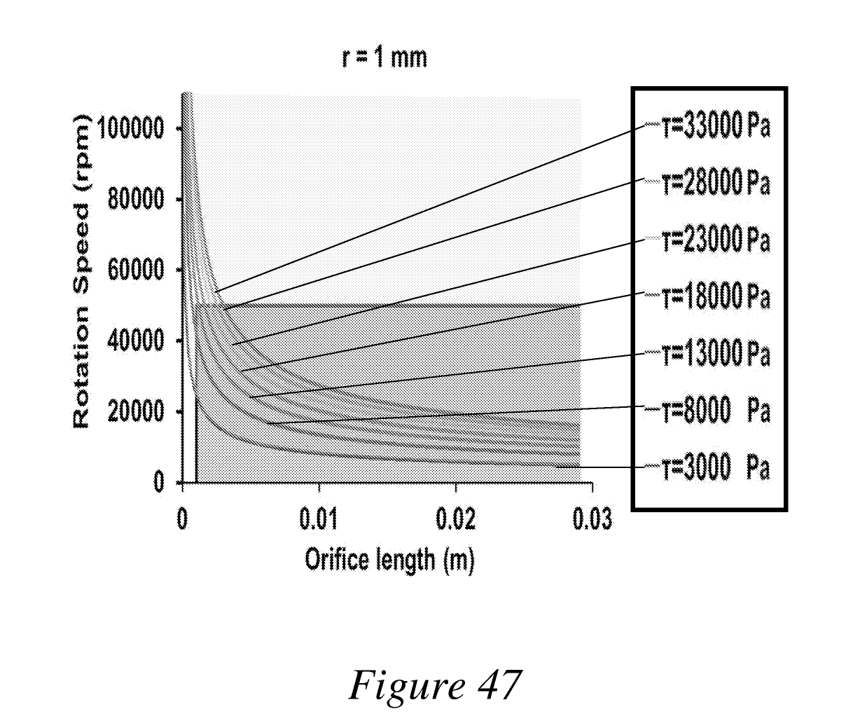

FIG. 47 is a graph of rotational speeds in rpm (along the y-axis) versus exemplary orifice lengths in m (along the x-axis) with an exemplary orifice radius of about 1 mm. The graph plots curves representing shear forces of 3,000 Pa, 8,000 Pa, 13,000 Pa, 18,000 Pa, 23,000 Pa, 28,000 Pa and 33,000 Pa generated by different combinations of rotational speeds and orifice lengths. In this setup, a minimum shear force of about 3,000 Pa is required by to form insoluble polymer fibers. As such, the parameter space above and to the right of the 3,000 Pa curve may be used to form polymer fibers in exemplary embodiments. The area in light gray represents the conditions under which a device comprising a rotating reservoir and an orifice produces sufficient shear force to fabricate an insoluble nanofiber from a biogenic polymer based on the mathematical model described above.

That is, for an orifice radius of about 1 mm and orifice lengths ranging from about 0.001 m to about 0.03 m, a minimum rotational speed of about 4,000 rpm (depending on the specific orifice length) is required to achieve fiber formation through fibrillogenesis. Rotational speeds in exemplary embodiments at an exemplary orifice radius of about 1 mm and orifice lengths ranging from about 0.001 m may range from about 50,000 rpm to about 400,000 rpm, e.g., 50,000, 55,000, 60,000, 65,000, 70,000, 75,000, 80,000, 85,000, 90,000, 95,000, 100,000, 105,000, 110,000, 115,000, 120,000, 125,000, 130,000, 135,000, 140,000, 145,000, 150,000 rpm, and the like.

Exemplary orifice lengths that may be used in some exemplary embodiments range between about 0.001 m and about 0.1 m, e.g., 0.005, 0.01, 0.015, 0.02, 0.025, 0.03, 0.035, 0.04, 0.045, 0.05 m, and the like.

A comparison of FIGS. 45-47 demonstrates that increasing the orifice radius decreases the rotational speed required to achieve a certain level of shear force, and therefore decreases the rotational speed required to achieve fibrillogenesis for fiber formation. Although the necessary rotational speed may be lower at large orifice radii, solvent in a large jet may not have sufficient time to evaporate, which may impeded proper fiber formation. This is because smaller orifice radii facilitate fiber formation by aiding solvent evaporation.

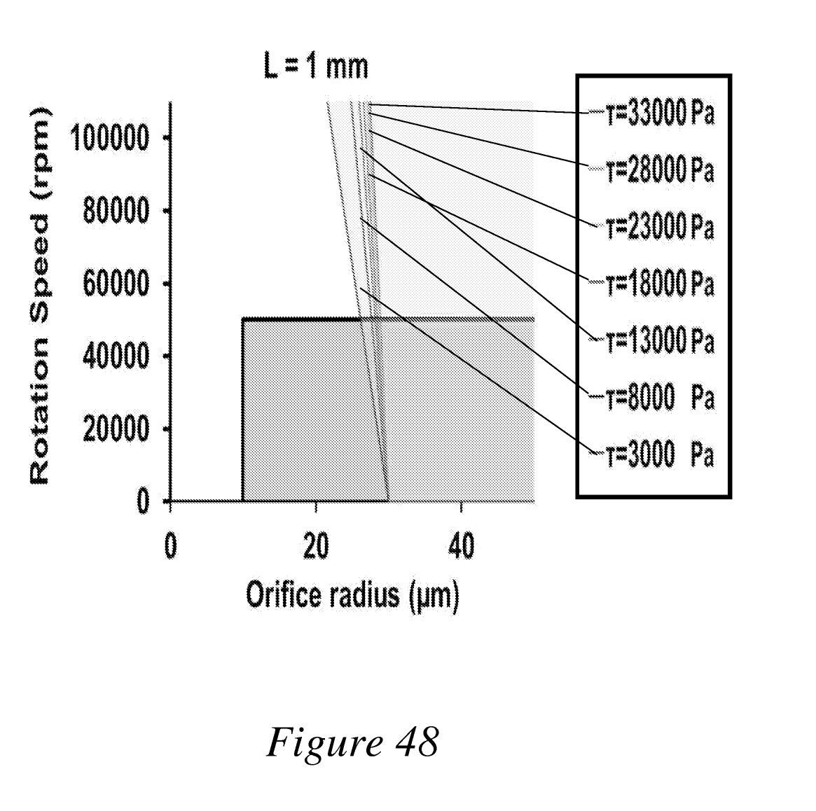

FIG. 48 is a graph of rotational speeds in rpm (along the y-axis) versus exemplary orifice radii in μm (along the x-axis) with an exemplary orifice length of about 1 mm. The graph plots curves representing shear forces of 3,000 Pa, 8,000 Pa, 13,000 Pa, 18,000 Pa, 23,000 Pa, 28,000 Pa and 33,000 Pa generated by different combinations of rotational speeds and orifice radii. In this setup, a minimum shear force of about 3,000 Pa is required by to form insoluble polymer fibers. As such, the parameter space above and to the right of the 3,000 Pa curve may be used to form polymer fibers in exemplary embodiments. The area in light gray represents the conditions under which a device comprising a rotating reservoir and an orifice produces sufficient shear force to fabricate an insoluble nanofiber from a biogenic polymer based on the mathematical model described above.

For example, for an orifice length of about 1 mm and an orifice radius of about 25 μm, a minimum rotational speed of about 50,000 rpm (depending on the specific orifice length) is required to achieve fiber formation through fibrillogenesis. Rotational speeds in exemplary embodiments at an exemplary orifice length of about 1 mm and orifice radii ranging from about 25 μm may range from about 50,000 rpm to about 400,000 rpm, e.g., 50,000, 55,000, 60,000, 65,000, 70,000, 75,000, 80,000, 85,000, 90,000, 95,000, 100,000, 105,000, 110,000, 115,000, 120,000, 125,000, 130,000, 135,000, 140,000, 145,000, 150,000 rpm, and the like.

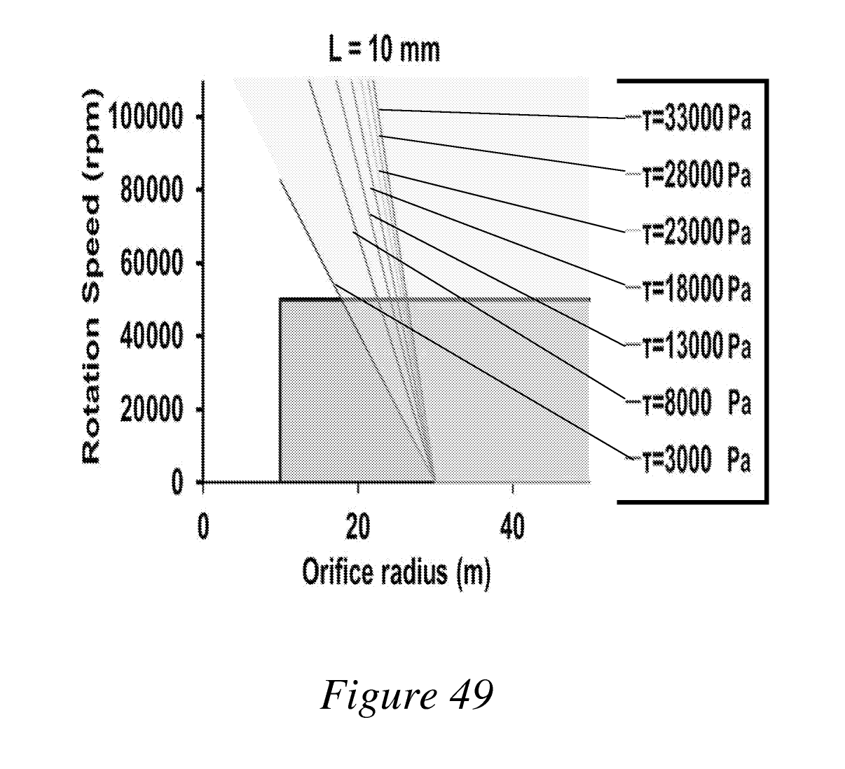

FIG. 49 is a graph of rotational speeds in rpm (along the y-axis) versus exemplary orifice radii in μm (along the x-axis) with an exemplary orifice length of about 10 mm. The graph plots curves representing shear forces of 3,000 Pa, 8,000 Pa, 13,000 Pa, 18,000 Pa, 23,000 Pa, 28,000 Pa and 33,000 Pa generated by different combinations of rotational speeds and orifice radii. In this setup, a minimum shear force of about 3,000 Pa is required by to form insoluble polymer fibers. As such, the parameter space above and to the right of the 3,000 Pa curve may be used to form polymer fibers in exemplary embodiments. The area in light gray represents the conditions under which a device comprising a rotating reservoir and an orifice produces sufficient shear force to fabricate an insoluble nanofiber from a biogenic polymer based on the mathematical model described above.

For example, for an orifice length of about 10 mm and an orifice radius of about 20 μm, a minimum rotational speed of about 50,000 rpm (depending on the specific orifice length) is required to achieve fiber formation through fibrillogenesis. For an orifice length of about 10 mm and an orifice radius of about 10 μm, a minimum rotational speed of about 80,000 rpm (depending on the specific orifice radius) is required. Rotational speeds in exemplary embodiments at an exemplary orifice length of about 10 mm and orifice radii ranging from about 20 μm may range from about 50,000 rpm to about 400,000 rpm, e.g., 50,000, 55,000, 60,000, 65,000, 70,000, 75,000, 80,000, 85,000, 90,000, 95,000, 100,000, 105,000, 110,000, 115,000, 120,000, 125,000, 130,000, 135,000, 140,000, 145,000, 150,000 rpm, and the like. Rotational speeds in exemplary embodiments at an exemplary orifice length of about 10 mm and orifice radii ranging from about 10 μm may range from about 80,000 rpm to about 400,000 rpm, e.g., 80,000, 85,000, 90,000, 95,000, 100,000, 105,000, 110,000, 115,000, 120,000, 125,000, 130,000, 135,000, 140,000, 145,000, 150,000 rpm, and the like.

Exemplary orifice diameters that may be used in some exemplary embodiments range between about 0.1 μm and about 10 μm, e.g., 0.1, 0.2, 0.3, 0.4, 0.5, 0.6, 0.7, 0.8, 0.9, 1.0 μm, and the like.

A comparison of FIGS. 48 and 49 demonstrates that, at high rotational speeds, the orifice radius may be tuned to control the shear stress. That is, at the same orifice length and at high rotational speeds, the shear stress may be decreased by decreasing the orifice radius.

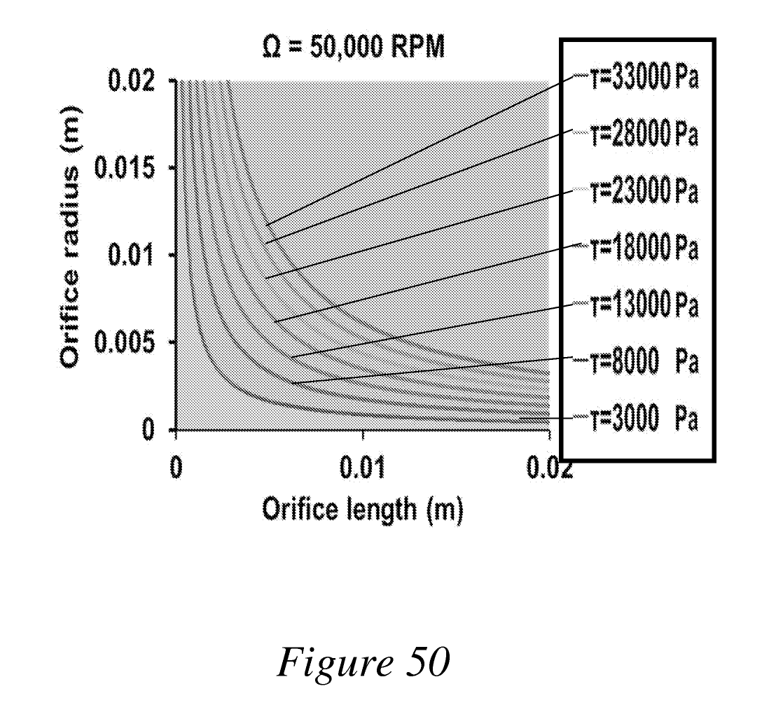

FIG. 50 is a graph of exemplary orifice radii in m (along the y-axis) versus exemplary orifice lengths in m (along the x-axis) at an exemplary rotational speed of about 50,000 rpm. The graph plots curves representing shear forces of 3,000 Pa, 8,000 Pa, 13,000 Pa, 18,000 Pa, 23,000 Pa, 28,000 Pa and 33,000 Pa generated by different combinations of orifice length and radii. In this setup, a minimum shear force of about 3,000 Pa is required by to form insoluble polymer fibers. As such, the parameter space above and to the right of the 3,000 Pa curve may be used to form polymer fibers in exemplary embodiments. The area in light gray represents the conditions under which a device comprising a rotating reservoir and an orifice produces sufficient shear force to fabricate an insoluble nanofiber from a biogenic polymer based on the mathematical model described above. That is, as the orifice radius is increased, the orifice length may be decreased. For example, at an exemplary rotational speed of about 50,000 rpm and an exemplary orifice radius of about 0.005 m, orifice lengths equal to and above about 0.002 m may be used. At an exemplary rotational speed of about 50,000 rpm and an exemplary orifice radius of about 0.01 m, orifice lengths equal to and above about 0.001 m may be used.

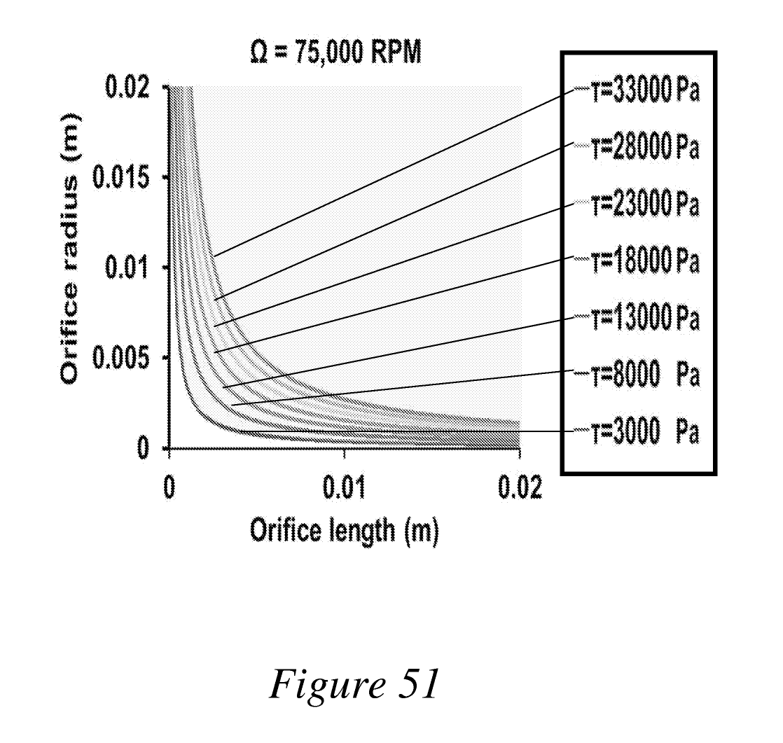

FIG. 51 is a graph of exemplary orifice radii in m (along the y-axis) versus exemplary orifice lengths in m (along the x-axis) at an exemplary rotational speed of about 75,000 rpm. The graph plots curves representing shear forces of 3,000 Pa, 8,000 Pa, 13,000 Pa, 18,000 Pa, 23,000 Pa, 28,000 Pa and 33,000 Pa generated by different combinations of orifice length and radii. In this setup, a minimum shear force of about 3,000 Pa is required by to form insoluble polymer fibers. As such, the parameter space above and to the right of the 3,000 Pa curve may be used to form polymer fibers in exemplary embodiments. The area in light gray represents the conditions under which a device comprising a rotating reservoir and an orifice produces sufficient shear force to fabricate an insoluble nanofiber from a biogenic polymer based on the mathematical model described above. That is, as the orifice radius is increased, the orifice length may be decreased. For example, at an exemplary rotational speed of about 75,000 rpm and an exemplary orifice radius of about 0.01 m, orifice lengths equal to and above about 0.001 m may be used. At an exemplary rotational speed of about 75,000 rpm and an exemplary orifice radius of about 0.005 m, orifice lengths equal to and above about 0.002 m may be used.

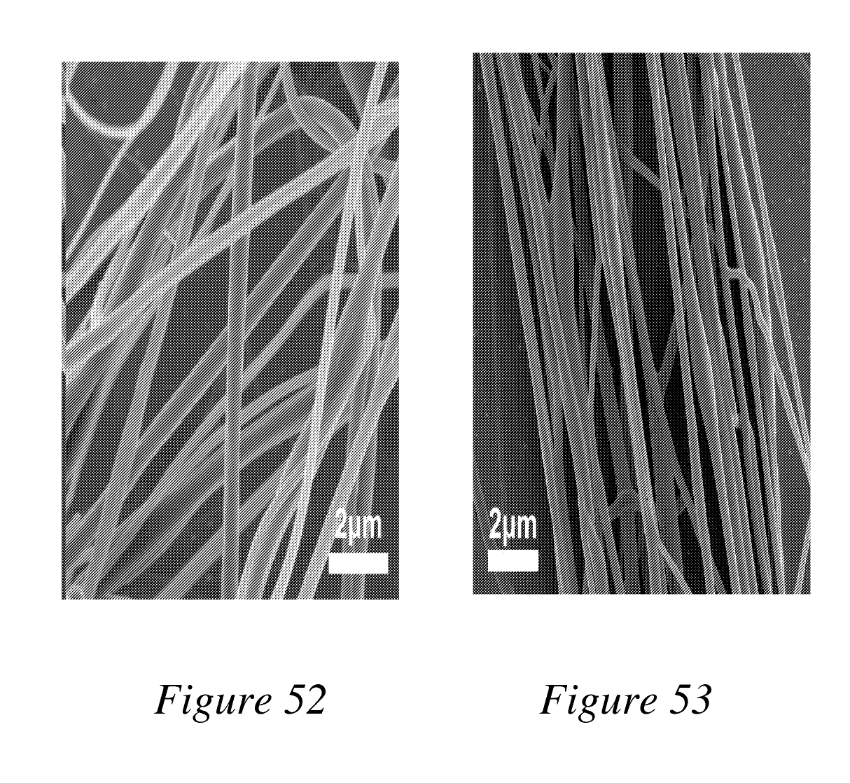

FIG. 52 are fibronectin nanofibers produced in a device comprising a rotating reservoir and an orifice rotated at 75,000 rpm and having a 200 um orifice radius and a 0.5 cm orifice length.

FIG. 53 are silk fibroin nanofibers produced in a device comprising a rotating reservoir and an orifice rotated at 75,000 rpm and having a 200 um orifice radius and a 0.5 cm orifice length.

FIG. 54 are poly(lactic acid) nanofibers produced in a device comprising a rotating reservoir and an orifice rotated at 75,000 rpm and having a 200 um orifice radius and a 0.5 cm orifice length.

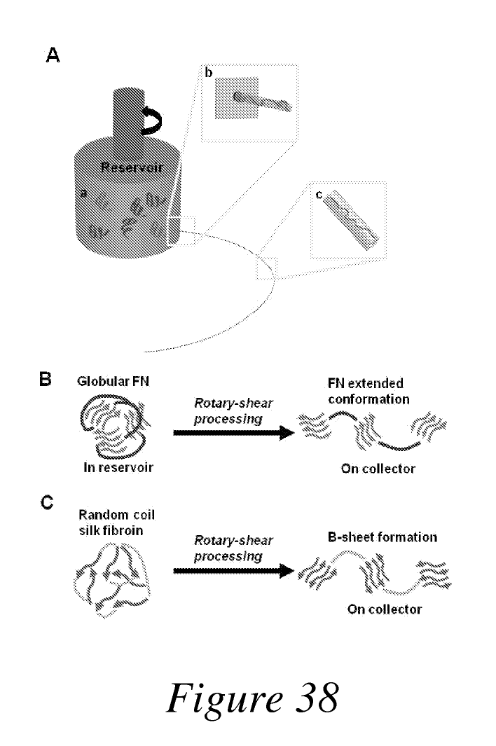

Using the above theoretical, experimental and practical model, the conformation of biogenic polymers at various stages of the nanofiber forming process is depicted in FIGS. 38A-38C. FIG. 38A illustrates an exemplary rotating reservoir containing a soluble biogenic polymer material in its globular state. As the biogenic polymer exits the reservoir through the orifice it has been unfolded by shear forces within the opening of the reservoir. Because, e.g., protein-protein binding sites, in the biogenic polymer are now exposed due to shear unfolding, biogenic polymer molecules may irreversibly bind creating insoluble biogenic polymer fibers.

In FIG. 38B, a biogenic polymer, e.g., a protein comprising a beta sheet structure, such as fibronectin, is depicted before and after spinning in an exemplary fiber forming device of the invention employing rotational motion and comprising a reservoir and an orifice. The biogenic polymer has a maintained beta sheet structure which is contained within the conformation of the protein. After spinning, shear forces unfold the protein exposing its beta sheet domains in its extended state.

In FIG. 38C, a biogenic polymer comprising a random coil structure, such as silk fibroin, is depicted before and after spinning in an exemplary fiber forming device of the invention employing rotational motion and comprising a reservoir and an orifice. During extraction of a biogenic protein comprising a random coil, such as silk fibroin, all existing hydrogen bonding within the biogenic polymer are broken to reveal as is the beta sheet structure of the biogenic polymer. Once the bonds are broken, the biogenic polymer becomes soluble as a beta strand containing random coil in the reservoir. When the biogenic polymer is spun into fibers, shear forces cause beta strands to come into contact with neighboring strands to hydrogen bond and form beta sheets within the molecule and between molecules to form an insoluble fiber. The resulting fibrous biogenic polymer nanofiber has an extended conformation with a beta sheet content dependent on the magnitude of shear forces felt by the molecule within the opening of the reservoir.

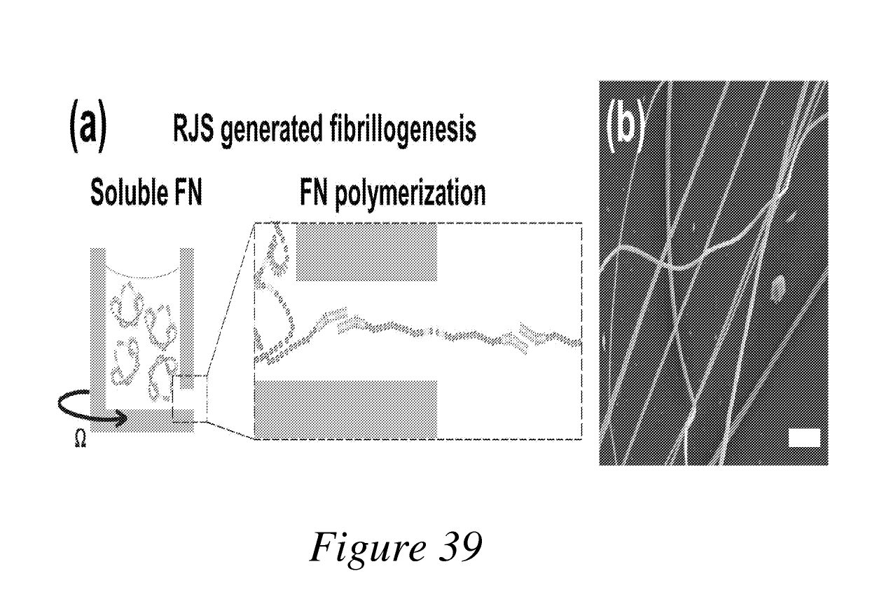

FIG. 39A also depicts the mechanism of in vitro fibrillogeneis of an extracellular matrix protein, such as fibronectin predicted based on model of shear stress described above.

In order to demonstrate that biogenic polymers, e.g., proteins, e.g., proteins comprising beta sheets (e.g., fibronectin) are being elongated in the flow when exiting the orifice of the device employing rotational motion, the secondary structure of the fabricated nanofibers was studied using two methods, Raman spectroscopy and Fluorescence resonance energy transfer (FRET). Furthermore, as described below, using an exemplary fiber forming device of the invention employing rotational motion and comprising a reservoir and an orifice, nanofibers of biogenic polymers which retain the morphological and biological activities of polymers produced in vivo have been made (see, e.g., FIGS. 39B, 40, and 44).

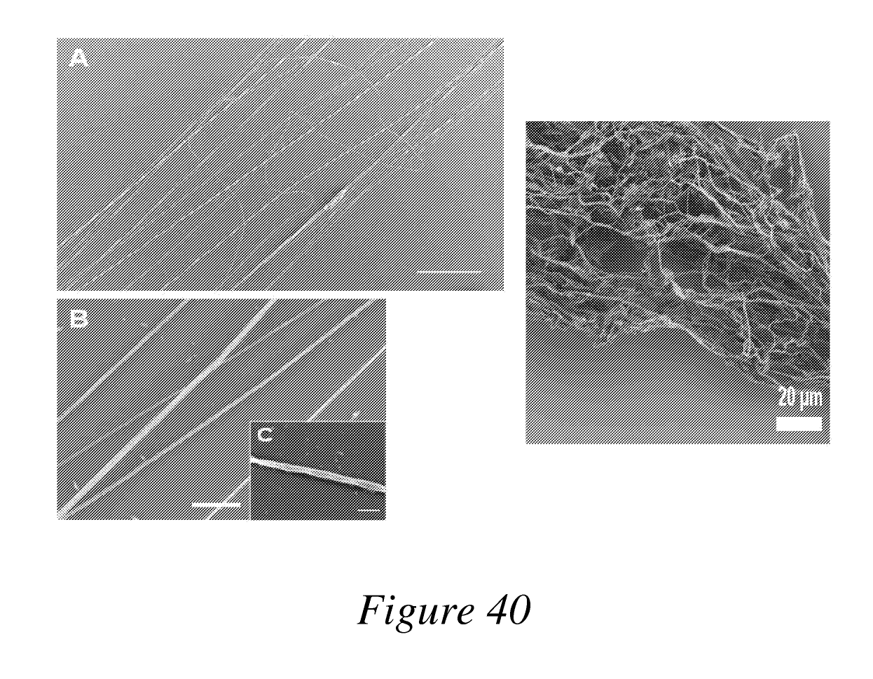

Scanning electron microscopy (SEM) was used to analyze the fabricated fiber morphology and diameter. FIGS. 40A and 40B show that the fabricated fibronectin nanofibers have an average fiber diameter of 232.6±59 nm. Scale bars are 50 μm (FIG. 40A) and 2 μm (FIG. 40B). At higher magnification, SEM reveals the ultrastructure of the fabricated fibronectin nanofibers. Scale bar is 200 nm (FIG. 40C).

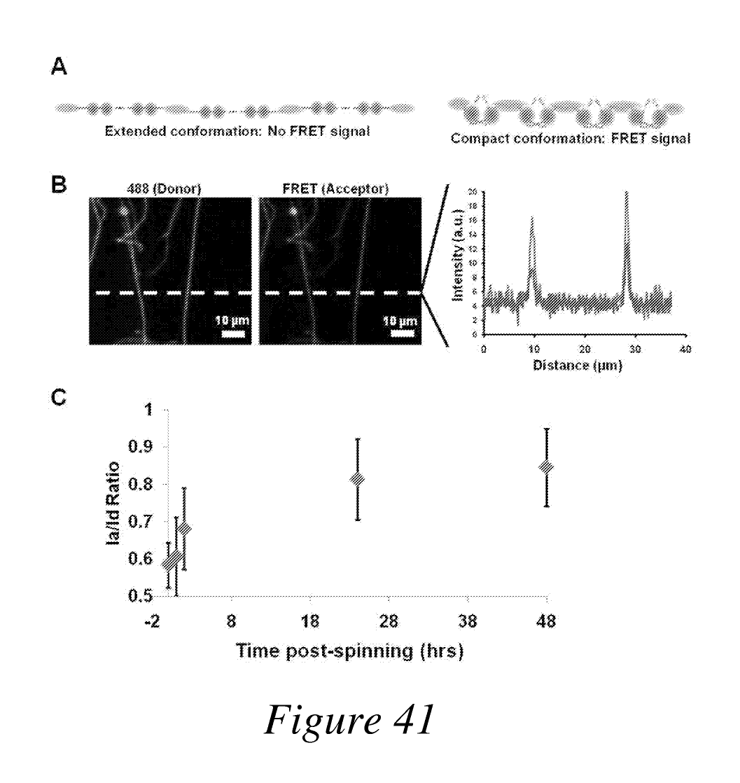

The secondary structure of the fabricated fibronectin nanofibers was also examined. Fluorescence resonance energy transfer (FRET) is a dual labeling and imaging technique which can be used to identify the secondary structure of fibronectin molecules by measuring the intensity of fluorescence resulting from energy transfer from donor fluorophores to acceptor fluorophores. Alexa Fluor 488 is used to non-specifically label amines along the FN backbone. Tetramethyl rhodamine 546 is bound specifically to free sulfhydryls on cryptic cysteines. The intensity of acceptor fluorophores is inversely proportional to the distance between fluorophores. In this way, the compact or extended nature of fabricated fibronectin nanofibers can be measured by comparing relative FRET intensities. A schematic of fibronectin conformation and expected FRET result is shown in FIG. 41A. Representative FRET intensity measured at time=10 minutes after spinning FRET labeled FN fibers is shown in FIG. 41B. The ratio of acceptor to donor fluorescence intensity over 2 days was measured and shown in FIG. 41C.

Raman spectroscopy is a technique which is used to identify the chemical signature of a material. It can also be used to measure the secondary structure of proteins. If the secondary structure is in an extended conformation, the peaks associated with those vibrational and rotational modes will exhibit higher intensity than those peaks measuring the vibrartional and rotational modes of bonds hidden within the folded structure of the protein molecule. Raman spectra was collected at varying timepoints and the associated peaks were observed to decrease in intensity over 24 to 48 hours.

Raman spectra and FRET intensity ratios demonstrate molecularly that when nanofibers produced from a protein with a shear topology and a beta sheet structure exit the reservoir orifice of a fiber forming device employing rotational motion, they are in an extended state due to shear forces within the system inducing fibrillogenesis and remaining intact due to mechanical elasticity of the embedded beta sheet domain. Thus, the fabricated fibronectin nanofibers have retained the morphological and conformational characteristics of polymers produced in vivo. A 3 wt % solution of fibronectin dissolved in water and a 3 wt % solution of fibronectin dissolved in water and hexafluoroisoporpanol mix (2:1) were spun at 28,000 rpm.

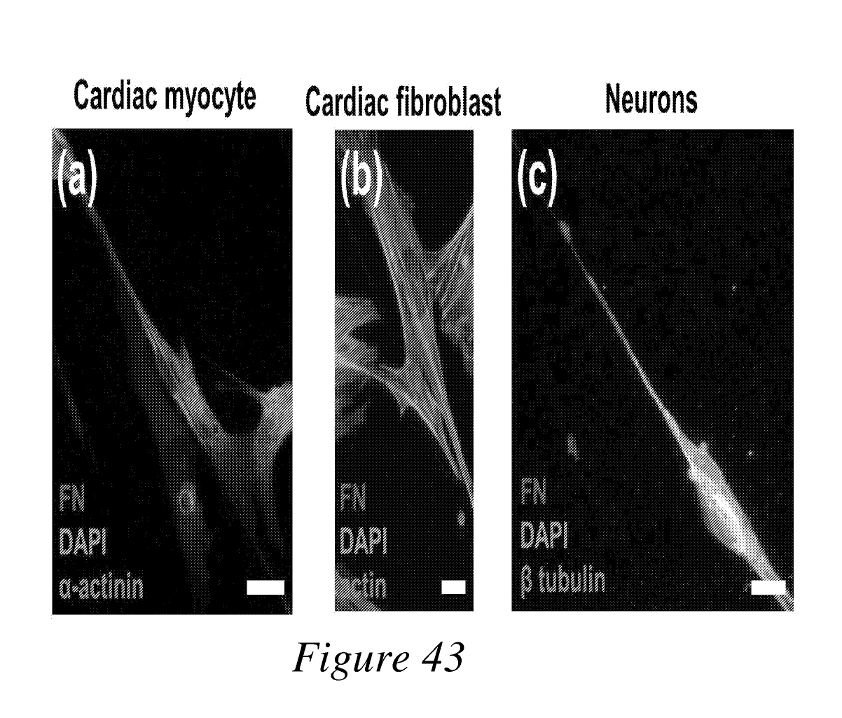

The fabricated fibers were also assessed for their bioactivity by determining if cells would adhere to the fabricated fibronectin nanofibers. FIGS. 43A-43C are laser scanning confocal images of (a) cardiomyocytes (b) actin filaments of cardiac fibroblasts and (c) neurons attached to and orienting with FN nanofibers. Scale bars are 10 μm. As shown in FIGS. 43A-43C, there is robust attachment of cardiac myocytes, fibroblasts, and neurons to cell scaffolds prepared from the fabricated fibronectin nanofibers.

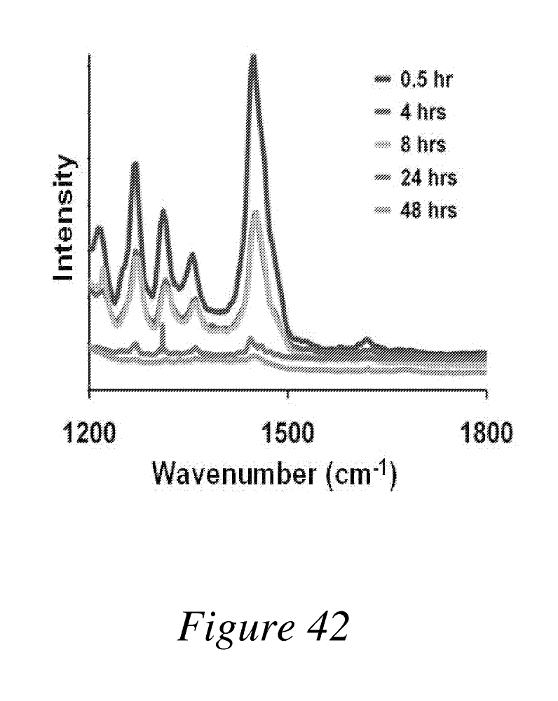

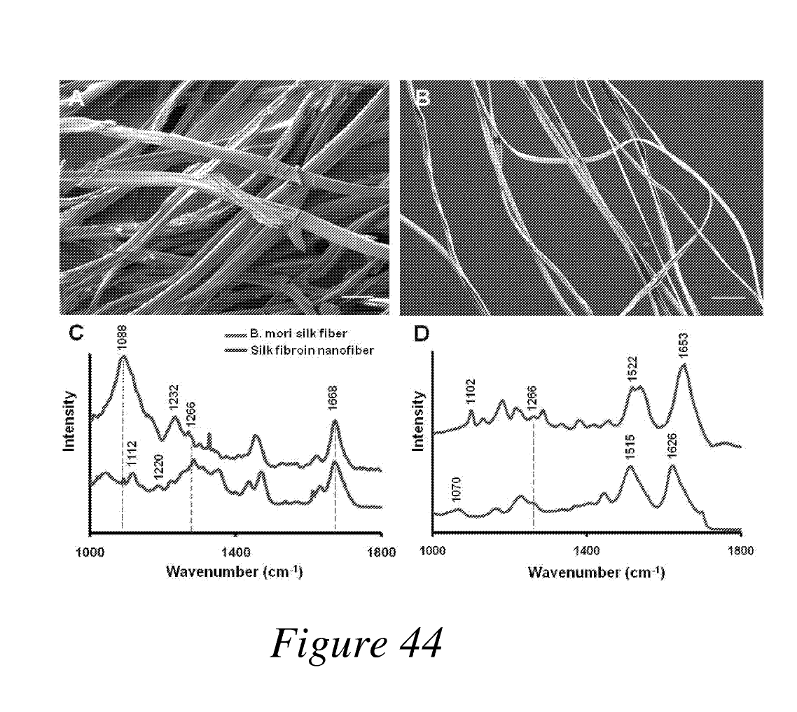

Nanofibers produced from the biogenic polymer, silk fibroin, using an exemplary fiber forming device of the invention employing rotational motion and comprising a reservoir and an orifice also retain the morphological and chemical characteristics of silk fibroin produced in vivo (FIGS. 44A-44D). Bombyx mori silkworm silk extracted from cocoons was imaged in its fibrous form to characterize size and morphology of native silk fibers (FIG. 44A). FIG. 42 is Raman spectroscopy graph of fabricated fibronectin nanofibers. Scale bar is 40 μm. After extraction, silk fibroin protein nanofibers were produced (FIG. 44B). Scale bar is 5 μm.

The chemical structure of fabricated silk fibroin nanofibers was compared with native silkworm silk microfibers using Stokes Raman spectroscopy. Reconstitution of a β-sheet structure in silk fibroin nanofibers is indicated by the conserved Amide I peak (1668 cm-1), Amide III peak (1226 cm-1), and the β-sheet characteristic peak at 1088 cm-1 (FIG. 44C). Silk fibroin nanofibers are a hybrid of β-sheet and α-helix conformation indicated C—C stretching observed at 1112 cm-1. ATR-FTIR spectroscopy confirms the results seen in Raman spectroscopy. Peak shifts in Amide I (1626→1653 cm⁻¹), and Amide II (1515→1522 cm⁻¹) indicated a decrease in relative β-sheet content of the fabricated nanofibers (FIG. 44D). A 3 wt % solution of fibronectin dissolved in water and a 3 wt % solution of fibronectin dissolved in water and hexafluoroisoporpanol mix (2:1) were spun at 25,000-30,000 rpm.

In summary, the experiments described above demonstrate that an exemplary fiber forming device employing rotational motion and comprising a rotating reservoir and an orifice can be used as a tool to provoke shear induced polymer, e.g., biogenic polymer, unfolding and facilitate fibrillogensis in vitro. The experiments described above, also show that fabricated insoluble fibrous structures of polymers, such as biogenic polymers, e.g., fibronectin and silk fibroin, have been generated, initiated by a shear-force driven self-assembly process involving passing a solution through a small diameter orifice of a rotating reservoir with laminar flow, followed by protein fibrillogenesis at the air-liquid interface due to solvent evaporation and jet necking processes.

In particular, by passing through the orifice channel, the shear rate of the fluid (the radial derivative of the fluid velocity) caused chain unfolding of adherent polymer molecules closest to the channel wall, therefore transferring a shear event to the polymer molecule, causing it to unfold and expose cryptic polymer-polymer, e.g., protein-protein, binding domains as it exits the orifice. The folded/unfolded state of the polymer may be controlled by orifice geometry such as its diameter, length, roughness, and rotation speed of the container. Polymer solution jets are forced out of the orifice channel due to external centrifugal action of a rotary reservoir. The jet undergoes tremendous extension and jet thinning due to propelling force by traveling toward the collector wall. This facilitates evaporation of the solvent and further enhancing the jet necking phenomena. The resulting nanofibrous structures of polymers may be collected on the collector wall after jet solidification. The insolubility of the fabricated biogenic polymer nanofibers is the direct evidence of stress-induced fibrillogenesis seen in beta sheet containing biogenic polymers, e.g., proteins.

For example, a biogenic polymer, e.g., fibronectin, in its globular state is a soluble protein and is an insoluble fibrillar structure in a stretched conformation. In native tissue, these conformational changes occur during cell-induced fibronectin aggregation and stretching. By exposing the cryptic binding domains due to extensional flow due to capillary channel and jet necking process, the specific domains responsible for fibronectin-fibronectin binding come in contact forming an irreversible covalent bond.

In addition, it has been demonstrated that a fiber forming device employing rotational motion comprising a reservoir and an orifice is a biomimetic device for manufacturing fibrillar protein structures which can be used to transform proteins from alpha helix conformation to beta sheet conformation, e.g., silk fibroin. When spiders produce silk, beat sheet proteins are extruded through small orifices. This process unfolds the silk fibroin proteins. The fibers are then wound into thread and at this time when the proteins are returning to their relaxed state, they bind forming ultra-strong fibrous threads. Demonstrated herein is the fabrication and chemical analysis of silk fibroin fibers. The method of extracting the silk fibroin protein breaks hydrogen bonds in the beta sheet rich structure, resulting in a random coin solution of silk fibroin protein.

### Example 6

### Shear Stress Modeling and Fabrication of Biogenic Polymer Nanofibers

The mathematical model described above can be used to predict a suitable configuration of a rotating device to produce nanofibers from biogenic polymers. Moreover, using the configurations predicted, nanofibers of biogenic polymers were prepared.

In particular, using the mathematical model of shear stress described in example 5, supra, and plotting rotation speed versus orifice length shows that speeds greater than about 50,000 rpm are required in order to unfold biogenic polymers to successfully produce biogenic polymer nanofibers when the orifice is small, e.g., orifices having a radius of about 10 μm (FIG. 45).

FIG. 46 shows that increasing the orifice radius to about 200 μm decreases the speed required to unfold biogenic polymers, such as fibronectin. The light gray dot indicates the shear stress generated using a fiber forming device employing rotational motion and comprising a reservoir and an orifice used to fabricate the fibers depicted in FIGS. 51 and 53. The dark gray dot indicates the shear stress generated using a fiber forming device employing rotational motion and comprising a reservoir and an orifice used to fabricate the fibers depicted in FIG. 56.

FIG. 47 shows that at large orifice sizes, e.g., orifices having a length of about 10 mm, the speed required to achieve unfolding of a biogenic polymer is low, but in this regime solvent evaporation from a large orifice will negatively affect fiber formation.

Thus, decreasing orifice diameter requires higher speed for unfolding of biogenic polymers to occur and having a smaller orifice facilitates biogenic fiber formation by aiding in solvent evaporation.

FIG. 48 shows that to achieve unfolding of a biogenic polymer at small, uncovered orifice radii, an orifice length of about 1 mm is not long enough to unfold biogenic polymers and fabricate biogenic polymer nanofibers; a longer orifice is required.

FIG. 49 shows that by increasing the length of the orifice to about 10 mm, unfolding of biogenic polymer occurs at high rotation speeds (greater than about 80,000 rpm).

FIG. 50 shows that at 50,000 rpm a biogenic polymer spun in a device employing rotational motion comprising a reservoir and an orifice occurs at all modeled orifice lengths and radii. However, by increasing the speed of rotation of a fiber forming device comprising a rotating reservoir and an orifice to greater than 50,000 rpm, occurs at almost all of the modeled orifice lengths and radii.

Thus, rotational speeds greater than about 50,000 rpm can be used to produce biogenic polymer and synthetic polymer nanofibers. At high rotational speeds, tuning orifice radius can be used to tune shear stress (i.e., decrease shear stress by decreasing orifice radius at high speeds and constant orifice length) and increasing orifice surface area (e.g., using an orifice having, for example a x-pointed star shape) will increase the amount of polymer experiencing shear force in the orifice, because stress is highest at the wall of the orifice.

Based on the modeling above, nanofibers were fabricated in a fiber forming device employing rotational motion comprising a reservoir and an orifice using biogenic polymers and synthetic polymer solutions.

Figure is an image of fibronectin nanofibers produced in a device comprising a rotating reservoir and an orifice rotated at 75,000 rpm and having a 200 um orifice radius and a 0.5 cm orifice length using a 3% weight fibronectin solution in water and hexafluoroisopropanol (HFIP). The average diameter of the fabricated nanofibers is 657±98 nm.

FIG. 53 is an image of silk fibroin nanofibers produced in a device comprising a rotating reservoir and an orifice rotated at 75,000 rpm and having a 200 um orifice radius and a 0.5 cm orifice length using a 3% weight silk fibroin solution in water and hexafluoroisopropanol (HFIP). The average diameter of the fabricated nanofibers is 450±87 nm.

FIG. 54 is an image of poly(lactic acid) nanofibers produced in a device comprising a rotating reservoir and an orifice rotated at 75,000 rpm and having a 200 um orifice radius and a 0.5 cm orifice length using a 2% weight polymer solution in chloroform. The average diameter of the fabricated nanofibers is 87±35 nm.

### Example 7

### Derivation of the Predictive Model for Shear Force Unfolding of Fibronectin

Shear stresses in a Poiseuille flow rotating with angular speed (Ω). The system consists of a viscous (incompressible) fluid flow through a pipe of uniform cross section, rotating about the Y axis (↑Y, →Z)

### Coordinate System:

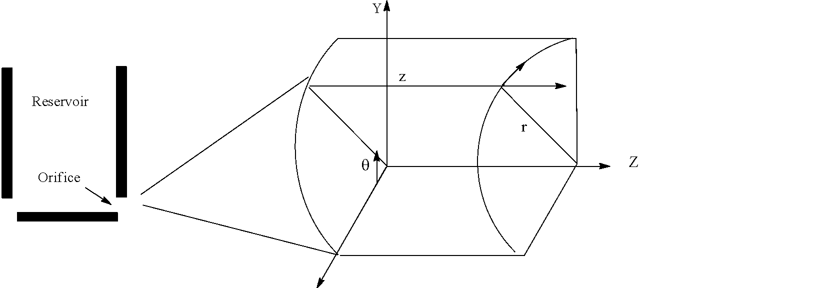

### List of Variables

ρ is density

$$( \frac{kg}{{m}^{3}} )$$

P is pressure

$$( Pa = \frac{N}{{m}^{2}} = \frac{kg}{m - {s}^{2}} )$$

z is distance along orifice (m)
Ω is rotation speed

$$( \frac{cycles}{s} )$$

μ is solution viscosity

$$( Pa \cdot s = \frac{kg}{m \cdot s} )$$

u is velocity

$$( \frac{m}{s} )$$

### Assumptions:

1. The flow is steady (i.e. velocity does not change with time: du_{z}/dt=0
2. Flow is in unidirectional:
   a. Velocity in the r direction, uᵣ=0.
   b. Velocity in the θ direction, u_{θ}=0.
3. The flow is axisymetric.

### Conservation of Mass (Continuity Equation):

$$\frac{\partial }{\partial t} ρ + \frac{1}{r} \frac{\partial {ru}_{r}}{\partial r} + \frac{1}{r} \frac{\partial {u}_{θ}}{\partial θ} + \frac{\partial {u}_{z}}{\partial z} = 0$$

Assumption 4: Density, ρ, does not change with time.

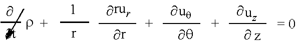

Assumption 2a: There is no flow in the r direction.

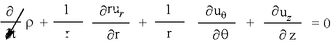

Assumption 3: Flow is axisymetric.

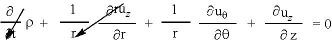

### Therefore:

$$\frac{\partial {u}_{z}}{\partial z} = 0$$

### Conservation of Momentum: Navier Stokes of Cylindrical Coordinates:

A very common case is axisymetric flow with the assumption of no tangential velocity and the remaining quantities are independent of θ. N−S_{θ} goes to zero:

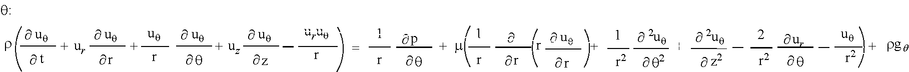

N−Sᵣ goes to zero because:
1. Assume no flow in the r direction
2. P_{hydro} is negligible
3. And

$$\frac{\partial {u}_{z}}{\partial z} = 0$$

from continuity equation.

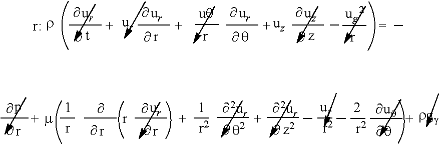

So we study N−S in the z-direction:

$$z \text{:} ρ ( \frac{\partial {u}_{z}}{\partial t} + {u}_{r} \frac{\partial {u}_{z}}{\partial r} + \frac{{u}_{θ}}{r} \frac{\partial {u}_{z}}{\partial θ} + {u}_{z} \frac{\partial {u}_{z}}{\partial z} ) = - \frac{\partial p}{\partial r} + μ ( \frac{1}{r} \frac{\partial }{\partial r} ( r \frac{\partial {u}_{z}}{\partial r} ) + \frac{1}{{r}^{2}} \frac{{\partial }^{2} {u}_{z}}{\partial {θ}^{2}} + \frac{{\partial }^{2} {u}_{z}}{\partial {z}^{2}} ) + ρ$$

### Other Body Forces Term:

$$z \text{:} ρ ( \frac{\partial {u}_{z}}{\partial t} + {u}_{r} \frac{\partial {u}_{z}}{\partial r} + \frac{{u}_{θ}}{r} \frac{\partial {u}_{z}}{\partial θ} + {u}_{z} \frac{\partial {u}_{z}}{\partial z} ) = - \frac{\partial p}{\partial r} + μ ( \frac{1}{r} \frac{\partial }{\partial r} ( r \frac{\partial {u}_{z}}{\partial r} ) + \frac{1}{{r}^{2}} \frac{{\partial }^{2} {u}_{z}}{\partial {θ}^{2}} + \frac{{\partial }^{2} {u}_{z}}{\partial {z}^{2}} )$$

The volumetric other body forces term, ρg_{z}, is substituted with the volumetric centripetal force of rotation. Because α=Ω^{z}r, we replace the acceleration term:

ρg˜ρΩ^{z}(z−M)

With the assumption that g [symbol] Ω^{z}(z−M)

### Simplification of N−S_{z}:

Assumption 1: Flow is steady (i.e. velocity does not change with time.

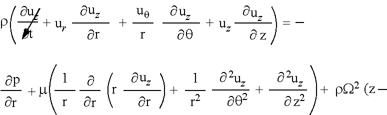

Assumption 2a: Velocity in the r direction is zero.

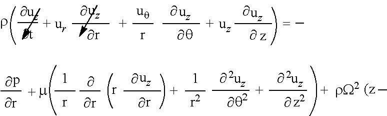

Assumption 2b: Velocity in the θ direction is zero.

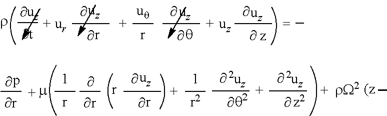

From continuity equation:

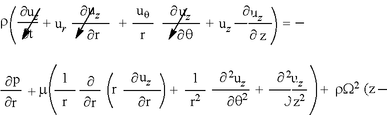

Assumption 3: Flow is axisymmetric.

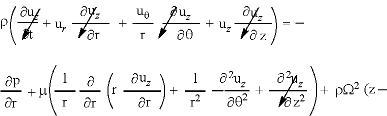

The resulting equation is:

$$0 = - \frac{\partial P}{\partial z} + \frac{μ}{r} \frac{d}{d r} ( r \frac{d {u}_{z}}{d r} ) + ρ {Ω}^{2} ( z - M )$$

### Reorganize:

$$\frac{1}{r} \frac{d}{d r} ( r \frac{d {u}_{z}}{d r} ) = \frac{1}{μ} ( \frac{d P}{d z} - ρ {Ω}^{2} ( z - M ) )$$

The solution of the previous eq. for u_{z} is (Solved in Mathematica):

$${u}_{z} = \frac{1}{4 μ} ( \frac{d P}{d z} - ρ {Ω}^{2} ( z - M ) ) {r}^{2} + c 1 ln r + c 2$$

Pressure term:

$$P = {a}_{1} + {a}_{2} z + {a}_{3} {z}^{2}$$

$$\frac{\partial P}{\partial z} = {a}_{2} + 2 {a}_{3} z$$

### Therefore:

$${u}_{z} = \frac{1}{4 μ} ( {a}_{2} + 2 {a}_{3} z - ρ {Ω}^{2} ( z - M ) ) {r}^{2} + c 1 ln r + c 2$$

Boundary Condition: u_{z} is finite at r=0, ln(0)=1→c₁=0

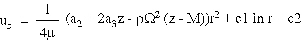

From continuity equation:

$$\frac{\partial {u}_{z}}{\partial z} = 0 = \frac{\partial }{\partial z} [ \frac{1}{4 μ} ( {α}_{2} + 2 {α}_{3} z - ρ {Ω}^{2} z + ρ {Ω}^{2} M ) {r}^{2} + {c}_{2} ]$$

$$0 = \frac{1}{4 μ} ( 2 {a}_{3} - ρ {Ω}^{2} ) {r}^{2}$$

$$0 = 2 {a}_{3} - ρ {Ω}^{2}$$

$${a}_{3} = \frac{1}{2} ρ {Ω}^{2}$$

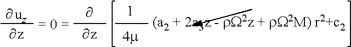

$${u}_{z} = \frac{1}{4 μ} {a}_{2} \cdot {r}^{2} + {c}_{2}$$

### Pressure Boundary Conditions:

$$P ( z - M = 0 ) = ρ gh$$

$$P ( z - M = 0 ) = {a}_{1} = ρ gh$$

$$P ( z - M = L ) = ρ gh + {a}_{2} L + \frac{1}{2} ρ {Ω}^{2} {L}^{2} = 0$$

$${a}_{2} = - \frac{ρ gh}{L} - \frac{1}{2} ρ {Ω}^{2} L$$

Boundary condition: No slip boundary conditions at the pipe wall requires u_{z}(r=R)=0→

$$c 2 = \frac{1}{4 μ} ( \frac{ρ gh}{L} - \frac{1}{2} ρ {Ω}^{2} L ) {R}^{2}$$

$${u}_{z} = \frac{1}{4 μ} - ( \frac{ρ gh}{L} + \frac{1}{2} ρ {Ω}^{2} L ) {r}^{2} + \frac{1}{4 μ} ( \frac{ρ gh}{L} + \frac{1}{2} ρ {Ω}^{2} L ) {R}^{2}$$

$${u}_{z} = \frac{1}{4 μ} ( \frac{ρ gh}{L} + \frac{1}{2} ρ {Ω}^{2} L ) ( {R}^{2} - {r}^{2} )$$

$${u}_{z} = \frac{ρ}{8 L μ} ( 2 gh + {Ω}^{2} {L}^{2} ) ( {R}^{2} - {r}^{2} )$$

Pressure gradient is:

$$P ( z ) = ρ gh + ( - \frac{1}{2} ρ {Ω}^{2} L - \frac{ρ gh}{L} ) ( z - M ) + \frac{1}{2} ρ {{Ω}^{2} ( z - M )}^{2}$$

The shear stress is defined generally as:

$$τ ( r ) = μ \frac{d {u}_{z}}{d r}$$

$$τ ( r ) = μ \frac{d}{d r} ( \frac{ρ}{8 L μ} ( 2 gh + {Ω}^{2} {L}^{2} ) ( {R}^{2} - {r}^{2} ) )$$

$$τ ( r ) = ( - \frac{ρ}{4 L} ( 2 gh + {Ω}^{2} {L}^{2} ) r )$$

Hydrostatic pressure:

$$\frac{d p}{d z} ∼ \frac{Δ p}{Δ z} = - \vert \frac{Δ p}{Δ z} \vert$$

τ(r)∝R

τ(r)∝Ω²

### Supplemental:

Hydrostatic pressure is negligible:
For our system:

$$ρ = 1600 \frac{kg}{{m}^{3}}$$

$$g = 9.8 \frac{m}{{s}^{2}}$$

$$h = 0.1 m$$

$$\begin{matrix}{P}_{hydrostatic @ bottom of res .} = ρ gh \\ = ( 1600 \frac{kg}{{m}^{3}} ) ( 9.8 \frac{m}{{s}^{2}} ) ( 0.1 m ) \\ = 156.8 Pa\end{matrix}$$

$$\begin{matrix}{P}_{hydrostatic @ start of orifice} = ρ gh \\ = ( 1600 \frac{kg}{{m}^{3}} ) ( 9.8 \frac{m}{{s}^{2}} ) ( 0.0004 m ) \\ = 6.3 Pa\end{matrix}$$

$$\begin{matrix}{P}_{centripetal} = ρ z {Ω}^{2} \\ = ( 1600 \frac{kg}{{m}^{3}} ) {( 0.01 m )}^{2} {( 333 \frac{1}{s} )}^{2} \\ = 17 , 742 Pa\end{matrix}$$

### EQUIVALENTS

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements or method steps, those elements or steps may be replaced with a single element or step. Likewise, a single element or step may be replaced with a plurality of elements or steps that serve the same purpose. Further, where parameters for various properties are specified herein for exemplary embodiments, those parameters may be adjusted up or down by 1/20th, 1/10th, ⅕th, ⅓rd, ½, etc., or by rounded-off approximations thereof, unless otherwise specified. Moreover, while exemplary embodiments have been shown and described with references to particular embodiments thereof, those of ordinary skill in the art will understand that various substitutions and alterations in form and details may be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than shown.

### INCORPORATION BY REFERENCE

The contents of all references, including patents and patent applications, cited throughout this application are hereby incorporated herein by reference in their entirety. The appropriate components and methods of those references may be selected for the invention and embodiments thereof. Still further, the components and methods identified in the Background section are integral to this disclosure and can be used in conjunction with or substituted for components and methods described elsewhere in the disclosure within the scope of the invention.

1. A device for the formation of a micron, submicron or nanometer dimension polymeric fiber, the device comprising:
a reservoir for holding a polymer, the reservoir including one or more orifices for ejecting the polymer during fiber formation, thereby forming a micron, submicron or nanometer dimension polymeric fiber; and
a collection device for accepting the formed micron, submicron or nanometer dimension polymeric fiber;
wherein at least one of the reservoir and the collection device employs linear and/or rotational motion during fiber formation.

2. The device of claim 1, further comprising:
a linear motion generator for imparting the linear motion to the at least one of the reservoir and the collection device.

3. The device of claim 2, wherein the linear motion generator also imparts a rotational motion to the at least one of the reservoir and the collection device.

4. (canceled)

5. (canceled)

6. The device of claim 1, wherein both of the reservoir and the collection device oscillates in a linear manner during fiber formation.

7. A device for the formation of a micron, submicron or nanometer dimension polymeric fiber, the device comprising:
a reservoir for holding a polymer, the reservoir including one or more orifices for ejecting the polymer during fiber formation, thereby forming micron, submicron or nanometer dimension polymeric fibers; and
an air vessel for circulating a vortex of air around the formed fibers to wind the fibers into one or more threads.

8. The device of claim 7, further comprising:
a collection device for accepting the formed micron, submicron or nanometer dimension polymeric fibers.

9. The device of claim 8, wherein the collection device is rotating or stationary.

10. (canceled)

11. The device of claim 7, wherein the reservoir is rotating or oscillating.

12. (canceled)

13. The device of claim 7, wherein the air vessel comprises:
an enclosed member extending substantially vertically for accommodating the descending formed fibers;
one or more angle nozzles for introduced one or more angled air jets into the enclosed member; and
one or more air introduction pipes connectable to the one or more nozzles for introducing the air jets into the enclosed member.

14. (canceled)

15. A device for the formation of a micron, submicron or nanometer dimension polymeric fiber, the device comprising:
a reservoir for holding a polymer, the reservoir including one or more orifices for ejecting the polymer during fiber formation, thereby forming a micron, submicron or nanometer dimension polymeric fiber;
one or more mechanical members disposed or formed on or in the vicinity of the reservoir for increasing an air flow or an air turbulence experienced by the polymer ejected from the reservoir; and
a collection device for accepting the formed micron, submicron or nanometer dimension polymeric fiber.

16. The device of claim 15, wherein the collection device is rotating or is stationary.

17. (canceled)

18. The device of claim 15, wherein the reservoir is rotating or is oscillating.

19. (canceled)

20. The device of claim 15, wherein the one or more mechanical members are disposed on the reservoir.

21. The device of claim 15, further comprising:
a motion generator for imparting a motion to the reservoir;
wherein the one or more mechanical members are disposed on the motion generator.

22. The device of claim 15, wherein the one or more mechanical members are stationary or are moving.

23. (canceled)

24. The device of claim 15, wherein the one or more mechanical members are disposed vertically above the one or more orifices of the reservoir or one or more mechanical members are disposed vertically below the one or more orifices of the reservoir.

25-27. (canceled)

28. A miniaturized device for the formation of a micron, submicron or nanometer dimension polymeric fiber within a body cavity, the device comprising:
a miniaturized reservoir for holding a polymer, the reservoir including one or more orifices for ejecting the polymer during fiber formation, thereby forming a micron, submicron or nanometer dimension polymeric fiber; and
a motion generator for imparting a motion to the reservoir for ejecting the polymer from the reservoir during fiber formation;
wherein a body cavity accepts the formed micron, submicron or nanometer dimension polymeric fiber.

29. The device of claim 28, wherein the reservoir is rotating or is oscillating.

30. (canceled)

31. The device of claim 28, wherein the motion generator is miniaturized and is insertable into the body cavity or the motion generator is non-miniaturized and is provided outside the body cavity.

32-36. (canceled)

37. A reservoir for the formation of a micron, submicron or nanometer dimension polymeric fiber within a body cavity, the reservoir comprising:
a reservoir body having a hollow internal space for holding a polymer; and
a plurality of orifices provided on the body for ejecting the polymer during fiber formation, thereby forming a micron, submicron or nanometer dimension polymeric fiber.

38. The reservoir of claim 37, wherein the reservoir is rotatable or is capable of oscillation.

39. (canceled)

40. The reservoir of claim 37, wherein the plurality of orifices are provided on the same surface of the reservoir body or on different surfaces of the reservoir body.

41. (canceled)

42. The reservoir of claim 37, wherein the plurality of orifices have the same cross-sectional configuration or different cross-sectional configurations.

43. (canceled)

44. The reservoir of claim 37, further comprising:
a first nozzle provided on a first of the one or more orifices of the reservoir.

45. The reservoir of claim 44, wherein the first nozzle has a cross-sectional configuration different from a cross-sectional configuration of the first orifice.

46. The reservoir of claim 44, wherein the first nozzle increases the surface area of the formed fiber, convolutes the surface topography of the formed fiber, or creates one or more structural features on the surface of the formed fiber.

47-49. (canceled)

50. A method for fabricating a micron, submicron or nanometer dimension polymeric fiber, comprising
providing a polymer in solution and imparting sufficient shear force to the surface of the polymer solution for a sufficient time such that the polymer in the solution is unfolded thereby forming a micron, submicron or nanometer dimension polymeric fiber.

51. A method for fabricating a micron, submicron or nanometer dimension polymeric fiber, comprising
providing a device comprising a rotating reservoir and at least one orifice; providing a polymer solution in the rotating reservoir and imparting sufficient shear force to the surface of the polymer solution for a sufficient time such that the polymer in the solution is unfolded thereby forming a micron, submicron or nanometer dimension polymeric fiber.

52. A method for fabricating a micron, submicron or nanometer dimension polymeric fiber, comprising
providing the device of claim 1;
providing a polymer solution in the rotating reservoir and imparting sufficient shear force to the surface of the polymer solution for a sufficient time such that the polymer in the solution is unfolded thereby forming a micron, submicron or nanometer dimension polymeric fiber.

53. The method of claim 50, wherein the polymer is a protein.

54. (canceled)

55. The method of claim 50, wherein the shear force is at least about 3,000 Pascals.

56. The method of claim 51, wherein the reservoir is rotated at greater than about 50,000 rpm.

57. The method of claim 51, wherein the at least one orifice has a diameter of about 1 micron to about 100 millimeters or the at least one orifice has a length of about 10 microns to about 100 centimeters.

58. (canceled)

59. A micron, submicron or nanometer dimension polymeric fiber prepared according to the method of claim 50.
